(19) United States
(12) Patent Application Publication
(10) Pub. No.: US 2026/0212871 A1
(43) Pub. Date: Jul. 23, 2026

(54) SOUND SIGNAL PROCESSING APPARATUS, SOUND SIGNAL PROCESSING METHOD, AND PROGRAM

(71) Applicant: NTT. Inc., Tokyo (JP)

(72) Inventors: Takehiro MORIYA, Musashino-shi, Tokyo (JP); Noboru HARADA, Musashino-shi, Tokyo (JP); Yutaka KAMAMOTO, Musashino-shi, Tokyo (JP); Ryosuke SUGIURA, Musashino-shi, Tokyo (JP)

(73) Assignee: NIPPON TELEGRAPH AND TELEPHONE CORPORATION, Tokyo (JP)

(21) Appl. No.: 19/141,370

(22) PCT Filed: Dec. 28, 2022
(86) PCT No.: PCT/JP2022/048529

§ 371 Date: Jun. 20, 2025

(51) Int. Cl. G10L 19/008

(52) U.S. Cl. CPC G10L 19/008

(57) ABSTRACT

A sound signal processing device that obtains a two-channel stereo encoding target signal to be subjected to stereo encoding from a two-channel stereo input sound signal, the sound signal processing device including a signal mixing unit that obtains, as an encoding target signal, for each channel, a signal obtained by performing weighted addition on an input sound signal of the channel and an input sound signal of the other channel, the signal being closer to the input sound signal of the channel as an absolute value of an inter-channel time difference of the two-channel stereo input sound signal is smaller.

### TECHNICAL FIELD

The present invention relates to a technique for processing a sound signal of two-channel stereo so as to suppress deterioration in auditory quality of a decoded sound signal obtained by stereo encoding/decoding.

### BACKGROUND ART

As a technique for processing a sound signal of two-channel stereo so as to suppress deterioration in auditory quality of a decoded sound signal obtained by stereo encoding/decoding, there are a technique described in Patent Literature 1 and a technique described in Patent Literature 2. Patent Literature 1 and Patent Literature 2 describe techniques in which an L channel signal and an R channel signal are processed to obtain an L channel processed signal and an R channel processed signal, respectively, and the L channel processed signal and the R channel processed signal are subjected to subsequent encoding processing.

In Patent Literature 1, an energy ratio, a time difference, and the like between an L channel signal and an R channel signal are obtained as spatial information, and a signal of any one of the channels is processed using the spatial information, thereby obtaining an L channel processed signal and an R channel processed signal having higher similarity than the L channel signal and the R channel signal. In Patent Literature 2, for each channel, an energy ratio, a time difference, and the like between the channel signal and a monaural signal that is an average of the left channel signal and the right channel signal are obtained as spatial information of the channel, and the channel signal is brought close to the monaural signal using the spatial information of the channel, thereby obtaining an L channel processed signal and an R channel processed signal. In Patent Literature 1 and Patent Literature 2, since the spatial information is used to obtain the decoded sound signal of each channel on the decoding side, a spatial information encoding parameter representing the spatial information is output on the encoding side, and the spatial information is obtained from the input spatial information encoding parameter on the decoding side.

### CITATION LIST

### Patent Literature

Patent Literature 1: WO 2006/059567 A
Patent Literature 2: WO 2006/070760 A

### SUMMARY OF INVENTION

### Technical Problem

In both the technique described in Patent Literature 1 and the technique described in Patent Literature 2, the close proximity of a plurality of encoding target signals makes it possible to reduce the code amount required to represent the encoding target signals themselves, but there is a problem that a code representing information related to processing of processing a signal is required, and processing on the decoding side corresponding to the processing on the encoding side is also required. In addition, in both the technique described in Patent Literature 1 and the technique described in Patent Literature 2, a plurality of encoding target signals obtained by processing using spatial information such as an energy ratio and a time difference is not necessarily close to each other, and there is a possibility that deterioration in auditory quality of the decoded sound signal cannot be suppressed depending on a difference in signal between channels in a two-channel stereo input sound signal.

An object of the present invention is to obtain an encoding target signal from a sound signal of two-channel stereo so as to suppress deterioration in auditory quality of a decoded sound signal obtained by stereo encoding/decoding of the encoding target signal without requiring a code representing information related to processing and without requiring processing on the decoding side.

### Solution to Problem

An aspect of the present invention is a sound signal processing device that obtains a two-channel stereo encoding target signal including encoding target signals of two channels to be subjected to stereo encoding by a stereo encoding device from a two-channel stereo input sound signal including input sound signals of two channels, the sound signal processing device including: a signal mixing unit that obtains, for each channel, a signal obtained by performing weighted addition on the input sound signal of the channel and the input sound signal of the other channel as the encoding target signal of the channel, wherein a weight of the input sound signal of the channel in the weighted addition is a value having a weak monotonic decrease relationship with respect to an absolute value of an inter-channel time difference of the two-channel stereo input sound signal, and a weight of the input sound signal of the other channel in the weighted addition is a value having a weak monotonic increase relationship with respect to the absolute value of the inter-channel time difference.

An aspect of the present invention is a sound signal processing device that obtains a two-channel stereo encoding target signal including encoding target signals of two channels to be subjected to stereo encoding by a stereo encoding device from a two-channel stereo input sound signal including input sound signals of two channels, the sound signal processing device including: a signal mixing unit that obtains the input sound signal of the channel as the encoding target signal of the channel for each channel in a first range, within a range that can be taken by an absolute value of an inter-channel time difference of the two-channel stereo input sound signal, that is a range in which the absolute value of the inter-channel time difference is smaller than or equal to or less than a predetermined value, and obtains, as the encoding target signal of the channel, a signal obtained by performing weighted addition on the input sound signal of the channel and the input sound signal of the other channel for each channel in a second range, within the range that can be taken by the absolute value of the inter-channel time difference, that is a range other than the first range, wherein a weight of the input sound signal of the channel in the weighted addition is a value having a weak monotonic decrease relationship with respect to the absolute value of the inter-channel time difference in the second range, and a weight of the input sound signal of the other channel in the weighted addition is a value having a weak monotonic increase relationship with respect to the absolute value of the inter-channel time difference in the second range.

An aspect of the present invention is a sound signal processing device that obtains a two-channel stereo encoding target signal including encoding target signals of two channels to be subjected to stereo encoding by a stereo encoding device from a two-channel stereo input sound signal including input sound signals of two channels, the sound signal processing device including: a downmixed signal generation unit that mixes the input sound signals of the two channels to generate a downmixed signal; and a mixing unit that obtains, for each channel, a signal obtained by performing weighted addition on the input sound signal of the channel and the downmixed signal as the encoding target signal of the channel, wherein a weight of the input sound signal of the channel in the weighted addition is a value having a weak monotonic decrease relationship with respect to an absolute value of an inter-channel time difference of the two-channel stereo input sound signal, and a weight of the downmixed signal in the weighted addition is a value having a weak monotonic increase relationship with respect to the absolute value of the inter-channel time difference.

An aspect of the present invention is a sound signal processing device that obtains a two-channel stereo encoding target signal including encoding target signals of two channels to be subjected to stereo encoding by a stereo encoding device from a two-channel stereo input sound signal including input sound signals of two channels, the sound signal processing device including: a downmixed signal generation unit that mixes the input sound signals of the two channels to generate a downmixed signal; and a mixing unit that obtains the input sound signal of the channel as the encoding target signal of the channel for each channel in a first range, within a range that can be taken by an absolute value of an inter-channel time difference of the two-channel stereo input sound signal, that is a range in which the absolute value of the inter-channel time difference is smaller than or equal to or less than a predetermined value, and obtains, as the encoding target signal of the channel, a signal obtained by performing weighted addition on the input sound signal of the channel and the downmixed signal for each channel in a second range, within the range that can be taken by the absolute value of the inter-channel time difference, that is a range other than the first range, wherein a weight of the input sound signal of the channel in the weighted addition is a value having a weak monotonic decrease relationship with respect to the absolute value of the inter-channel time difference in the second range, and a weight of the downmixed signal in the weighted addition is a value having a weak monotonic increase relationship with respect to the absolute value of the inter-channel time difference in the second range.

An aspect of the present invention is a sound signal processing device that obtains a two-channel stereo encoding target signal including encoding target signals of two channels to be subjected to stereo encoding by a stereo encoding device from a two-channel stereo input sound signal including input sound signals of two channels, the sound signal processing device including: a downmixed signal generation unit that mixes the input sound signals of the two channels to generate a downmixed signal; and a mixing unit that obtains the downmixed signal as the encoding target signal of the channel for each channel in a first range, within a range that can be taken by an absolute value of an inter-channel time difference of the two-channel stereo input sound signal, that is a range in which the absolute value of the inter-channel time difference is larger than or equal to or larger than a predetermined value, and obtains, as the encoding target signal, a signal obtained by performing weighted addition on the input sound signal of the channel and the downmixed signal for each channel in a second range, within the range that can be taken by the absolute value of the inter-channel time difference, that is a range other than the first range, wherein a weight of the input sound signal of the channel in the weighted addition is a value having a weak monotonic decrease relationship with respect to the absolute value of the inter-channel time difference in the second range, and a weight of the downmixed signal in the weighted addition is a value having a weak monotonic increase relationship with respect to the absolute value of the inter-channel time difference in the second range.

An aspect of the present invention is a sound signal processing device that obtains a two-channel stereo encoding target signal including encoding target signals of two channels to be subjected to stereo encoding by a stereo encoding device from a two-channel stereo input sound signal including input sound signals of two channels, the sound signal processing device including: a downmixed signal generation unit that mixes the input sound signals of the two channels to generate a downmixed signal; and a mixing unit that obtains the input sound signal of the channel as the encoding target signal of the channel for each channel in a first range, within a range that can be taken by an absolute value of an inter-channel time difference of the two-channel stereo input sound signal, that is a range in which the absolute value of the inter-channel time difference is smaller than or equal to or less than a predetermined first value, obtains, as the encoding target signal of the channel, the downmixed signal for each channel in a second range, within the range that can be taken by the absolute value of the inter-channel time difference, that is a range in which the absolute value of the inter-channel time difference is larger than or equal to or larger than a predetermined second value larger than the first value, and obtains, as the encoding target signal, a signal obtained by performing weighted addition on the input sound signal of the channel and the downmixed signal for each channel in a third range, within the range that can be taken by the absolute value of the inter-channel time difference, that is a range other than the first range and the second range, wherein a weight of the input sound signal of the channel in the weighted addition is a value having a weak monotonic decrease relationship with respect to the absolute value of the inter-channel time difference in the third range, and a weight of the downmixed signal in the weighted addition is a value having a weak monotonic increase relationship with respect to the absolute value of the inter-channel time difference in the third range.

### Advantageous Effects of Invention

According to the present invention, it is possible to obtain an encoding target signal from an input sound signal of two-channel stereo so as to suppress deterioration in auditory quality of a decoded sound signal obtained by stereo encoding/decoding of the encoding target signal without requiring a code representing information related to processing and without requiring processing on the decoding side.

### BRIEF DESCRIPTION OF DRAWINGS

FIG. 1 is a block diagram illustrating an example of a configuration of a sound signal encoding system 300.

FIG. 2 is a flowchart illustrating an example of processing of the sound signal encoding system 300.

FIG. 3 is a block diagram illustrating an example of a configuration of a sound signal processing device 100.

FIG. 4 is a flowchart illustrating an example of processing of the sound signal processing device 100.

FIG. 5 is a block diagram illustrating an example of a configuration of the sound signal processing device 100.

FIG. 6 is a flowchart illustrating an example of processing of the sound signal processing device 100.

FIG. 7 is a block diagram illustrating an example of a configuration of a sound signal decoding device 400.

FIG. 8 is a flowchart illustrating an example of processing of the sound signal decoding device 400.

FIG. 9 is a diagram illustrating an example of a functional configuration of a computer that implements each system and each device according to an embodiment of the present invention.

### DESCRIPTION OF EMBODIMENTS

### First Embodiment

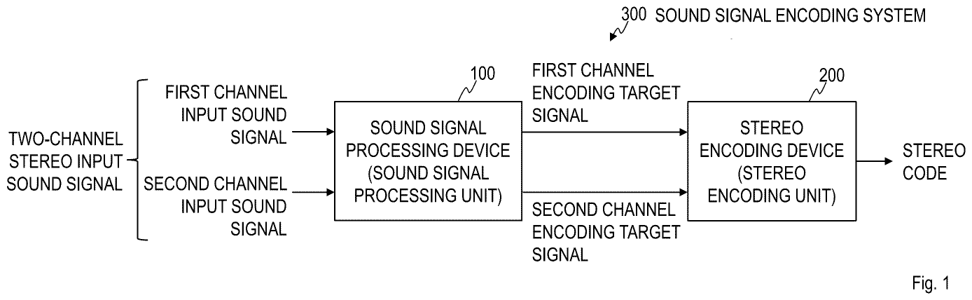

In the first embodiment, a sound signal encoding system 300 will be described. The sound signal encoding system 300 is as illustrated in FIG. 1 and includes a sound signal processing device 100 and a stereo encoding device 200.

A two-channel stereo sound signal is input to the sound signal encoding system 300. The two-channel stereo sound signal input to the sound signal encoding system 300 is referred to as a two-channel stereo input sound signal. The two-channel stereo input sound signal includes input sound signals of two channels, specifically, a first channel input sound signal and a second channel input sound signal. For example, a two-channel stereo input sound signal input to the sound signal encoding system 300 includes a first channel input sound signal that is a digital sound signal obtained by performing AD conversion on a sound collected by a first channel microphone disposed in a space and a second channel input sound signal that is a digital sound signal obtained by performing AD conversion on a sound collected by a second channel microphone disposed in the space. The first channel and the second channel are, for example, a left channel and a right channel.

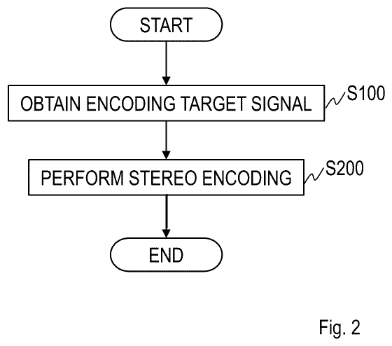

The sound signal encoding system 300 obtains a stereo code that is a code corresponding to the two-channel stereo input sound signal from the two-channel stereo input sound signal. The stereo code obtained by the sound signal encoding system 300 is output from the sound signal encoding system 300. The sound signal encoding system 300 performs processing of step S100 and step S200 illustrated in FIG. 2.

For example, the sound signal encoding system 300 performs processing of step S100 and step S200 illustrated in FIG. 2 on each frame. When the number of samples per frame is T, first channel input sound signals x₁(1), x₁(2), . . . , x₁(T) and second channel input sound signals x₂(1), x₂(2), . . . , x₂(T) are input to the sound signal encoding system 300 in units of frames, and the sound signal encoding system 300 obtains and outputs a stereo code CS from the first channel input sound signals x₁(1), x₁(2), . . . , x₁(T) and the second channel input sound signals x₂(1), x₂(2), . . . , x₂(T) in units of frames. Here, T is a positive integer, and for example, when the frame length is 20 ms and the sampling frequency is 48 kHz, T is 960.

### [Sound Signal Processing Device 100]

The two-channel stereo input sound signal input to the sound signal encoding system 300 is input to the sound signal processing device 100. The sound signal processing device 100 obtains, from the two-channel stereo input sound signal, a two-channel stereo encoding target signal that is a two-channel stereo signal to be subjected to stereo encoding by the stereo encoding device 200 (step S100). The two-channel stereo encoding target signal obtained by the sound signal processing device 100 is output to the stereo encoding device 200. Details of the sound signal processing device 100 will be described in a second embodiment and subsequent embodiments. Note that, since the sound signal processing device 100 is a device that performs preprocessing of the stereo encoding device 200, it can be said that it is a sound signal preprocessing device.

The two-channel stereo encoding target signal includes encoding target signals of two channels, and specifically, includes a first channel encoding target signal and a second channel encoding target signal. Therefore, the sound signal processing device 100 obtains, from the first channel input sound signal and the second channel input sound signal, the first channel encoding target signal and the second channel encoding target signal to be subjected to stereo encoding by the stereo encoding device 200. For example, the sound signal processing device 100 obtains, for each frame, first channel encoding target signals x′₁(1), x′₁(2), . . . , x′₁(T) and second channel encoding target signals x′₂(1), x′₂(2), . . . , x′₂(T) from the first channel input sound signals x₁(1), x₁(2), . . . , x₁(T) and the second channel input sound signals x₂(1), x₂(2), . . . , x₂(T).

### [Stereo Encoding Device 200]

The two-channel stereo encoding target signal output from the sound signal processing device 100 is input to the stereo encoding device 200. The stereo encoding device 200 stereo-encodes the two-channel stereo encoding target signal to obtain a stereo code (step S200). Specifically, the stereo encoding device 200 stereo-encodes the first channel encoding target signal and the second channel encoding target signal to obtain a stereo code. The stereo code obtained by the stereo encoding device 200 is an output of the sound signal encoding system 300.

For example, the stereo encoding device 200 stereo-encodes the first channel encoding target signals x′₁(1), x′₁(2), . . . , x′₁(T) and the second channel encoding target signals x′₂(1), x′₂(2), . . . , x′₂(T) to obtain the stereo code CS for each frame.

Here, the stereo encoding is a method of encoding using at least a relationship between channels, such as parametric stereo encoding or MS stereo encoding. The parametric stereo encoding is a method of obtaining a code by encoding a signal obtained by downmixing encoding target signals of two channels and a parameter such as a time difference or a level difference between the encoding target signal of each channel and the downmixed signal. The MS stereo encoding is a method of obtaining a code by encoding a sum signal of encoding target signals of two channels and a difference signal of encoding target signals of two channels. Both the parametric stereo encoding and the MS stereo encoding fall under stereo encoding since they are methods of encoding using at least a relationship between channels. In addition, even when a time section for performing encoding without using a relationship between channels is included, a method including a time section for performing encoding using a relationship between channels is a method of encoding using at least a relationship between channels, and thus falls under stereo encoding. That is, the stereo encoding is a method including at least a time section for performing encoding using at least a relationship between channels, and can also be said to be an encoding method in which at least a relationship between channels is used. On the other hand, a method of obtaining a code by always independently encoding an encoding target signal of each channel (so-called “dual monaural encoding”) is a method of encoding without using a relationship between channels, and thus is not included in “stereo encoding”.

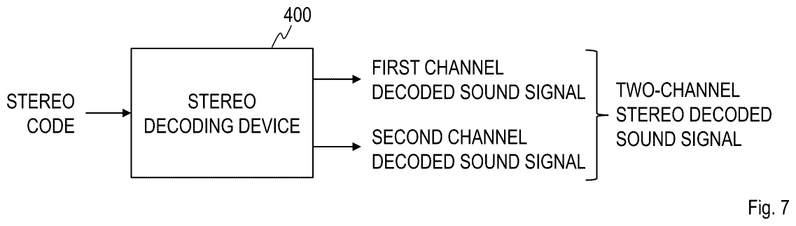

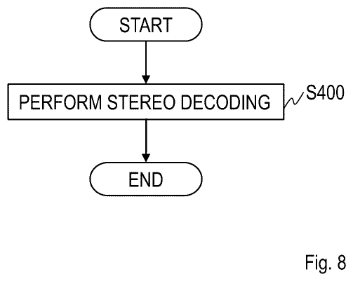

The stereo code output from the sound signal encoding system 300 is input to a stereo decoding device 400 illustrated in FIG. 7 via a transmission path. The stereo decoding device 400 performs processing of step S400 illustrated in FIG. 8. Specifically, the stereo decoding device 400 decodes the stereo code by a stereo decoding method corresponding to the stereo encoding method of the stereo encoding device 200 to obtain and output a two-channel stereo decoded sound signal (step S400). The two-channel stereo decoded sound signal includes decoded sound signals of two channels, specifically, a first channel decoded sound signal and a second channel decoded sound signal. The first channel decoded sound signal and the second channel decoded sound signal are signals appropriately DA-converted and presented to a listener.

Note that, in the sound signal encoding system 300, the sound signal processing device 100 and the stereo encoding device 200 may be configured as separate and independent devices, or the sound signal processing device 100 and the stereo encoding device 200 may be configured as one device. In a case where the sound signal encoding system 300 is configured as one device, the sound signal encoding system 300 may be read as a sound signal encoding device 300, the sound signal processing device 100 may be read as a sound signal processing unit 100, and the stereo encoding device 200 may be read as a stereo encoding unit 200.

### Second Embodiment

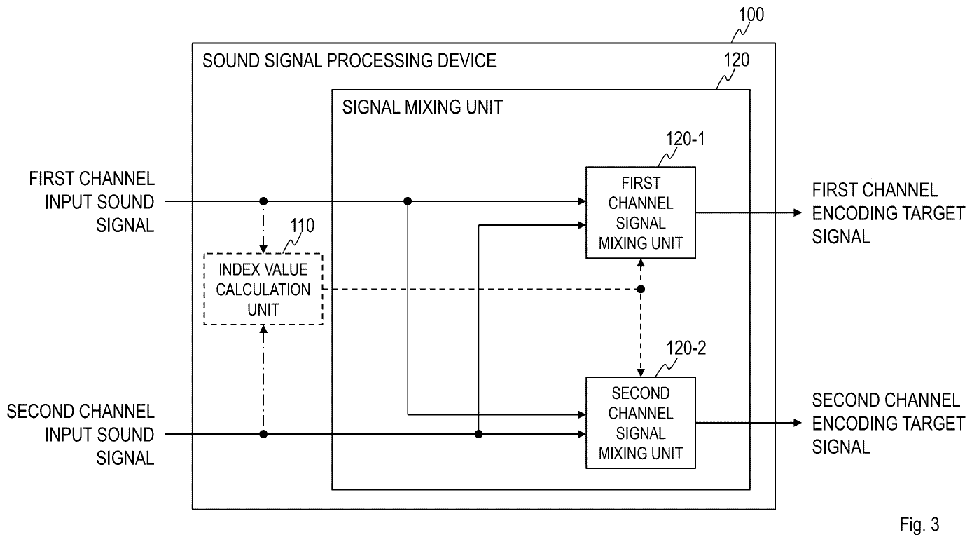

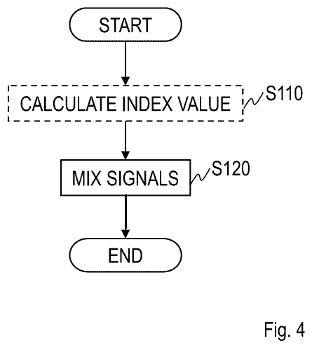

In the second embodiment, the sound signal processing device 100 that performs processing according to a bit rate of the stereo encoding of the stereo encoding device 200 will be described. The sound signal processing device 100 of the second embodiment is as indicated by the solid line in FIG. 3 and includes a signal mixing unit 120. The sound signal processing device 100 of the second embodiment performs processing of step S120 indicated by the solid line in FIG. 4.

### [Signal Mixing Unit 120]

A first channel input sound signal and a second channel input sound signal, which are input sound signals of two channels constituting a two-channel stereo input sound signal input to the sound signal processing device 100, are input to the signal mixing unit 120. For example, for each channel of the first channel and the second channel, the signal mixing unit 120 obtains, as an encoding target signal of the channel, a signal in which an input sound signal of the other channel is mixed with an input sound signal of the channel, the signal being closer to the input sound signal of the channel as the bit rate of the stereo encoding of the stereo encoding device 200 is higher (step S120). In other words, for each channel of the first channel and the second channel, the signal mixing unit 120 obtains, as an encoding target signal of the channel, a signal in which an input sound signal of the channel is mixed with an input sound signal of the other channel, the signal being closer to the input sound signal of the channel as the bit rate of the stereo encoding of the stereo encoding device 200 is higher. The encoding target signals (that is, the two-channel stereo encoding target signal) of the two channels obtained by the signal mixing unit 120 are output to the stereo encoding device 200 as output signals of the sound signal processing device 100.

“The channel” refers to its own channel, and when “each channel” is a first channel, “the channel” is a first channel, and when “each channel” is a second channel, “the channel” is a second channel. “The other channel” refers to a channel other than the own channel of two channels, and when “each channel” is a first channel, “the other channel” is a second channel, and when “each channel” is a second channel, “the other channel” is a first channel. In both the case where the first channel is an X channel and the second channel is a Y channel and the case where the second channel is an X channel and the first channel is a Y channel, “the channel” refers to the X channel and “the other channel” refers to the Y channel. The same applies hereinafter.

An example of the signal in which the input sound signal of the channel and the input sound signal of the other channel for each channel are mixed is a signal obtained by performing weighted addition on the input sound signal of the channel and the input sound signal of the other channel, and more specifically, is a signal obtained by performing weighted addition on the input sound signal of the channel at the time and the input sound signal of the other channel at the time for each time. The same applies hereinafter.

For example, as illustrated in FIG. 3, it is sufficient if the signal mixing unit 120 includes a first channel signal mixing unit 120-1 and a second channel signal mixing unit 120-2. In other words, it is sufficient if the first channel signal mixing unit 120-1 obtains, as a first channel encoding target signal, a signal in which the first channel input sound signal and the second channel input sound signal are mixed, the signal being closer to the first channel input sound signal as the bit rate of the stereo encoding of the stereo encoding device 200 is higher. In addition, it is sufficient if the second channel signal mixing unit 120-2 obtains, as a second channel encoding target signal, a signal in which the second channel input sound signal and the first channel input sound signal are mixed, the signal being closer to the second channel input sound signal as the bit rate of the stereo encoding of the stereo encoding device 200 is higher.

When the bit rate of the stereo encoding of the stereo encoding device 200 is sufficiently high, the auditory quality of the decoded sound signal is sufficiently high even when the decoded sound signal is obtained by performing stereo encoding and stereo decoding on the two-channel stereo input sound signal as it is as the encoding target signal. However, in a case where the bit rate of the stereo encoding of the stereo encoding device 200 is low, when stereo encoding and stereo decoding are performed on the two-channel stereo input sound signal as it is as the encoding target signal to obtain a decoded sound signal, quantization noise included in the decoded sound signal is noticeably perceived, and the auditory quality of the decoded sound signal becomes low.

When the stereo encoding method of the stereo encoding device 200 and the stereo decoding method corresponding thereto are designed such that the lower the bit rate of the stereo encoding of the stereo encoding device 200, the more priority is given to reducing the quantization noise included in the decoded sound signal of each channel than the reproducibility of the difference between the channels affecting the reproducibility of the localization of the sound source and the like, it is possible to suppress the deterioration in auditory quality of the decoded sound signal when the bit rate of the stereo encoding of the stereo encoding device 200 is low. However, it may not be realistic to change the stereo encoding of the stereo encoding device 200 and the stereo decoding method according to the bit rate.

Therefore, in the sound signal processing device 100 of the second embodiment, the encoding target signal of each channel becomes closer to the input sound signal of each channel as the bit rate of the stereo encoding of the stereo encoding device 200 is higher, and the encoding target signal of each channel becomes closer to the same one signal as the bit rate of the stereo encoding of the stereo encoding device 200 is lower, so that it is possible to suppress deterioration in auditory quality of the decoded sound signal in a case where the bit rate of the stereo encoding of the stereo encoding device 200 is low even when the stereo encoding of the stereo encoding device 200 and the stereo decoding method are not changed according to the bit rate.

Assuming that each time is t, the first channel input sound signal at time t is x₁(t), the second channel input sound signal at time t is x₂(t), the first channel encoding target signal at time t is x′₁(t), and the second channel encoding target signal at time t is x′₂(t), assuming that, for example, a weight value of 0.5 or more and 1 or less, the weight value having a positive correlation with the bit rate of the stereo encoding, that is, the weight value that is a larger value as the bit rate of the stereo encoding is higher is w₁, w₂, it is sufficient if the first channel signal mixing unit 120-1 obtains the first channel encoding target signal x′₁(t) represented by Formula (2-1) described below for each time t, and the second channel signal mixing unit 120-2 obtains the second channel encoding target signal x′₂(t) represented by Formula (2-2) described below for each time t. The weight value w₁ and the weight value w₂ may be the same value or different values.

$$\begin{matrix}[ Math . 1 ] & \\ {x}_{1}^{′} ( t ) = {w}_{1} {x}_{1} ( t ) + ( 1 - {w}_{1} ) {x}_{2} ( t ) & ( 2 ‐ 1 )\end{matrix}$$

$$\begin{matrix}[ Math . 2 ] & \\ {x}_{2}^{′} ( t ) = {w}_{2} {x}_{2} ( t ) + ( 1 - {w}_{2} ) {x}_{1} ( t ) & ( 2 ‐ 2 )\end{matrix}$$

The first channel signal mixing unit 120-1 may obtain the first channel encoding target signal x′₁(t) by calculation using Formula (2-1) described above, or may obtain the first channel encoding target signal x′₁(t) represented by Formula (2-1) described above using another calculation method or the like. Similarly, the second channel signal mixing unit 120-2 may obtain the second channel encoding target signal x′₂(t) by calculation using Formula (2-2) described above, or may obtain the second channel encoding target signal x′₂(t) represented by Formula (2-2) described above using another calculation method or the like. The same applies to a description portion to be described below for obtaining the first channel encoding target signal x′₁(t) and the second channel encoding target signal x′₂(t).

Note that it is not essential that the weight values w₁ and w₂ are larger values as the bit rate of the stereo encoding is higher in the entire range that can be taken by the bit rate of the stereo encoding, and the weight values w₁ and w₂ may be constant values regardless of the bit rate of the stereo encoding in a partial range of the range that can be taken by the bit rate of the stereo encoding. That is, it is sufficient if each of the weight value w₁ and the weight value w₂ has a weak monotonic increase relationship with respect to the bit rate of the stereo encoding.

Note that the fact that the weight value w₁ has a weak monotonic increase relationship with respect to the bit rate of the stereo encoding means that (1−w₁) included in Formula (2-1) described above has a weak monotonic decrease relationship with respect to the bit rate of the stereo encoding. Similarly, the fact that the weight value w₂ has a weak monotonic increase relationship with respect to the bit rate of the stereo encoding means that (1−w₂) included in Formula (2-2) described above has a weak monotonic decrease relationship with respect to the bit rate of the stereo encoding.

A second type value (for example, the weight value w₁) having a weak monotonic increase relationship with respect to a first type value (for example, bit rate of stereo encoding) means that, assuming that the first type value is a, the second type value is a function f(a) of the first type value a, a minimum value of values that can be taken by the first type value is aₘᵢₙ, and a maximum value of values that can be taken by the first type value is aₘₐₓ, f(aₘᵢₙ)<f(aₘₐₓ), and f(a₁)≤f(a₂) is satisfied for all combinations of a₁ and a₂ satisfying aₘᵢₙ≤a₁<a₂≤aₘₐₓ. In other words, the fact that the second type value has a weak monotonic increase relationship with respect to the first type value means that the second type value when the first type value is the minimum value of the range that can be taken by the first type value is smaller than the second type value when the first type value is the maximum value of the range that can be taken by the first type value, and the second type value when the first type value is a certain value, in the entire range that can be taken by the first type value, is equal to or less than the second type value when the first type value is a value larger than the certain value.

That is, the fact that the second type value has a weak monotonic increase relationship with respect to the first type value means that the second type value has a monotonic increase relationship with respect to the first type value in the entire range that can be taken by the first type value, or the second type value is constant regardless of the first type value in a partial range (first type range) of the range that can be taken by the first type value, and the second type value has a monotonic increase relationship with respect to the first type value in a range other than the partial range (range other than first type range, second type range) of the range that can be taken by the first type value. Each of the first type range and the second type range is one or more ranges. That is, there may be a plurality of first type ranges or there may be a plurality of second type ranges. Note that, as a matter of course, the “weak monotonic increase” may be read as “monotonic non-decrease”.

The second type value having a monotonic increase relationship with respect to the first type value means that the second type value has a positive correlation with the first type value, and that the larger the first type value, the larger the second type value. Note that the “monotonic increase” may be read as “strict monotonic increase”.

The second type value having a weak monotonic decrease relationship with respect to the first type value means that, assuming that the first type value is a, the second type value is a function f(a) of the first type value a, a minimum value of values that can be taken by the first type value is aₘᵢₙ, and a maximum value of values that can be taken by the first type value is aₘₐₓ, f(aₘᵢₙ)>f(aₘₐₓ), and f(a₁)≥f(a₂) is satisfied for all combinations of a₁ and a₂ satisfying aₘᵢₙ≤a₁<a₂≤aₘₐₓ. In other words, the fact that the second type value has a weak monotonic decrease relationship with respect to the first type value means that the second type value when the first type value is the minimum value of the range that can be taken by the first type value is larger than the second type value when the first type value is the maximum value of the range that can be taken by the first type value, and the second type value when the first type value is a certain value, in the entire range that can be taken by the first type value, is equal to or larger than the second type value when the first type value is a value larger than the certain value.

That is, the fact that the second type value has a weak monotonic decrease relationship with respect to the first type value means that the second type value has a monotonic decrease relationship with respect to the first type value in the entire range that can be taken by the first type value, or the second type value is constant regardless of the first type value in a partial range (first type range) of the range that can be taken by the first type value, and the second type value has a monotonic decrease relationship with respect to the first type value in a range other than the partial range (range other than first type range, second type range) of the range that can be taken by the first type value. Each of the first type range and the second type range is one or more ranges. That is, there may be a plurality of first type ranges or there may be a plurality of second type ranges. Note that, as a matter of course, the “weak monotonic decrease” may be read as “monotonic non-increase”.

The second type value having a monotonic decrease relationship with respect to the first type value means that the second type value has a negative correlation with the first type value, that the smaller the first type value, the larger the second type value, and that the larger the first type value, the smaller the second type value. Note that the “monotonic decrease” may be read as “strict monotonic decrease”.

Note that what has been described in the previous six paragraphs is a general description of the relationship between values, and is not specialized in the present specification, and thus, naturally, the same applies to the subsequent descriptions.

Therefore, it is sufficient if the signal mixing unit 120 obtains, for each channel, as the encoding target signal of the channel, a signal in which the input sound signal of the channel and the input sound signal of the other channel are mixed, the signal being closer to the input sound signal of the channel as the bit rate of the stereo encoding is higher, in the entire range that can be taken by the bit rate of the stereo encoding, or obtains, for each channel, as the encoding target signal of the channel, a signal in which the input sound signal of the channel and the input sound signal of the other channel are mixed, the signal having the same closeness to the input sound signal of the channel regardless of the bit rate of the stereo encoding, in a partial range (first type range) of the range that can be taken by the bit rate of the stereo encoding, and, obtains, for each channel, as the encoding target signal of the channel, a signal in which the input sound signal of the channel and the input sound signal of the other channel are mixed, the signal being closer to the input sound signal of the channel as the bit rate of the stereo encoding is higher in a range other than the partial range (range other than first type range, second type range) of the range that can be taken by the bit rate of the stereo encoding (step S120). Each of the first type range and the second type range is one or more ranges. That is, there may be a plurality of first type ranges or there may be a plurality of second type ranges.

For example, it is sufficient if the signal mixing unit 120 obtains, for each channel, as the encoding target signal of the channel, a signal obtained by performing weighted addition on the input sound signal of the channel and the input sound signal of the other channel, in which the weight of the input sound signal of the channel in the weighted addition is a value having a weak monotonic increase relationship with respect to the bit rate of the stereo encoding, and the weight of the input sound signal of the other channel in the weighted addition is a value having a weak monotonic decrease relationship with respect to the bit rate of the stereo encoding.

The value having a weak monotonic increase relationship with respect to the bit rate of the stereo encoding is, for example, a function value of a weak monotonic increase function using the bit rate of the stereo encoding as an argument. Therefore, for example, it is sufficient if a weak monotonic increase function for each channel is stored in the signal mixing unit 120 in advance, and the signal mixing unit 120 acquires a function value by giving the bit rate of the stereo encoding of the frame as an argument to the weak monotonic increase function for the channel for each channel of each frame and uses the acquired function value as the weight of the input sound signal of the channel. Alternatively, for example, for a plurality of types of bit rates that can be taken by the stereo encoding of the stereo encoding device 200, it is sufficient if a set of each bit rate and each weight value corresponding to each bit rate determined in advance such that the weight value has a weak monotonic increase relationship with respect to the bit rate is stored in the signal mixing unit 120 in advance, and the signal mixing unit 120 acquires the weight value corresponding to the bit rate of the stereo encoding of the frame among the stored weight values for each channel of each frame and uses the acquired weight value as the weight of the input sound signal of the channel.

The value having a weak monotonic decrease relationship with respect to the bit rate of the stereo encoding is, for example, a function value of a weak monotonic decrease function using the bit rate of the stereo encoding as an argument. Therefore, for example, it is sufficient if a weak monotonic decrease function for each channel is stored in the signal mixing unit 120 in advance, and the signal mixing unit 120 acquires a function value by giving the bit rate of the stereo encoding of the frame as an argument to the weak monotonic decrease function for the channel for each channel of each frame and uses the acquired function value as the weight of the input sound signal of the other channel. Alternatively, for example, for a plurality of types of bit rates that can be taken by the stereo encoding of the stereo encoding device 200, it is sufficient if a set of each bit rate and each weight value corresponding to each bit rate determined in advance such that the weight value has a weak monotonic decrease relationship with respect to the bit rate is stored in the signal mixing unit 120 in advance, and the signal mixing unit 120 acquires the weight value corresponding to the bit rate of the stereo encoding of the frame among the stored weight values for each channel of each frame and uses the acquired weight value as the weight of the input sound signal of the other channel.

When the weight value w₁ is 1, the first channel encoding target signal x′₁(t) represented by Formula (2-1) described above is the same as the first channel input sound signal x₁(t), and when the weight value w₂ is 1, the second channel encoding target signal x′₂(t) represented by Formula (2-2) described above is the same as the second channel input sound signal x₂(t). Therefore, in a case where the weight value w₁ and the weight value w₂ when the bit rate of the stereo encoding is the maximum value of values that can be taken by the bit rate or within a predetermined range including the maximum value are 1, the signal mixing unit 120 may use the input sound signal of the channel as the encoding target signal of the channel as it is for each channel when the bit rate of the stereo encoding is the maximum value of values that can be taken by the bit rate or within the predetermined range including the maximum value.

Therefore, in a case where the bit rate of the stereo encoding is larger than a predetermined value, the signal mixing unit 120 may obtain the input sound signal of the channel as it is as the encoding target signal of the channel for each channel, and in other cases than the above case, that is, in a case where the bit rate of the stereo encoding is equal to or less than the predetermined value described above, the signal mixing unit 120 may obtain, for each channel, as the encoding target signal of the channel, a signal in which the input sound signal of the channel and the input sound signal of the other channel are mixed, the signal being closer to the input sound signal of the channel as the bit rate of the stereo encoding is higher, in the entire range that can be taken by the bit rate of the stereo encoding, or obtain, for each channel, as the encoding target signal of the channel, a signal in which the input sound signal of the channel and the input sound signal of the other channel are mixed, the signal having the same closeness to the input sound signal of the channel regardless of the bit rate of the stereo encoding, in a partial range (first type range) of the range that can be taken by the bit rate of the stereo encoding, and, obtain, for each channel, as the encoding target signal of the channel, a signal in which the input sound signal of the channel and the input sound signal of the other channel are mixed, the signal being closer to the input sound signal of the channel as the bit rate of the stereo encoding is higher in a range other than the partial range (range other than first type range, second type range) of the range that can be taken by the bit rate of the stereo encoding (step S120). The signal mixing unit 120 may perform an operation in which “larger than a predetermined value” and “equal to or less than the predetermined value” described above are replaced with “equal to or larger than a predetermined value” and “smaller than the predetermined value”, respectively.

For example, it is sufficient if the signal mixing unit 120 obtains the input sound signal of the channel as it is as the encoding target signal of the channel for each channel in a first range, within the range that can be taken by the bit rate of the stereo encoding, that is a range in which the bit rate is larger than a predetermined value (that is, in a first case where the bit rate of the stereo encoding is larger than the predetermined value), and obtains, as the encoding target signal of the channel, for each channel in a second range that is a range other than the first range within the range that can be taken by the bit rate of the stereo encoding (that is, in a second case other than the first case, specifically, in a case where the bit rate of the stereo encoding is equal to or less than the predetermined value described above), a signal obtained by performing weighted addition on the input sound signal of the channel and the input sound signal of the other channel, in which the weight of the input sound signal of the channel in the weighted addition is a value having a weak monotonic increase relationship with respect to the bit rate of the stereo encoding in the second range, and the weight of the input sound signal of the other channel in the weighted addition is a value having a weak monotonic decrease relationship with respect to the bit rate of the stereo encoding in the second range. The signal mixing unit 120 may perform an operation in which “larger than a predetermined value” and “equal to or less than the predetermined value” described above are replaced with “equal to or larger than a predetermined value” and “smaller than the predetermined value”, respectively.

In a case where the bit rate of the stereo encoding of the stereo encoding device 200 is predetermined, it is sufficient if the signal mixing unit 120 uses the predetermined bit rate. In a case where the bit rate of the stereo encoding of the stereo encoding device 200 is decided for each frame by a bit rate decision processing unit, which is not illustrated, it is sufficient if the bit rate of each frame decided by the bit rate decision processing unit is used by the signal mixing unit 120. In short, it is sufficient if the signal mixing unit 120 uses the bit rate of the stereo encoding corresponding to each time subjected to processing.

Note that, in a case where the bit rate of the stereo encoding may be different for each frame as in a case where the bit rate of the stereo encoding of the stereo encoding device 200 is decided for each frame, the encoding target signal of each channel may be obtained using a value between the weight value determined from the bit rate of the previous frame and the weight value determined from the bit rate of the current frame near the boundary of the frame.

For example, assuming that wₚ₁ is the weight value of the first channel determined from the bit rate of the previous frame, that w_{c1} is the weight value of the first channel determined from the bit rate of the current frame, the first channel signal mixing unit 120-1 may set a value obtained by Formula (2-3) described below as a weight value w₁(t) for each time from the initial time (that is, the first time) of the current frame to the T₀−1st time, and set w_{c1} as the weight value w₁(t) for each time from the T₀th time to the last time (that is, the Tth time) of the current frame, and obtain the first channel encoding target signal x′₁(t) represented by Formula (2-4) described below instead of Formula (2-1) described above for each time t of the current frame.

$$\begin{matrix}[ Math . 3 ] & \\ {w}_{1} ( t ) = ( \frac{t}{{T}_{0}} ) {w}_{c 1} + ( 1 - \frac{t}{{T}_{0}} ) {w}_{p 1} & ( 2 ‐ 3 )\end{matrix}$$

$$\begin{matrix}[ Math . 4 ] & \\ {x}_{1}^{′} ( t ) = {w}_{1} ( t ) {x}_{1} ( t ) + ( 1 - {w}_{1} ( t ) ) {x}_{2} ( t ) & ( 2 ‐ 4 )\end{matrix}$$

Similarly, assuming that wₚ₂ is the weight value of the second channel determined from the bit rate of the previous frame, that w_{c2} is the weight value of the second channel determined from the bit rate of the current frame, the second channel signal mixing unit 120-2 may set a value obtained by Formula (2-5) described below as a weight value w₂(t) for each time from the initial time (that is, the first time) of the current frame to the T₀−1st time, and set w_{c2} as the weight value w₂(t) for each time from the T₀th time to the last time (that is, the Tth time) of the current frame, and obtain the second channel encoding target signal x′₂(t) represented by Formula (2-6) described below instead of Formula (2-2) described above for each time t of the current frame.

$$\begin{matrix}[ Math . 5 ] & \\ {w}_{2} ( t ) = ( \frac{t}{{T}_{0}} ) {w}_{c 2} + ( 1 - \frac{t}{{T}_{0}} ) {w}_{p 2} & ( 2 ‐ 5 )\end{matrix}$$

$$\begin{matrix}[ Math . 6 ] & \\ {x}_{2}^{′} ( t ) = {w}_{2} ( t ) {x}_{2} ( t ) + ( 1 - {w}_{2} ( t ) ) {x}_{1} ( t ) & ( 2 ‐ 6 )\end{matrix}$$

It is sufficient if the first channel signal mixing unit 120-1 stores the weight value w_{c1} of the current frame and uses the weight value w_{c1} as the weight value wₚ₁ in the processing of the next frame. Similarly, it is sufficient if the second channel signal mixing unit 120-2 stores the weight value w_{c2} of the current frame and uses the weight value w_{c2} as the weight value wₚ₂ in the processing of the next frame.

Since the signal mixing unit 120 obtains the encoding target signal of each channel by Formulae (2-4) and (2-6) described above, even in a case where the bit rate of the current frame is different from the bit rate of the previous frame, continuity of the waveform of the encoding target signal in the boundary portion of the frame can be maintained.

Note that, when both the weight value wₚ₁ and the weight value w_{c1} are values having a weak monotonic increase relationship with respect to the bit rate of the stereo encoding, the weight value w₁(t) obtained by Formula (2-3) described above is also a value having a weak monotonic increase relationship with respect to the bit rate of the stereo encoding. Similarly, when both the weight value wₚ₂ and the weight value w_{c2} are values having a weak monotonic increase relationship with respect to the bit rate of the stereo encoding, the weight value w₂(t) obtained by Formula (2-5) described above is also a value having a weak monotonic increase relationship with respect to the bit rate of the stereo encoding.

### First Modification of Second Embodiment

The second embodiment may be implemented by including processing of calculating an index value according to the bit rate of the stereo encoding of the stereo encoding device 200. A mode including the processing of calculating an index value according to the bit rate of the stereo encoding will be described as a first modification of the second embodiment. A sound signal processing device 100 of the first modification of the second embodiment is as indicated by the broken line and the solid line in FIG. 3 and includes an index value calculation unit 110 and a signal mixing unit 120. The sound signal processing device 100 performs processing of steps S110 and S120 indicated by the broken line and the solid line in FIG. 4. Hereinafter, the first modification of the second embodiment will be described focusing on differences from the second embodiment.

### [Index Value Calculation Unit 110]

The index value calculation unit 110 calculates an index value a having a weak monotonic increase relationship with respect to the bit rate of the stereo encoding of the stereo encoding device 200 or an index value α′ having a weak monotonic decrease relationship with respect to the bit rate of the stereo encoding of the stereo encoding device 200 (step S110). The index value a or the index value α′ obtained by the index value calculation unit 110 is output to the signal mixing unit 120.

The value having a weak monotonic increase relationship with respect to the bit rate of the stereo encoding of the stereo encoding device 200 is, for example, a function value of a weak monotonic increase function using the bit rate of the stereo encoding of the stereo encoding device 200 as an argument. Therefore, for example, it is sufficient if a weak monotonic increase function is stored in the index value calculation unit 110 in advance, and the index value calculation unit 110 acquires a function value by giving the bit rate of the stereo encoding of the frame as an argument to the weak monotonic increase function for each frame and obtains the acquired function value as the index value α. Alternatively, for example, for a plurality of subranges obtained by dividing a range that can be taken by the bit rate of the stereo encoding, it is sufficient if a set of information for specifying the bit rate of the stereo encoding belonging to each subrange and each function value corresponding to each subrange determined in advance so that the function value has a weak monotonic function relationship with respect to the bit rate of the stereo encoding is stored in the index value calculation unit 110 in advance, and the index value calculation unit 110 acquires, for each frame, a function value corresponding to the bit rate of the stereo encoding of the frame among the stored function values and obtains the acquired function value as the index value α. Note that the index value calculation unit 110 may use the bit rate itself of the stereo encoding as the index value α.

The value having a weak monotonic decrease relationship with respect to the bit rate of the stereo encoding of the stereo encoding device 200 is, for example, a function value of a weak monotonic decrease function using the bit rate of the stereo encoding of the stereo encoding device 200 as an argument. Therefore, for example, it is sufficient if a weak monotonic decrease function is stored in the index value calculation unit 110 in advance, and the index value calculation unit 110 acquires a function value by giving the bit rate of the stereo encoding of the frame as an argument to the weak monotonic decrease function for each frame and obtains the acquired function value as the index value α′. Alternatively, for example, for a plurality of subranges obtained by dividing a range that can be taken by the bit rate of the stereo encoding, it is sufficient if a set of information for specifying the bit rate of the stereo encoding belonging to each subrange and each function value corresponding to each subrange determined in advance so that the function value has a weak monotonic decrease relationship with respect to the bit rate of the stereo encoding is stored in the index value calculation unit 110 in advance, and the index value calculation unit 110 acquires, for each frame, a function value corresponding to the bit rate of the stereo encoding of the frame among the stored function values and obtains the acquired function value as the index value α′.

### [Signal Mixing Unit 120]

A first channel input sound signal and a second channel input sound signal, which are input sound signals of two channels constituting a two-channel stereo input sound signal input to the sound signal processing device 100, and the index value a or index value α′ output from the index value calculation unit 110 are input to the signal mixing unit 120. The signal mixing unit 120 to which the index value a is input obtains, for each channel of the first channel and the second channel, as the encoding target signal of the channel, a signal in which the input sound signal of the channel and the input sound signal of the other channel are mixed, the signal being closer to the input sound signal of the channel as the index value a is larger, and the signal mixing unit 120 to which the index value α′ is input obtains, for each channel of the first channel and the second channel, as the encoding target signal of the channel, a signal in which the input sound signal of the channel and the input sound signal of the other channel are mixed, the signal being closer to the input sound signal of the channel as the index value α′ is smaller (step S120). The encoding target signals (that is, the two-channel stereo encoding target signal) of the two channels obtained by the signal mixing unit 120 are output to the stereo encoding device 200 as output signals of the sound signal processing device 100.

For example, as illustrated in FIG. 3, it is sufficient if the signal mixing unit 120 includes a first channel signal mixing unit 120-1 and a second channel signal mixing unit 120-2. In this case, it is sufficient if the first channel signal mixing unit 120-1 to which the index value a is input obtains, as the first channel encoding target signal, a signal in which the first channel input sound signal and the second channel input sound signal are mixed, the signal being closer to the first channel input sound signal as the index value a is larger, and the first channel signal mixing unit 120-1 to which the index value α′ is input obtains, as the first channel encoding target signal, a signal in which the first channel input sound signal and the second channel input sound signal are mixed, the signal being closer to the input sound signal of the first channel as the index value α′ is smaller. Similarly, it is sufficient if the second channel signal mixing unit 120-2 to which the index value a is input obtains, as the second channel encoding target signal, a signal in which the second channel input sound signal and the first channel input sound signal are mixed, the signal being closer to the second channel input sound signal as the index value a is larger, and the second channel signal mixing unit 120-2 to which the index value α′ is input obtains, as the second channel encoding target signal, a signal in which the second channel input sound signal and the first channel input sound signal are mixed, the signal being closer to the second channel input sound signal as the index value α′ is smaller.

The signal mixing unit 120 to which the index value a is input may obtain the input sound signal of the channel as it is as the encoding target signal of the channel for each channel in a case where the index value a is larger than a predetermined value, and obtain the signal in which the input sound signal of the channel and the input sound signal of the other channel are mixed for each channel, the signal being closer to the input sound signal of the channel as the index value a is larger as the encoding target signal of the channel in a case other than the above case, that is, in a case where the index value a is equal to or less than the predetermined value (step S120). The signal mixing unit 120 may perform an operation in which “larger than a predetermined value” and “equal to or less than the predetermined value” described above are replaced with “equal to or larger than a predetermined value” and “smaller than the predetermined value”, respectively.

Similarly, the signal mixing unit 120 to which the index value α′ is input may obtain the input sound signal of the channel as it is as the encoding target signal of the channel for each channel in a case where the index value α′ is smaller than a predetermined value, and obtain the signal in which the input sound signal of the channel and the input sound signal of the other channel are mixed for each channel, the signal being closer to the input sound signal of the channel as the index value α′ is smaller as the encoding target signal of the channel in a case other than the above case, that is, in a case where the index value α′ is equal to or larger than the predetermined value (step S120). The signal mixing unit 120 may perform an operation in which “smaller than a predetermined value” and “equal to or larger than the predetermined value” described above are replaced with “equal to or less than a predetermined value” and “larger than the predetermined value”, respectively.

### First Example of Index Value Calculation Unit 110 and Signal Mixing Unit 120

The index value calculation unit 110 obtains an index value a of 0.5 or more and 1 or less and having a weak monotonic increase relationship with respect to the bit rate of the stereo encoding of the stereo encoding device 200. For example, the index value calculation unit 110 obtains, as the index value α, 0.5 when the bit rate of the stereo encoding of the stereo encoding device 200 is the minimum value of values that can be taken by the bit rate, 1 when the bit rate of the stereo encoding of the stereo encoding device 200 is the maximum value of values that can be taken by the bit rate, and a larger value as the bit rate of the stereo encoding of the stereo encoding device 200 is higher.

For each time t, the signal mixing unit 120 obtains a first channel encoding target signal x′₁(t) represented by Formula (2-7) described below and obtains a second channel encoding target signal x′₂(t) represented by Formula (2-8) described below.

$$\begin{matrix}[ Math . 7 ] & \\ {x}_{1}^{′} ( t ) = α {x}_{1} ( t ) + ( 1 - α ) {x}_{2} ( t ) & ( 2 ‐ 7 )\end{matrix}$$

$$\begin{matrix}[ Math . 8 ] & \\ {x}_{2}^{′} ( t ) = α {x}_{2} ( t ) + ( 1 - α ) {x}_{1} ( t ) & ( 2 ‐ 8 )\end{matrix}$$

When the index value calculation unit 110 calculates the index value a for each frame, the signal mixing unit 120 may, for each frame, set the index value α calculated for the previous frame by the index value calculation unit 110 as αₚ, set the index value α calculated for the current frame by the index value calculation unit 110 as α_{c}, set a value obtained by Formula (2-9) described below as an index value α(t) for each time from the initial time (that is, the first time) of the current frame to the T₀−1th time, set ac as the index value α(t) for each time from the T₀th time to the last time (that is, the Tth time) of the current frame, and obtain the first channel encoding target signal x′₁(t) represented by Formula (2-10) described below instead of Formula (2-7) described above for each time t of the current frame, and obtain the second channel encoding target signal x′₂(t) represented by Formula (2-11) described below instead of Formula (2-8) described above.

$$\begin{matrix}[ Math . 9 ] & \\ α ( t ) = ( \frac{t}{{T}_{0}} ) {α}_{c} + ( 1 - \frac{t}{{T}_{0}} ) {α}_{p} & ( 2 ‐ 9 )\end{matrix}$$

$$\begin{matrix}[ Math . 10 ] & \\ {x}_{1}^{′} ( t ) = α ( t ) {x}_{1} ( t ) + ( 1 - α ( t ) ) {x}_{2} ( t ) & ( 2 ‐ 10 )\end{matrix}$$

$$\begin{matrix}[ Math . 11 ] & \\ {x}_{2}^{′} ( t ) = α ( t ) {x}_{2} ( t ) + ( 1 - α ( t ) ) {x}_{1} ( t ) & ( 2 ‐ 11 )\end{matrix}$$

### Second Example of Index Value Calculation Unit 110 and Signal Mixing Unit 120

The index value calculation unit 110 obtains an index value α′ of 0 or more and 0.5 or less and having a weak monotonic decrease relationship with respect to the bit rate of the stereo encoding of the stereo encoding device 200. For example, the index value calculation unit 110 obtains, as the index value α′, 0 when the bit rate of the stereo encoding of the stereo encoding device 200 is the maximum value of values that can be taken by the bit rate, 0.5 when the bit rate of the stereo encoding of the stereo encoding device 200 is the minimum value of values that can be taken by the bit rate, and a larger value as the bit rate of the stereo encoding of the stereo encoding device 200 is lower.

For each time t, the signal mixing unit 120 obtains a first channel encoding target signal x′₁(t) represented by Formula (2-12) described below and obtains a second channel encoding target signal x′₂(t) represented by Formula (2-13) described below.

$$\begin{matrix}[ Math . 12 ] & \\ {x}_{1}^{′} ( t ) = ( 1 - {α}^{′} ) {x}_{1} ( t ) + {α}^{′} {x}_{2} ( t ) & ( 2 ‐ 12 )\end{matrix}$$

$$\begin{matrix}[ Math . 13 ] & \\ {x}_{2}^{′} ( t ) = ( 1 - {α}^{′} ) {x}_{2} ( t ) + {α}^{′} {x}_{1} ( t ) & ( 2 ‐ 13 )\end{matrix}$$

When the index value calculation unit 110 calculates the index value α′ for each frame, the signal mixing unit 120 may, for each frame, set the index value α′ calculated for the previous frame by the index value calculation unit 110 as α′ₚ, set the index value α′ calculated for the current frame by the index value calculation unit 110 as α′_{c}, set a value obtained by Formula (2-14) described below as an index value α′(t) for each time from the initial time (that is, the first time) of the current frame to the To-lth time, set α′_{c} as the index value α′ (t) for each time from the T₀th time to the last time (that is, the Tth time) of the current frame, and obtain the first channel encoding target signal x′₁(t) represented by Formula (2-15) described below instead of Formula (2-12) described above for each time t of the current frame, and obtain the second channel encoding target signal x′₂(t) represented by Formula (2-16) described below instead of Formula (2-13) described above.

$$\begin{matrix}[ Math . 14 ] & \\ {α}^{′} ( t ) = ( \frac{t}{{T}_{0}} ) {α}_{c}^{′} + ( 1 - \frac{t}{{T}_{0}} ) {α}_{p}^{′} & ( 2 ‐ 14 )\end{matrix}$$

$$\begin{matrix}[ Math . 15 ] & \\ {x}_{1}^{′} ( t ) = ( 1 - {α}^{′} ( t ) ) {x}_{1} ( t ) + {α}^{′} ( t ) {x}_{2} ( t ) & ( 2 ‐ 15 )\end{matrix}$$

$$\begin{matrix}[ Math . 16 ] & \\ {x}_{2}^{′} ( t ) = ( 1 - {α}^{′} ( t ) ) {x}_{2} ( t ) + {α}^{′} ( t ) {x}_{1} ( t ) & ( 2 ‐ 16 )\end{matrix}$$

### Second Modification of Second Embodiment

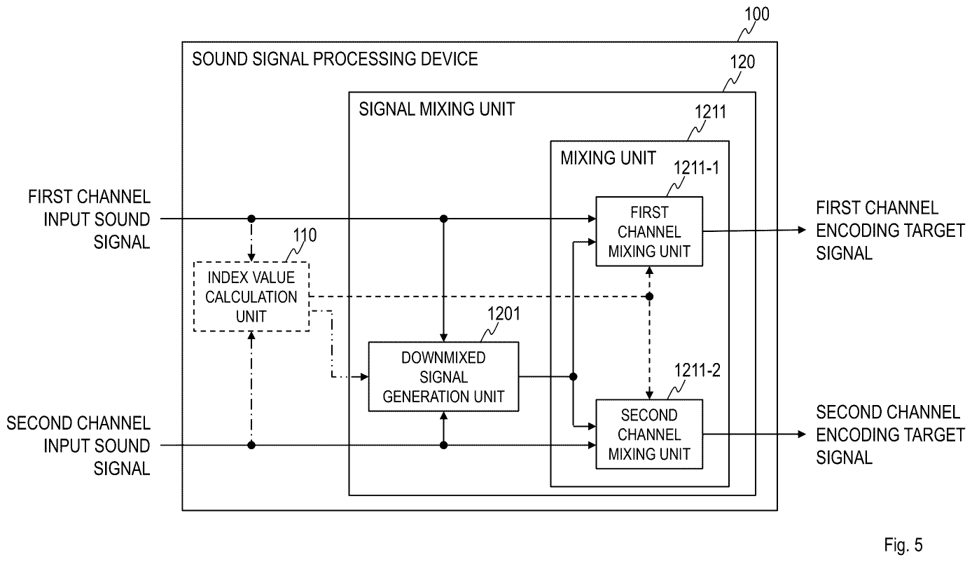

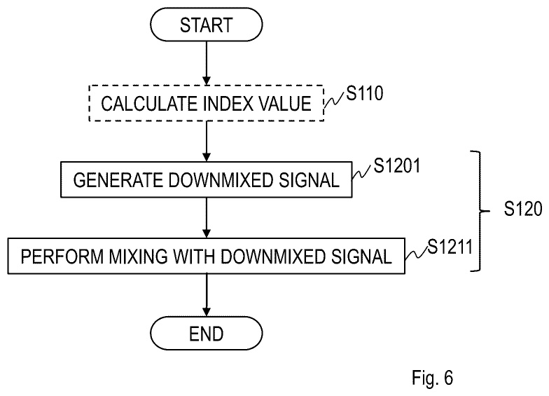

The second embodiment may be implemented including processing of mixing a two-channel stereo input sound signal to generate a downmixed signal. A mode including processing of generating a downmixed signal will be described as a second modification of the second embodiment. A sound signal processing device 100 of the second modification of the second embodiment is as indicated by the solid line in FIG. 5 and includes a signal mixing unit 120, and the signal mixing unit 120 includes a downmixed signal generation unit 1201 and a mixing unit 1211. As indicated by the solid line in FIG. 6, the sound signal processing device 100 performs processing of step S120 including steps S1201 and S1211. Hereinafter, the second modification of the second embodiment will be described focusing on differences from the second embodiment.

### [Downmixed Signal Generation Unit 1201]

A first channel input sound signal and a second channel input sound signal, which are input sound signals of two channels constituting a two-channel stereo input sound signal input to the sound signal processing device 100, are input to the downmixed signal generation unit 1201. The downmixed signal generation unit 1201 mixes the first channel input sound signal and the second channel input sound signal to generate a downmixed signal (step S1201). The downmixed signal obtained by the downmixed signal generation unit 1201 is output to the mixing unit 1211.

The downmixed signal generated by the downmixed signal generation unit 1201 may be any signal as long as it is a signal obtained by mixing the first channel input sound signal and the second channel input sound signal. For example, it is sufficient if the downmixed signal generation unit 1201 generates, as the downmixed signal, a signal obtained by averaging the first channel input sound signal and the second channel input sound signal, a signal obtained by averaging the first channel input sound signal and the second channel input sound signal in consideration of the time difference, or the like.

### [Mixing Unit 1211]

A first channel input sound signal and a second channel input sound signal, which are input sound signals of two channels constituting a two-channel stereo input sound signal input to the sound signal processing device 100, and the downmixed signal output from the downmixed signal generation unit 1201 are input to the mixing unit 1211. For example, for each channel of the first channel and the second channel, the mixing unit 1211 obtains, as an encoding target signal of the channel, a signal in which a downmixed signal is mixed with an input sound signal of the channel, the signal being closer to the input sound signal of the channel as the bit rate of the stereo encoding of the stereo encoding device 200 is higher, and the signal being closer to the downmixed signal as the bit rate of the stereo encoding of the stereo encoding device 200 is lower (step S1211). In other words, for each channel of the first channel and the second channel, the mixing unit 1211 obtains, as an encoding target signal of the channel, a signal in which an input sound signal of the channel is mixed with a downmixed signal, the signal being closer to the input sound signal of the channel as the bit rate of the stereo encoding of the stereo encoding device 200 is higher, and the signal being closer to the downmixed signal as the bit rate of the stereo encoding of the stereo encoding device 200 is lower. The encoding target signals (that is, the two-channel stereo encoding target signal) of the two channels obtained by the mixing unit 1211 are output to the stereo encoding device 200 as output signals of the sound signal processing device 100.

An example of the signal in which the input sound signal of the channel and the downmixed signal for each channel are mixed is a signal obtained by performing weighted addition on the input sound signal of the channel and the downmixed signal, and more specifically, is a signal obtained by performing weighted addition on the input sound signal of the channel at the time and the downmixed signal at the time for each time. The same applies hereinafter.

For example, as illustrated in FIG. 5, it is sufficient if the mixing unit 1211 includes a first channel mixing unit 1211-1 and a second channel mixing unit 1211-2. In this case, it is sufficient if the first channel mixing unit 1211-1 obtains, as a first channel encoding target signal, a signal in which a first channel input sound signal is mixed with a downmixed signal, the signal being closer to the first channel input sound signal as the bit rate of the stereo encoding of the stereo encoding device 200 is higher, and the signal being closer to the downmixed signal as the bit rate of the stereo encoding of the stereo encoding device 200 is lower. In addition, it is sufficient if the second channel mixing unit 1211-2 obtains, as a second channel encoding target signal, a signal in which a second channel input sound signal is mixed with a downmixed signal, the signal being closer to the second channel input sound signal as the bit rate of the stereo encoding of the stereo encoding device 200 is higher, and the signal being closer to the downmixed signal as the bit rate of the stereo encoding of the stereo encoding device 200 is lower.

Assuming that a downmixed signal at time t is x_{M}(t), for example, a weight value of 0 or more and 1 or less and having a positive correlation with the bit rate of the stereo encoding, that is, a weight value that is a larger value as the bit rate of the stereo encoding of the stereo encoding device 200 is higher is w₁, w₂, it is sufficient if the first channel mixing unit 1211-1 obtains the first channel encoding target signal x′₁(t) represented by Formula (2-17) described below for each time t, and the second channel mixing unit 1211-2 obtains the second channel encoding target signal x′₂(t) represented by Formula (2-18) described below for each time t. The weight value w₁ and the weight value w₂ may be the same value or different values.

$$\begin{matrix}[ Math . 17 ] & \\ {x}_{1}^{′} ( t ) = {w}_{1} {x}_{1} ( t ) + ( 1 - {w}_{1} ) {x}_{M} ( t ) & ( 2 ‐ 17 )\end{matrix}$$

$$\begin{matrix}[ Math . 18 ] & \\ {x}_{2}^{′} ( t ) = {w}_{2} {x}_{2} ( t ) + ( 1 - {w}_{2} ) {x}_{M} ( t ) & ( 2 ‐ 18 )\end{matrix}$$

Note that it is not essential that the weight values w₁ and w₂ are larger as the bit rate of the stereo encoding is higher in the entire range that can be taken by the bit rate of the stereo encoding, and the weight values w₁ and w₂ may be constant regardless of the bit rate of the stereo encoding in a partial range of the range that can be taken by the bit rate of the stereo encoding. That is, it is sufficient if each of the weight value w₁ and the weight value w₂ has a weak monotonic increase relationship with respect to the bit rate of the stereo encoding.

Therefore, it is sufficient if the mixing unit 1211 obtains, for each channel, as the encoding target signal of the channel, a signal in which the input sound signal of the channel and the downmixed signal are mixed, the signal being closer to the input sound signal of the channel as the bit rate of the stereo encoding is higher (that is, a signal closer to the downmixed signal as the bit rate of the stereo encoding is lower), in the entire range that can be taken by the bit rate of the stereo encoding, or obtains, for each channel, as the encoding target signal of the channel, a signal in which the input sound signal of the channel and the downmixed signal are mixed, the signal having the same closeness to the input sound signal of the channel regardless of the bit rate of the stereo encoding (that is, a signal having the same closeness to the downmixed signal regardless of the bit rate of the stereo encoding), in a partial range (first type range) of the range that can be taken by the bit rate of the stereo encoding, and, obtains, for each channel, as the encoding target signal of the channel, a signal in which the input sound signal of the channel and the downmixed signal are mixed, the signal being closer to the input sound signal of the channel as the bit rate of the stereo encoding is higher (that is, a signal closer to the downmixed signal as the bit rate of the stereo encoding is lower) in a range other than the partial range (range other than first type range, second type range) of the range that can be taken by the bit rate of the stereo encoding (step S1211). Each of the first type range and the second type range is one or more ranges. That is, there may be a plurality of first type ranges or there may be a plurality of second type ranges.

For example, it is sufficient if the mixing unit 1211 obtains, for each channel, as the encoding target signal of the channel, a signal obtained by performing weighted addition on the input sound signal of the channel and the downmixed signal, in which the weight of the input sound signal of the channel in the weighted addition is a value having a weak monotonic increase relationship with respect to the bit rate of the stereo encoding, and the weight of the downmixed signal in the weighted addition is a value having a weak monotonic decrease relationship with respect to the bit rate of the stereo encoding.

The value having a weak monotonic increase relationship with respect to the bit rate of the stereo encoding is, for example, a function value of a weak monotonic increase function using the bit rate of the stereo encoding as an argument. Therefore, for example, it is sufficient if a weak monotonic increase function for each channel is stored in the mixing unit 1211 in advance, and the mixing unit 1211 acquires a function value by giving the bit rate of the stereo encoding of the frame as an argument to the weak monotonic increase function for the channel for each channel of each frame and uses the acquired function value as the weight of the input sound signal of the channel. Alternatively, for example, for a plurality of types of bit rates that can be taken by the stereo encoding of the stereo encoding device 200, it is sufficient if a set of each bit rate and each weight value corresponding to each bit rate determined in advance such that the weight value has a weak monotonic increase relationship with respect to the bit rate is stored in the mixing unit 1211 in advance, and the mixing unit 1211 acquires the weight value corresponding to the bit rate of the stereo encoding of the frame among the stored weight values for each channel of each frame and uses the acquired weight value as the weight of the input sound signal of the channel.

The value having a weak monotonic decrease relationship with respect to the bit rate of the stereo encoding is, for example, a function value of a weak monotonic decrease function using the bit rate of the stereo encoding as an argument. Therefore, for example, it is sufficient if a weak monotonic decrease function for each channel is stored in the mixing unit 1211 in advance, and the mixing unit 1211 acquires a function value by giving the bit rate of the stereo encoding of the frame as an argument to the weak monotonic decrease function for the channel for each channel of each frame and uses the acquired function value as the weight of the downmixed signal. Alternatively, for example, for a plurality of types of bit rates that can be taken by the stereo encoding of the stereo encoding device 200, it is sufficient if a set of each bit rate and each weight value corresponding to each bit rate determined in advance such that the weight value has a weak monotonic decrease relationship with respect to the bit rate is stored in the mixing unit 1211 in advance, and the mixing unit 1211 acquires the weight value corresponding to the bit rate of the stereo encoding of the frame among the stored weight values for each channel of each frame and uses the acquired weight value as the weight of the downmixed signal.

When the weight value w₁ is 1, the first channel encoding target signal x′₁(t) represented by Formula (2-17) described above is the same as the first channel input sound signal x₁(t), and when the weight value w₂ is 1, the second channel encoding target signal x′₂(t) represented by Formula (2-18) described above is the same as the second channel input sound signal x₂(t). Therefore, in a case where the weight value w₁ and the weight value w₂ when the bit rate of the stereo encoding is the maximum value of values that can be taken by the bit rate or within a predetermined range including the maximum value are 1, the mixing unit 1211 may use the input sound signal of the channel as the encoding target signal of the channel as it is for each channel when the bit rate of the stereo encoding is the maximum value of values that can be taken or within the predetermined range including the maximum value.

When the weight value w₁ is 0, the first channel encoding target signal x′₁(t) represented by Formula (2-17) described above is the same as the downmixed signal x_{M}(t), and when the weight value w₂ is 0, the second channel encoding target signal x′₂(t) represented by Formula (2-18) described above is the same as the downmixed signal x_{M}(t). Therefore, in a case where the weight value w₁ and the weight value w₂ when the bit rate of the stereo encoding is the minimum value of values that can be taken by the bit rate or within a predetermined range including the minimum value are 0, the mixing unit 1211 may use the downmixed signal as the encoding target signal of the channel as it is for each channel when the bit rate of the stereo encoding is the minimum value of values that can be taken by the bit rate or within the predetermined range including the minimum value.

Therefore, in a case where the bit rate of the stereo encoding is larger than a predetermined value, the mixing unit 1211 may obtain the input sound signal of the channel as it is as the encoding target signal of the channel for each channel, and in other cases than the above case, that is, in a case where the bit rate of the stereo encoding is equal to or less than the predetermined value described above, the mixing unit 1211 may obtain, for each channel, as the encoding target signal of the channel, a signal in which the input sound signal of the channel and the downmixed signal are mixed, the signal being closer to the input sound signal of the channel as the bit rate of the stereo encoding is higher (that is, a signal closer to the downmixed signal as the bit rate of the stereo encoding is lower), in the entire range that can be taken by the bit rate of the stereo encoding, or obtain, for each channel, as the encoding target signal of the channel, a signal in which the input sound signal of the channel and the downmixed signal are mixed, the signal having the same closeness to the input sound signal of the channel regardless of the bit rate of the stereo encoding (that is, a signal having the same closeness to the downmixed signal regardless of the bit rate of the stereo encoding), in a partial range (first type range) of the range that can be taken by the bit rate of the stereo encoding, and, obtain, for each channel, as the encoding target signal of the channel, a signal in which the input sound signal of the channel and the downmixed signal are mixed, the signal being closer to the input sound signal of the channel as the bit rate of the stereo encoding is higher (that is, a signal closer to the downmixed signal as the bit rate of the stereo encoding is lower) in a range other than the partial range (range other than first type range, second type range) of the range that can be taken by the bit rate of the stereo encoding (step S1211). The mixing unit 1211 may perform an operation in which “larger than a predetermined value” and “equal to or less than the predetermined value” described above are replaced with “equal to or larger than a predetermined value” and “smaller than the predetermined value”, respectively. Each of the first type range and the second type range is one or more ranges. That is, there may be a plurality of first type ranges or there may be a plurality of second type ranges.

For example, it is sufficient if the mixing unit 1211 obtains the input sound signal of the channel as it is as the encoding target signal of the channel for each channel in a first range, within the range that can be taken by the bit rate of the stereo encoding, that is a range in which the bit rate is larger than a predetermined value (that is, in a first case where the bit rate of the stereo encoding is larger than the predetermined value), and obtains, as the encoding target signal of the channel, for each channel in a second range that is a range other than the first range within the range that can be taken by the bit rate of the stereo encoding (that is, in a second case other than the first case, specifically, in a case where the bit rate of the stereo encoding is equal to or less than the predetermined value described above), a signal obtained by performing weighted addition on the input sound signal of the channel and the downmixed signal, in which the weight of the input sound signal of the channel in the weighted addition is a value having a weak monotonic increase relationship with respect to the bit rate of the stereo encoding in the second range, and the weight of the downmixed signal in the weighted addition is a value having a weak monotonic decrease relationship with respect to the bit rate of the stereo encoding in the second range. The mixing unit 1211 may perform an operation in which “larger than a predetermined value” and “equal to or less than the predetermined value” described above are replaced with “equal to or larger than a predetermined value” and “smaller than the predetermined value”, respectively.

Alternatively, in a case where the bit rate of the stereo encoding is smaller than a predetermined value, the mixing unit 1211 may obtain the downmixed signal as it is as the encoding target signal of the channel for each channel, and in other cases than the above case, that is, in a case where the bit rate of the stereo encoding is equal to or larger than the predetermined value described above, the mixing unit 1211 may obtain, for each channel, as the encoding target signal of the channel, a signal in which the input sound signal of the channel and the downmixed signal are mixed, the signal being closer to the input sound signal of the channel as the bit rate of the stereo encoding is higher (that is, a signal closer to the downmixed signal as the bit rate of the stereo encoding is lower), in the entire range that can be taken by the bit rate of the stereo encoding, or obtain, for each channel, as the encoding target signal of the channel, a signal in which the input sound signal of the channel and the downmixed signal are mixed, the signal having the same closeness to the input sound signal of the channel regardless of the bit rate of the stereo encoding (that is, a signal having the same closeness to the downmixed signal regardless of the bit rate of the stereo encoding), in a partial range (first type range) of the range that can be taken by the bit rate of the stereo encoding, and, obtain, for each channel, as the encoding target signal of the channel, a signal in which the input sound signal of the channel and the downmixed signal are mixed, the signal being closer to the input sound signal of the channel as the bit rate of the stereo encoding is higher (that is, a signal closer to the downmixed signal as the bit rate of the stereo encoding is lower) in a range other than the partial range (range other than first type range, second type range) of the range that can be taken by the bit rate of the stereo encoding (step S1211). The mixing unit 1211 may perform an operation in which “smaller than a predetermined value” and “equal to or larger than the predetermined value” described above are replaced with “equal to or less than a predetermined value” and “larger than the predetermined value”, respectively. Each of the first type range and the second type range is one or more ranges. That is, there may be a plurality of first type ranges or there may be a plurality of second type ranges.

For example, it is sufficient if the mixing unit 1211 obtains the downmixed signal as it is as the encoding target signal of the channel for each channel in a first range, within the range that can be taken by the bit rate of the stereo encoding, that is a range in which the bit rate is smaller than a predetermined value (that is, in a first case where the bit rate of the stereo encoding is smaller than the predetermined value), and obtains, as the encoding target signal of the channel, for each channel in a second range that is a range other than the first range within the range that can be taken by the bit rate of the stereo encoding (that is, in a second case other than the first case, specifically, in a case where the bit rate of the stereo encoding is equal to or larger than the predetermined value described above), a signal obtained by performing weighted addition on the input sound signal of the channel and the downmixed signal, in which the weight of the input sound signal of the channel in the weighted addition is a value having a weak monotonic increase relationship with respect to the bit rate of the stereo encoding in the second range, and the weight of the downmixed signal in the weighted addition is a value having a weak monotonic decrease relationship with respect to the bit rate of the stereo encoding in the second range. The mixing unit 1211 may perform an operation in which “smaller than a predetermined value” and “equal to or larger than the predetermined value” described above are replaced with “equal to or less than a predetermined value” and “larger than the predetermined value”, respectively.

Alternatively, in a case where the bit rate of the stereo encoding is larger than a predetermined first value, the mixing unit 1211 may obtain the input sound signal of the channel as it is as the encoding target signal of the channel for each channel, and in a case where the bit rate of the stereo encoding is equal to or less than a predetermined second value smaller than the predetermined first value, obtain the downmixed signal for each channel as it is as the encoding target signal of the channel, in a case where neither of the two cases is applicable, that is, in a case where the bit rate of the stereo encoding is equal to or less than the predetermined first value and is larger than the predetermined second value, the mixing unit 1211 may obtain, for each channel, as the encoding target signal of the channel, a signal in which the input sound signal of the channel and the downmixed signal are mixed, the signal being closer to the input sound signal of the channel as the bit rate of the stereo encoding is higher (that is, a signal closer to the downmixed signal as the bit rate of the stereo encoding is lower), in the entire range that can be taken by the bit rate of the stereo encoding, or obtain, for each channel, as the encoding target signal of the channel, a signal in which the input sound signal of the channel and the downmixed signal are mixed, the signal having the same closeness to the input sound signal of the channel regardless of the bit rate of the stereo encoding (that is, a signal having the same closeness to the downmixed signal regardless of the bit rate of the stereo encoding), in a partial range (first type range) of the range that can be taken by the bit rate of the stereo encoding, and, obtain, for each channel, as the encoding target signal of the channel, a signal in which the input sound signal of the channel and the downmixed signal are mixed, the signal being closer to the input sound signal of the channel as the bit rate of the stereo encoding is higher (that is, a signal closer to the downmixed signal as the bit rate of the stereo encoding is lower) in a range other than the partial range (range other than first type range, second type range) of the range that can be taken by the bit rate of the stereo encoding (step S1211). The mixing unit 1211 may perform an operation in which “larger than a predetermined first value” and “equal to or less than the predetermined first value” described above are replaced with “equal to or larger than a predetermined first value” and “smaller than the predetermined first value”, respectively, and may perform an operation in which “larger than a predetermined second value” and “equal to or less than the predetermined second value” described above are replaced with “equal to or larger than a predetermined second value” and “smaller than the predetermined second value”, respectively. Each of the first type range and the second type range is one or more ranges. That is, there may be a plurality of first type ranges or there may be a plurality of second type ranges.

For example, it is sufficient if the mixing unit 1211 obtains the input sound signal of the channel as it is as the encoding target signal of the channel for each channel in a first range, within the range that can be taken by the bit rate of the stereo encoding, that is a range in which the bit rate is larger than a predetermined first value (that is, in a first case where the bit rate of the stereo encoding is larger than the predetermined first value), obtains the downmixed signal as it is as the encoding target signal of the channel for each channel in a second range, within the range that can be taken by the bit rate of the stereo encoding, that is a range in which the bit rate is equal to or less than the predetermined second value smaller than the predetermined first value described above (that is, in a second case where the bit rate of the stereo encoding is equal to or less than the predetermined second value smaller than the predetermined first value described above), and obtains, as the encoding target signal of the channel, for each channel in a third range, within the range that can be taken by the bit rate of the stereo encoding, that is a range other than the first range and the second range (that is, in a third case other than the first case and the second case, specifically, in a case where the bit rate of the stereo encoding is equal to or less than the predetermined first value described above and larger than the predetermined second value described above), a signal obtained by performing weighted addition on the input sound signal of the channel and the downmixed signal, in which the weight of the input sound signal of the channel in the weighted addition is a value having a weak monotonic increase relationship with respect to the bit rate of the stereo encoding in the third range, and the weight of the downmixed signal in the weighted addition is a value having a weak monotonic decrease relationship with respect to the bit rate of the stereo encoding in the third range. The mixing unit 1211 may perform an operation in which “larger than a predetermined first value” and “equal to or less than the predetermined first value” described above are replaced with “equal to or larger than a predetermined first value” and “smaller than the predetermined first value”, respectively, and may perform an operation in which “larger than a predetermined second value” and “equal to or less than the predetermined second value” described above are replaced with “equal to or larger than a predetermined second value” and “smaller than the predetermined second value”, respectively.

In a case where the bit rate of the stereo encoding may be different for each frame, assuming that wₚ₁ is the weight value of the first channel determined from the bit rate of the previous frame, that w_{c1} is the weight value of the first channel determined from the bit rate of the current frame, the first channel mixing unit 1211-1 may set a value obtained by Formula (2-19) described below as a weight value w₁(t) for each time from the initial time (that is, the first time) of the current frame to the T₀−1st time, and set w_{c1} as the weight value w₁(t) for each time from the T₀th time to the last time (that is, the Tth time) of the current frame, and obtain the first channel encoding target signal x′₁(t) represented by Formula (2-20) described below instead of Formula (2-17) described above for each time t of the current frame.

$$\begin{matrix}[ Math . 19 ] & \\ {w}_{1} ( t ) = ( \frac{t}{{T}_{0}} ) {w}_{c 1} + ( 1 - \frac{t}{{T}_{0}} ) {w}_{p 1} & ( 2 ‐ 19 )\end{matrix}$$

$$\begin{matrix}[ Math . 20 ] & \\ {x}_{1}^{′} ( t ) = {w}_{1} ( t ) {x}_{1} ( t ) + ( 1 - {w}_{1} ( t ) ) {x}_{M} ( t ) & ( 2 ‐ 20 )\end{matrix}$$

Similarly, assuming that wₚ₂ is the weight value of the second channel determined from the bit rate of the previous frame, that w_{c2} is the weight value of the second channel determined from the bit rate of the current frame, the second channel mixing unit 1211-2 may set a value obtained by Formula (2-21) described below as a weight value w₂(t) for each time from the initial time (that is, the first time) of the current frame to the T₀−1st time, and set w_{c2} as the weight value w₂(t) for each time from the T₀th time to the last time (that is, the Tth time) of the current frame, and obtain the second channel encoding target signal x′₂(t) represented by Formula (2-22) described below instead of Formula (2-18) described above for each time t of the current frame.

$$\begin{matrix}[ Math . 21 ] & \\ {w}_{2} ( t ) = ( \frac{t}{{T}_{0}} ) {w}_{c 2} + ( 1 - \frac{t}{{T}_{0}} ) {w}_{p 2} & ( 2 ‐ 21 )\end{matrix}$$

$$\begin{matrix}[ Math . 22 ] & \\ {x}_{2}^{′} ( t ) = {w}_{2} ( t ) {x}_{2} ( t ) + ( 1 - {w}_{2} ( t ) ) {x}_{M} ( t ) & ( 2 ‐ 22 )\end{matrix}$$

### Third Modification of Second Embodiment

The second modification of the second embodiment may be implemented by including processing of calculating an index value according to the bit rate of the stereo encoding of the stereo encoding device 200. A mode including the processing of calculating an index value according to the bit rate of the stereo encoding will be described as a third modification of the second embodiment. A sound signal processing device 100 of the third modification of the second embodiment is as indicated by the broken line and the solid line in FIG. 5 and includes an index value calculation unit 110 and a signal mixing unit 120, and the signal mixing unit 120 includes a downmixed signal generation unit 1201 and a mixing unit 1211. As indicated by the broken line and the solid line in FIG. 6, the sound signal processing device 100 performs processing of step S110, and processing of step S120 including steps S1201 and S1211. Hereinafter, the third modification of the second embodiment will be described focusing on differences from the second modification of the second embodiment.

### [Index Value Calculation Unit 110]

Input/output and operation of the index value calculation unit 110 are the same as those in the first modification of the second embodiment, and details are as described in the first modification of the second embodiment. The index value calculation unit 110 calculates an index value α having a weak monotonic increase relationship with respect to the bit rate of the stereo encoding of the stereo encoding device 200 or an index value α′ having a weak monotonic decrease relationship with respect to the bit rate of the stereo encoding of the stereo encoding device 200 (step S110). The index value α or the index value α′ obtained by the index value calculation unit 110 is output to the signal mixing unit 120.

### [Downmixed Signal Generation Unit 1201]

Input/output and operation of the downmixed signal generation unit 1201 are the same as those in the second modification of the second embodiment, and details are as described in the second modification of the second embodiment. A first channel input sound signal and a second channel input sound signal, which are input sound signals of two channels constituting a two-channel stereo input sound signal input to the sound signal processing device 100, are input to the downmixed signal generation unit 1201. The downmixed signal generation unit 1201 mixes the first channel input sound signal and the second channel input sound signal to generate a downmixed signal (step S1201). The downmixed signal obtained by the downmixed signal generation unit 1201 is output to the mixing unit 1211.

### [Mixing Unit 1211]

A first channel input sound signal and a second channel input sound signal, which are input sound signals of two channels constituting a two-channel stereo input sound signal input to the sound signal processing device 100, the downmixed signal output from the downmixed signal generation unit 1201, and the index value α or the index value α′ output from the index value calculation unit 110 are input to the mixing unit 1211. The mixing unit 1211 to which the index value α is input obtains, for each channel of the first channel and the second channel, as the encoding target signal of the channel, a signal in which the input sound signal of the channel and the downmixed signal are mixed, the signal being closer to the input sound signal of the channel as the index value α is larger (that is, the signal closer to the downmixed signal as the index value α is smaller), and the mixing unit 1211 to which the index value α′ is input obtains, for each channel of the first channel and the second channel, as the encoding target signal of the channel, a signal in which the input sound signal of the channel and the downmixed signal are mixed, the signal being closer to the input sound signal of the channel as the index value α′ is smaller (that is, the signal closer to the downmixed signal as the index value α′ is larger) (step S1211). The encoding target signals (that is, the two-channel stereo encoding target signal) of the two channels obtained by the mixing unit 1211 are output to the stereo encoding device 200 as output signals of the sound signal processing device 100.

For example, as illustrated in FIG. 5, it is sufficient if the mixing unit 1211 includes a first channel mixing unit 1211-1 and a second channel mixing unit 1211-2. In this case, it is sufficient if the first channel mixing unit 1211-1 to which the index value α is input obtains, as the first channel encoding target signal, a signal in which the first channel input sound signal and the downmixed signal are mixed, the signal being closer to the first channel input sound signal as the index value α is larger and closer to the downmixed signal as the index value α is smaller, and the first channel mixing unit 1211-1 to which the index value α′ is input obtains, as the first channel encoding target signal, a signal in which the first channel input sound signal and the downmixed signal are mixed, the signal being closer to the first channel input sound signal as the index value α′ is smaller and closer to the downmixed signal as the index value α′ is larger. In addition, it is sufficient if the second channel mixing unit 1211-2 to which the index value α is input obtains, as the second channel encoding target signal, a signal in which the second channel input sound signal and the downmixed signal are mixed, the signal being closer to the second channel input sound signal as the index value α is larger and closer to the downmixed signal as the index value α is smaller, and the second channel mixing unit 1211-2 to which the index value α′ is input obtains, as the second channel encoding target signal, a signal in which the second channel input sound signal and the downmixed signal are mixed, the signal being closer to the second channel input sound signal as the index value α′ is smaller and closer to the downmixed signal as the index value α′ is larger.

The mixing unit 1211 to which the index value α is input may obtain the input sound signal of the channel as it is as the encoding target signal of the channel for each channel in a case where the index value α is larger than a predetermined value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case other than the above case, that is, in a case where the index value α is equal to or less than the predetermined value (step S1211). The mixing unit 1211 may perform an operation in which “larger than a predetermined value” and “equal to or less than the predetermined value” described above are replaced with “equal to or larger than a predetermined value” and “smaller than the predetermined value”, respectively.

Alternatively, the mixing unit 1211 to which the index value α is input may obtain the downmixed signal as it is as the encoding target signal of the channel for each channel in a case where the index value α is smaller than a predetermined value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case other than the above case, that is, in a case where the index value α is equal to or larger than the predetermined value (step S1211). The mixing unit 1211 may perform an operation in which “smaller than a predetermined value” and “equal to or larger than the predetermined value” described above are replaced with “equal to or less than a predetermined value” and “larger than the predetermined value”, respectively.

Alternatively, the mixing unit 1211 to which the index value α is input may obtain the input sound signal of the channel as it is as the encoding target signal of the channel for each channel in a case where the index value α is larger than a predetermined first value, obtain the downmixed signal as it is as the encoding target signal of the channel for each channel in a case where the index value α is equal to or less than a predetermined second value smaller than the predetermined first value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case where neither of the two cases is applicable, that is, in a case where the index value α is equal to or less than the predetermined first value and larger than the predetermined second value (step S1211). The mixing unit 1211 may perform an operation in which “larger than a predetermined first value” and “equal to or less than the predetermined first value” described above are replaced with “equal to or larger than a predetermined first value” and “smaller than the predetermined first value”, respectively, and may perform an operation in which “larger than a predetermined second value” and “equal to or less than the predetermined second value” described above are replaced with “equal to or larger than a predetermined second value” and “smaller than the predetermined second value”, respectively.

Alternatively, the mixing unit 1211 to which the index value α′ is input may obtain the input sound signal of the channel as it is as the encoding target signal of the channel for each channel in a case where the index value α′ is smaller than a predetermined value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case other than the above case, that is, in a case where the index value α′ is equal to or larger than the predetermined value (step S1211). The mixing unit 1211 may perform an operation in which “smaller than a predetermined value” and “equal to or larger than the predetermined value” described above are replaced with “equal to or less than a predetermined value” and “larger than the predetermined value”, respectively.

Alternatively, the mixing unit 1211 to which the index value α′ is input may obtain the downmixed signal as it is as the encoding target signal of the channel for each channel in a case where the index value α′ is larger than a predetermined value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case other than the above case, that is, in a case where the index value α′ is equal to or less than the predetermined value (step S1211). The mixing unit 1211 may perform an operation in which “larger than a predetermined value” and “equal to or less than the predetermined value” described above are replaced with “equal to or larger than a predetermined value” and “smaller than the predetermined value”, respectively.

Alternatively, the mixing unit 1211 to which the index value α′ is input may obtain the input sound signal of the channel as it is as the encoding target signal of the channel for each channel in a case where the index value α′ is smaller than a predetermined first value, obtain the downmixed signal as it is as the encoding target signal of the channel for each channel in a case where the index value α′ is equal to or larger than a predetermined second value larger than the predetermined first value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case where neither of the two cases is applicable, that is, in a case where the index value α′ is equal to or larger than the predetermined first value and smaller than the predetermined second value (step S1211). The mixing unit 1211 may perform an operation in which “smaller than a predetermined first value” and “equal to or larger than the predetermined first value” described above are replaced with “equal to or less than a predetermined first value” and “larger than the predetermined first value”, respectively, and may perform an operation in which “smaller than a predetermined second value” and “equal to or larger than the predetermined second value” described above are replaced with “equal to or less than a predetermined second value” and “larger than the predetermined second value”, respectively.

### First Example of Index Value Calculation Unit 110 and Mixing Unit 1211

The index value calculation unit 110 obtains an index value α of 0 or more and 1 or less and having a weak monotonic increase relationship with respect to the bit rate of the stereo encoding of the stereo encoding device 200. For example, the index value calculation unit 110 obtains, as the index value α, 0 when the bit rate of the stereo encoding of the stereo encoding device 200 is the minimum value of values that can be taken by the bit rate, 1 when the bit rate of the stereo encoding of the stereo encoding device 200 is the maximum value of values that can be taken by the bit rate, and a larger value as the bit rate of the stereo encoding of the stereo encoding device 200 is higher.

Alternatively, for example, the index value calculation unit 110 obtains 1 as the index value α when the bit rate of the stereo encoding of the stereo encoding device 200 is 32 kbps, obtains 0.8 as the index value α when the bit rate of the stereo encoding of the stereo encoding device 200 is 24.4 kbps, obtains 0.6 as the index value α when the bit rate of the stereo encoding of the stereo encoding device 200 is 16.4 kbps, and obtains 0.4 as the index value α when the bit rate of the stereo encoding of the stereo encoding device 200 is 13.2 kbps.

For each time t, the mixing unit 1211 obtains a first channel encoding target signal x′₁(t) represented by Formula (2-23) described below and obtains a second channel encoding target signal x′₂(t) represented by Formula (2-24) described below.

$$\begin{matrix}[ Math . 23 ] & \\ {x}_{1}^{′} ( t ) = α {x}_{1} ( t ) + ( 1 - α ) {x}_{M} ( t ) & ( 2 ‐ 23 )\end{matrix}$$

$$\begin{matrix}[ Math . 24 ] & \\ {x}_{2}^{′} ( t ) = α {x}_{2} ( t ) + ( 1 - α ) {x}_{M} ( t ) & ( 2 ‐ 24 )\end{matrix}$$

When the index value calculation unit 110 calculates the index value α for each frame, the mixing unit 1211 may, for each frame, set the index value α calculated for the previous frame by the index value calculation unit 110 as ap, set the index value α calculated for the current frame by the index value calculation unit 110 as α_{c}, set a value obtained by Formula (2-25) described below as an index value α(t) for each time from the initial time (that is, the first time) of the current frame to the T₀−1th time, set ac as the index value α(t) for each time from the T₀th time to the last time (that is, the Tth time) of the current frame, and obtain the first channel encoding target signal x′₁(t) represented by Formula (2-26) described below instead of Formula (2-23) described above for each time t of the current frame, and obtain the second channel encoding target signal x′₂(t) represented by Formula (2-27) described below instead of Formula (2-24) described above.

$$\begin{matrix}[ Math . 25 ] & \\ α ( t ) = ( \frac{t}{{T}_{0}} ) {α}_{c} + ( 1 - \frac{t}{{T}_{0}} ) {α}_{p} & ( 2 ‐ 25 )\end{matrix}$$

$$\begin{matrix}[ Math . 26 ] & \\ {x}_{1}^{′} ( t ) = α ( t ) {x}_{1} ( t ) + ( 1 - α ( t ) ) {x}_{M} ( t ) & ( 2 ‐ 26 )\end{matrix}$$

$$\begin{matrix}[ Math . 27 ] & \\ {x}_{2}^{′} ( t ) = α ( t ) {x}_{2} ( t ) + ( 1 - α ( t ) ) {x}_{M} ( t ) & ( 2 ‐ 27 )\end{matrix}$$

### Second Example of Index Value Calculation Unit 110 and Mixing Unit 1211

The index value calculation unit 110 obtains an index value α′ of 0 or more and 1 or less and having a weak monotonic decrease relationship with respect to the bit rate of the stereo encoding of the stereo encoding device 200. For example, the index value calculation unit 110 obtains, as the index value α′, 0 when the bit rate of the stereo encoding of the stereo encoding device 200 is the maximum value of values that can be taken by the bit rate, 1 when the bit rate of the stereo encoding of the stereo encoding device 200 is the minimum value of values that can be taken by the bit rate, and a larger value as the bit rate of the stereo encoding of the stereo encoding device 200 is lower.

For each time t, the mixing unit 1211 obtains a first channel encoding target signal x′₁(t) represented by Formula (2-28) described below and obtains a second channel encoding target signal x′₂(t) represented by Formula (2-29) described below.

$$\begin{matrix}[ Math . 28 ] & \\ {x}_{1}^{′} ( t ) = ( 1 - {α}^{′} ) {x}_{1} ( t ) + {α}^{′} {x}_{M} ( t ) & ( 2 ‐ 28 )\end{matrix}$$

$$\begin{matrix}[ Math . 29 ] & \\ {x}_{2}^{′} ( t ) = ( 1 - {α}^{′} ) {x}_{2} ( t ) + {α}^{′} {x}_{M} ( t ) & ( 2 ‐ 29 )\end{matrix}$$

When the index value calculation unit 110 calculates the index value α′ for each frame, the mixing unit 1211 may, for each frame, set the index value α′ calculated for the previous frame by the index value calculation unit 110 as α′ₚ, set the index value α′ calculated for the current frame by the index value calculation unit 110 as α′_{c}, set a value obtained by Formula (2-30) described below as an index value α′(t) for each time from the initial time (that is, the first time) of the current frame to the T₀−1th time, set α′_{c} as the index value α′ (t) for each time from the T₀th time to the last time (that is, the Tth time) of the current frame, and obtain the first channel encoding target signal x′₁(t) represented by Formula (2-31) described below instead of Formula (2-28) described above for each time t of the current frame, and obtain the second channel encoding target signal x′₂(t) represented by Formula (2-32) described below instead of Formula (2-29) described above.

$$\begin{matrix}[ Math . 30 ] & \\ {α}^{′} ( t ) = ( \frac{t}{{T}_{0}} ) {α}_{c}^{′} + ( 1 - \frac{t}{{T}_{0}} ) {α}_{p}^{′} & ( 2 ‐ 30 )\end{matrix}$$

$$\begin{matrix}[ Math . 31 ] & \\ {x}_{1}^{′} ( t ) = ( 1 - {α}^{′} ( t ) ) {x}_{1} ( t ) + {α}^{′} ( t ) {x}_{M} ( t ) & ( 2 ‐ 31 )\end{matrix}$$

$$\begin{matrix}[ Math . 32 ] & \\ {x}_{2}^{′} ( t ) = ( 1 - {α}^{′} ( t ) ) {x}_{2} ( t ) + {α}^{′} ( t ) {x}_{M} ( t ) & ( 2 ‐ 32 )\end{matrix}$$

### Third Embodiment

In the third embodiment, a sound signal processing device 100 that performs processing according to an absolute value of an inter-channel time difference in the two-channel stereo input sound signal input to the sound signal processing device 100 will be described. The sound signal processing device 100 of the third embodiment is as indicated by the one-dot chain line, the broken line, and the solid line in FIG. 3 and includes an index value calculation unit 110 and a signal mixing unit 120. The sound signal processing device 100 performs processing of steps S110 and S120 indicated by the broken line and the solid line in FIG. 4. Hereinafter, the third embodiment will be described focusing on differences from the second embodiment.

### [Index Value Calculation Unit 110]

A first channel input sound signal and a second channel input sound signal, which are input sound signals of two channels constituting a two-channel stereo input sound signal input to the sound signal processing device 100, are input to the index value calculation unit 110. The index value calculation unit 110 calculates an absolute value |ITD| of the inter-channel time difference of the two-channel stereo input sound signal (step S110). The absolute value |ITD| of the inter-channel time difference obtained by the index value calculation unit 110 is output to the signal mixing unit 120.

The absolute value |ITD| of the inter-channel time difference corresponds to a difference in time required for a sound emitted by a main sound source in a certain space to reach a first channel microphone arranged in the certain space and a second channel microphone arranged in the certain space. The index value calculation unit 110 may calculate the absolute value |ITD| of the inter-channel time difference by any method. That is, the index value calculation unit 110 may calculate the absolute value |ITD| of the inter-channel time difference by a method exemplified below, or may calculate the absolute value |ITD| of the inter-channel time difference by a well-known method not exemplified.

In general, a value corresponding to a time required from when a sound emitted by a main sound source in a certain space reaches one microphone of a first channel microphone and a second channel microphone arranged in the certain space to when the sound reaches the other microphone is referred to as an inter-channel time difference ITD. However, the index value calculation unit 110 does not need to distinguish which microphone the sound emitted by the main sound source arrives first, which microphone the sound emitted by the main sound source arrives later, or the like, and it is sufficient if the index value calculation unit 110 calculates the absolute value |ITD| of the inter-channel time difference that is a value representing the magnitude of the inter-channel time difference ITD. Of course, the index value calculation unit 110 may obtain the absolute value |ITD| of the inter-channel time difference after calculating the inter-channel time difference ITD.

### First Example of Method in which Index Value Calculation Unit 110 Calculates Absolute Value |ITD| of Inter-Channel Time Difference

The first example is an example of using an absolute value of a correlation coefficient. The index value calculation unit 110 obtains an absolute value γ_{cand} of a correlation coefficient between a sample string of the first channel input sound signal and a sample string of the second channel input sound signal at a position shifted from the sample string by each number of candidate samples τ_{cand} for each number of candidate samples τ_{cand} from a predetermined positive number τₘₐₓ to a predetermined negative number τₘᵢₙ (step S110-A1). Next, the index value calculation unit 110 obtains an absolute value of τ_{cand} when the absolute value γ_{cand} of the correlation coefficient is the maximum value as an absolute value |ITD| of the inter-channel time difference (step S110-A2).

Each predetermined number of candidate samples may be an integer value from τₘₐₓ to τₘᵢₙ, may include a fractional value or a decimal value between Imax and τₘᵢₙ, or may not include any integer value between Imax and Imin. In addition, τₘₐₓ=−τₘᵢₙ may be satisfied or may not be satisfied. Note that τ_{cand} when the absolute value γ_{cand} of the correlation coefficient obtained in the processing of step S110-A1 is the maximum value is an example of the inter-channel time difference ITD, and in this example, the inter-channel time difference ITD is a positive value when the sound emitted by the main sound source is included in the first channel input sound signal earlier than the second channel input sound signal, and the inter-channel time difference ITD is a negative value when the sound emitted by the main sound source is included in the second channel input sound signal earlier than the first channel input sound signal.

### Second Example of Method in which Index Value Calculation Unit 110 Calculates Absolute Value |ITD| of Inter-Channel Time Difference

The second example is an example of using a correlation value using information of a phase of a signal. The index value calculation unit 110 first performs Fourier transform of Formula (3-1) described below on the first channel input sound signals x₁(1), x₁(2), . . . , x₁(T) to obtain a first channel frequency spectrum X₁(k) at each frequency k from 0 to T−1 (step S110-B1). Similarly, the index value calculation unit 110 performs Fourier transform of Formula (3-2) described below on the second channel input sound signals x₂(1), x₂(2), . . . , x₂(T) to obtain a second channel frequency spectrum X₂(k) at each frequency k from 0 to T−1 (step S110-B2).

$$\begin{matrix}[ Math . 33 ] & \\ {X}_{1} ( k ) = \frac{1}{\sqrt{T}} {\sum }_{t = 0}^{T - 1} {x}_{1} ( t + 1 ) {e}^{- j \frac{2 π k t}{T}} & ( 3 ‐ 1 )\end{matrix}$$

$$\begin{matrix}[ Math . 34 ] & \\ {X}_{2} ( k ) = \frac{1}{\sqrt{T}} {\sum }_{t = 0}^{T - 1} {x}_{2} ( t + 1 ) {e}^{- j \frac{2 π k t}{T}} & ( 3 ‐ 2 )\end{matrix}$$

Next, the index value calculation unit 110 obtains a phase difference spectrum φ(k) by Formula (3-3) described below using the first channel frequency spectrum X₁(k) and the second channel frequency spectrum X₂(k) for each frequency k (step S110-B3).

$$\begin{matrix}[ Math . 35 ] & \\ ϕ ( k ) = \frac{{X}_{1} ( k ) / \vert {X}_{1} ( k ) \vert}{{X}_{2} ( k ) / \vert {X}_{2} ( k ) \vert} & ( 3 ‐ 3 )\end{matrix}$$

Next, the index value calculation unit 110 obtains a phase difference signal ψ(τ_{cand}) by performing inverse Fourier transform of Formula (3-4) described below using the phase difference spectrum φ(k) for each number of candidate samples τ_{cand} from predetermined τₘₐₓ to τₘᵢₙ (step S110-B4). Details of τₘₐₓ and τₘᵢₙ are similar to those of the first example.

$$\begin{matrix}[ Math . 36 ] & \\ ψ ( {τ}_{cand} ) = \frac{1}{\sqrt{T}} {\sum }_{k = 0}^{T - 1} ϕ ( k ) {e}^{j \frac{2 π k {τ}_{cand}}{T}} & ( 3 ‐ 4 )\end{matrix}$$

The absolute value of the phase difference signal ψ(τ_{cand}) represents a type of correlation corresponding to the likelihood of the time difference between the first channel input sound signals x₁(1), x₁(2), . . . , x₁(T) and the second channel input sound signals x₂(1), x₂(2), . . . , x₂(T). Accordingly, the index value calculation unit 110 obtains an absolute value of the phase difference signal ψ(τ_{cand}) with respect to each number of candidate samples τ_{cand} as a correlation value γ_{cand} (step S110-B5) Next, the index value calculation unit 110 obtains an absolute value of τ_{and} when the correlation value γ_{cand} is the maximum value as an absolute value |ITD| of the inter-channel time difference (step S110-B6).

Note that, instead of using the absolute value of the phase difference signal ψ(τ_{cand}) as it is as the correlation value γ_{cand}, the index value calculation unit 110 may use a normalized value such as a relative difference between the absolute value of the phase difference signal ψ(τ_{cand}) for each τ_{cand} and the average of the absolute values of the phase difference signals obtained for each of a plurality of numbers of candidate samples before and after τ_{cand}. That is, the index value calculation unit 110 may obtain an average value by Formula (3-5) described below using a predetermined positive number τ_{range} for each τ_{cand} and obtain a normalized correlation value obtained by Formula (3-6) described below as γ_{cand} using the obtained average value ψ_{c}(τ_{cand}) and the phase difference signal ψ(τ_{cand}) (step S110-B5′).

$$\begin{matrix}[ Math . 37 ] & \\ {ψ}_{c} ( {τ}_{cand} ) = \frac{1}{2 {τ}_{range} + 1} {\sum }_{{τ}^{′} = {τ}_{cand} - {τ}_{range}}^{{τ}_{cand} + {τ}_{range}} \vert ψ ( {τ}^{′} ) \vert & ( 3 ‐ 5 )\end{matrix}$$

$$\begin{matrix}[ Math . 38 ] & \\ 1 - \frac{{ψ}_{c} ( {τ}_{cand} )}{\vert ψ ( {τ}_{cand} ) \vert} & ( 3 ‐ 6 )\end{matrix}$$

### [Signal Mixing Unit 120]

A first channel input sound signal and a second channel input sound signal, which are input sound signals of two channels constituting a two-channel stereo input sound signal input to the sound signal processing device 100, and the absolute value |ITD| of the inter-channel time difference output from the index value calculation unit 110 are input to the signal mixing unit 120. For example, for each channel of the first channel and the second channel, the signal mixing unit 120 obtains, as an encoding target signal of the channel, a signal in which an input sound signal of the other channel is mixed with an input sound signal of the channel, the signal being closer to the input sound signal of the channel as the absolute value |ITD| of the inter-channel time difference is smaller (step S120). In other words, for each channel of the first channel and the second channel, the signal mixing unit 120 obtains, as an encoding target signal of the channel, a signal in which an input sound signal of the channel and an input sound signal of the other channel are mixed, the signal being closer to the input sound signal of the channel as the absolute value |ITD| of the inter-channel time difference is smaller. The first channel encoding target signal and the second channel encoding target signal, which are the encoding target signals of the two channels obtained by the signal mixing unit 120, are output to the stereo encoding device 200 as output signals of the sound signal processing device 100.

For example, as illustrated in FIG. 3, it is sufficient if the signal mixing unit 120 includes a first channel signal mixing unit 120-1 and a second channel signal mixing unit 120-2. In this case, it is sufficient if the first channel signal mixing unit 120-1 obtains, as a first channel encoding target signal, a signal in which the first channel input sound signal and the second channel input sound signal are mixed, the signal being closer to the first channel input sound signal as the absolute value |ITD| of the inter-channel time difference is smaller. In addition, it is sufficient if the second channel signal mixing unit 120-2 obtains, as a second channel encoding target signal, a signal in which the second channel input sound signal and the first channel input sound signal are mixed, the signal being closer to the second channel input sound signal as the absolute value |ITD| of the inter-channel time difference is smaller.

In a subjective evaluation experiment by the inventor, in a case where the absolute value |ITD| of the inter-channel time difference of the two-channel stereo input sound signal was small, there was no problem in the auditory quality of the decoded sound signal even when the decoded sound signal was obtained by performing stereo encoding and stereo decoding using the two-channel stereo input sound signal as the encoding target signal as it is, but in a case where the absolute value |ITD| of the inter-channel time difference of the two-channel stereo input sound signal was large, when the decoded sound signal was obtained by performing stereo encoding and stereo decoding using the two-channel stereo input sound signal as the encoding target signal as it is, quantization noise included in the decoded sound signal was remarkably perceived, and the auditory quality of the decoded sound signal was low.

Therefore, in the sound signal processing device 100 of the third embodiment, the encoding target signal of each channel is made closer to the input sound signal of each channel as the absolute value |ITD| of the inter-channel time difference of the two-channel stereo input sound signal is smaller, and the encoding target signal of each channel is made closer to the same one signal as the absolute value |ITD| of the inter-channel time difference of the two-channel stereo input sound signal is larger, so that it is possible to suppress deterioration in auditory quality of the decoded sound signal when the absolute value |ITD| of the inter-channel time difference of the two-channel stereo input sound signal is larger.

For example, assuming that w₁ and w₂ are weight values that are 0.5 or more and 1 or less and have a negative correlation with the absolute value |ITD| of the inter-channel time difference, that is, weight values that are larger as the absolute value |ITD| of the inter-channel time difference is smaller, it is sufficient if the first channel signal mixing unit 120-1 obtains the first channel encoding target signal x′₁(t) represented by Formula (2-1) described above for each time t, and the second channel signal mixing unit 120-2 obtains the second channel encoding target signal x′₂(t) represented by Formula (2-2) described above for each time t. The weight value w₁ and the weight value w₂ may be the same value or different values.

Note that it is not essential that the weight values w₁ and w₂ are larger as the absolute value |ITD| of the inter-channel time difference is smaller in the entire range that can be taken by the absolute value |ITD| of the inter-channel time difference, and the weight values w₁ and w₂ may be constant values regardless of the absolute value |ITD| of the inter-channel time difference in a partial range of the range that can be taken by the absolute value |ITD| of the inter-channel time difference. That is, it is sufficient if the weight value w₁ and the weight value w₂ have a weak monotonic decrease relationship with respect to the absolute value |ITD| of the inter-channel time difference.

Therefore, it is sufficient if the signal mixing unit 120 obtains, for each channel, as the encoding target signal of the channel, a signal in which the input sound signal of the channel and the input sound signal of the other channel are mixed, the signal being closer to the input sound signal of the channel as the absolute value |ITD| of the inter-channel time difference is smaller, in the entire range that can be taken by the absolute value |ITD| of the inter-channel time difference, or obtains, for each channel, as the encoding target signal of the channel, a signal in which the input sound signal of the channel and the input sound signal of the other channel are mixed, the signal having the same closeness to the input sound signal of the channel regardless of the absolute value |ITD| of the inter-channel time difference, in a partial range (first type range) of the range that can be taken by the absolute value |ITD| of the inter-channel time difference, and, obtains, for each channel, as the encoding target signal of the channel, a signal in which the input sound signal of the channel and the input sound signal of the other channel are mixed, the signal being closer to the input sound signal of the channel as the absolute value |ITD| of the inter-channel time difference is smaller in a range other than the partial range (range other than first type range, second type range) of the range that can be taken by the absolute value |ITD| of the inter-channel time difference (step S120). Each of the first type range and the second type range is one or more ranges. That is, there may be a plurality of first type ranges or there may be a plurality of second type ranges.

For example, it is sufficient if the signal mixing unit 120 obtains, for each channel, as the encoding target signal of the channel, a signal obtained by performing weighted addition on the input sound signal of the channel and the input sound signal of the other channel, in which the weight of the input sound signal of the channel in the weighted addition is a value having a weak monotonic decrease relationship with respect to the absolute value |ITD| of the inter-channel time difference, and the weight of the input sound signal of the other channel in the weighted addition is a value having a weak monotonic increase relationship with respect to the absolute value |ITD| of the inter-channel time difference.

The value having a weak monotonic decrease relationship with respect to the absolute value |ITD| of the inter-channel time difference is, for example, a function value of a weak monotonic decrease function using the absolute value |ITD| of the inter-channel time difference as an argument. Therefore, for example, it is sufficient if a weak monotonic decrease function for each channel is stored in the signal mixing unit 120 in advance, and the signal mixing unit 120 acquires a function value by giving the absolute value |ITD| of the inter-channel time difference of the frame as an argument to the weak monotonic decrease function for the channel for each channel of each frame and uses the acquired function value as the weight of the input sound signal of the channel. Alternatively, for example, for a plurality of subranges obtained by dividing a range that can be taken by the absolute value |ITD| of the inter-channel time difference, it is sufficient if a set of information for specifying the absolute value |ITD| of the inter-channel time difference belonging to each subrange and each weight value corresponding to each subrange determined in advance so that the weight value has a weak monotonic decrease relationship with respect to the absolute value |ITD| of the inter-channel time difference is stored in the signal mixing unit 120 in advance, and the signal mixing unit 120 acquires, for each channel of each frame, a weight value corresponding to the absolute value |ITD| of the inter-channel time difference of the frame among the stored weight values and uses the acquired weight value as the weight of the input sound signal of the channel.

The value having a weak monotonic increase relationship with respect to the absolute value |ITD| of the inter-channel time difference is, for example, a function value of a weak monotonic increase function using the absolute value |ITD| of the inter-channel time difference as an argument. Therefore, for example, it is sufficient if a weak monotonic increase function for each channel is stored in the signal mixing unit 120 in advance, and the signal mixing unit 120 acquires a function value by giving the absolute value |ITD| of the inter-channel time difference of the frame as an argument to the weak monotonic increase function for the channel for each channel of each frame and uses the acquired function value as the weight of the input sound signal of the other channel. Alternatively, for example, for a plurality of subranges obtained by dividing a range that can be taken by the absolute value |ITD| of the inter-channel time difference, it is sufficient if a set of information for specifying the absolute value |ITD| of the inter-channel time difference belonging to each subrange and each weight value corresponding to each subrange determined in advance so that the weight value has a weak monotonic increase relationship with respect to the absolute value |ITD| of the inter-channel time difference is stored in the signal mixing unit 120 in advance, and the signal mixing unit 120 acquires, for each channel of each frame, a weight value corresponding to the absolute value |ITD| of the inter-channel time difference of the frame among the stored weight values and uses the acquired weight value as the weight of the input sound signal of the other channel.

When the weight value w₁ is 1, the first channel encoding target signal x′₁(t) represented by Formula (2-1) described above is the same as the first channel input sound signal x₁(t), and when the weight value w₂ is 1, the second channel encoding target signal x′₂(t) represented by Formula (2-2) described above is the same as the second channel input sound signal x₂(t). Therefore, in a case where the weight value w₁ and the weight value w₂ when the absolute value |ITD| of the inter-channel time difference is the minimum value of values that can be taken by the absolute value |ITD| of the inter-channel time difference or within a predetermined range including the minimum value are 1, the signal mixing unit 120 may use the input sound signal of the channel as the encoding target signal of the channel as it is for each channel when the absolute value |ITD| of the inter-channel time difference is the minimum value of values that can be taken by the absolute value |ITD| of the inter-channel time difference or within the predetermined range including the minimum value.

Therefore, in a case where the absolute value |ITD| of the inter-channel time difference is smaller than a predetermined value, the signal mixing unit 120 may obtain the input sound signal of the channel as it is as the encoding target signal of the channel for each channel, and in other cases than the above case, that is, in a case where the absolute value |ITD| of the inter-channel time difference is equal to or larger than the predetermined value described above, may obtain, for each channel, as the encoding target signal of the channel, a signal in which the input sound signal of the channel and the input sound signal of the other channel are mixed, the signal being closer to the input sound signal of the channel as the absolute value |ITD| of the inter-channel time difference is smaller, in the entire range that can be taken by the absolute value |ITD| of the inter-channel time difference, or obtain, for each channel, as the encoding target signal of the channel, a signal in which the input sound signal of the channel and the input sound signal of the other channel are mixed, the signal having the same closeness to the input sound signal of the channel regardless of the absolute value |ITD| of the inter-channel time difference, in a partial range (first type range) of the range that can be taken by the absolute value |ITD| of the inter-channel time difference, and, obtain, for each channel, as the encoding target signal of the channel, a signal in which the input sound signal of the channel and the input sound signal of the other channel are mixed, the signal being closer to the input sound signal of the channel as the absolute value |ITD| of the inter-channel time difference is smaller in a range other than the partial range (range other than first type range, second type range) of the range that can be taken by the absolute value |ITD| of the inter-channel time difference (step S120). The signal mixing unit 120 may perform an operation in which “smaller than a predetermined value” and “equal to or larger than the predetermined value” described above are replaced with “equal to or less than a predetermined value” and “larger than the predetermined value”, respectively.

For example, it is sufficient if the signal mixing unit 120 obtains the input sound signal of the channel as it is as the encoding target signal of the channel for each channel in a first range, within the range that can be taken by the absolute value |ITD| of the inter-channel time difference, that is a range in which the absolute value |ITD| of the inter-channel time difference is smaller than a predetermined value (that is, in a first case where the absolute value |ITD| of the inter-channel time difference is smaller than the predetermined value), and obtains, as the encoding target signal of the channel, for each channel in a second range that is a range other than the first range within the range that can be taken by the absolute value |ITD| of the inter-channel time difference (that is, in a second case other than the first case, specifically, in a case where the absolute value |ITD| of the inter-channel time difference is equal to or larger than the predetermined value described above), a signal obtained by performing weighted addition on the input sound signal of the channel and the input sound signal of the other channel, in which the weight of the input sound signal of the channel in the weighted addition is a value having a weak monotonic decrease relationship with respect to the absolute value |ITD| of the inter-channel time difference in the second range, and the weight of the input sound signal of the other channel in the weighted addition is a value having a weak monotonic increase relationship with respect to the absolute value |ITD| of the inter-channel time difference in the second range. The signal mixing unit 120 may perform an operation in which “smaller than a predetermined value” and “equal to or larger than the predetermined value” described above are replaced with “equal to or less than a predetermined value” and “larger than the predetermined value”, respectively.

In a case where the index value calculation unit 110 calculates the absolute value |ITD| of the inter-channel time difference for each frame, assuming that wₚ is the weight value of the first channel determined from the absolute value |ITD| of the inter-channel time difference of the previous frame, that w_{c1} is the weight value of the first channel determined from the absolute value |ITD| of the inter-channel time difference of the current frame, the first channel signal mixing unit 120-1 may set a value obtained by Formula (2-3) described above as a weight value w₁(t) for each time from the initial time (that is, the first time) of the current frame to the T₀−1st time, and set w_{c1} as the weight value w₁(t) for each time from the τ₀th time to the last time (that is, the Tth time) of the current frame, and obtain the first channel encoding target signal x′₁(t) represented by Formula (2-4) described above instead of Formula (2-1) described above for each time t of the current frame.

Similarly, assuming that wₚ₂ is the weight value of the second channel determined from the absolute value |ITD| of the inter-channel time difference of the previous frame, that w_{c2} is the weight value of the second channel determined from the absolute value |ITD| of the inter-channel time difference of the current frame, the second channel signal mixing unit 120-2 may set a value obtained by Formula (2-5) described above as a weight value w₂(t) for each time from the initial time (that is, the first time) of the current frame to the T₀−1st time, and set w_{c2} as the weight value w₂(t) for each time from the τ₀th time to the last time (that is, the Tth time) of the current frame, and obtain the second channel encoding target signal x′₂(t) represented by Formula (2-6) described above instead of Formula (2-2) described above for each time t of the current frame.

### First Modification of Third Embodiment

The third embodiment may be implemented including processing of calculating an index value according to the absolute value |ITD| of the inter-channel time difference. A mode including the processing of calculating an index value according to the absolute value |ITD| of the inter-channel time difference will be described as a first modification of the third embodiment. The sound signal processing device 100 of the first modification of the third embodiment is as indicated by the one-dot chain line, the broken line, and the solid line in FIG. 3 and includes an index value calculation unit 110 and a signal mixing unit 120. The sound signal processing device 100 performs processing of steps S110 and S120 indicated by the broken line and the solid line in FIG. 4. Hereinafter, the first modification of the third embodiment will be described focusing on differences from the third embodiment.

### [Index Value Calculation Unit 110]

A first channel input sound signal and a second channel input sound signal, which are input sound signals of two channels constituting a two-channel stereo input sound signal input to the sound signal processing device 100, are input to the index value calculation unit 110. The index value calculation unit 110 calculates an index value α having a weak monotonic decrease relationship with respect to the absolute value |ITD| of the inter-channel time difference of the two-channel stereo input sound signal or an index value α′ having a weak monotonic increase relationship with respect to the absolute value |ITD| of the inter-channel time difference of the two-channel stereo input sound signal (step S110). The index value α or the index value α′ obtained by the index value calculation unit 110 is output to the signal mixing unit 120. For example, it is sufficient if the index value calculation unit 110 calculates the absolute value |ITD| of the inter-channel time difference using the same method as in the third embodiment, and calculates the index value α or the index value α′ using the absolute value |ITD| of the inter-channel time difference.

The value having a weak monotonic decrease relationship with respect to the absolute value |ITD| of the inter-channel time difference of the two-channel stereo input sound signal is, for example, a function value of a weak monotonic decrease function using the absolute value |ITD| of the inter-channel time difference of the two-channel stereo input sound signal as an argument. Therefore, the processing of obtaining the index value α using the absolute value |ITD| of the inter-channel time difference can be performed, for example, by storing a weak monotonic decrease function in the index value calculation unit 110 in advance, and for each frame, the index value calculation unit 110 acquiring a function value by giving the absolute value |ITD| of the inter-channel time difference of the frame as an argument to the weak monotonic decrease function, and using the acquired function value as the index value α. Alternatively, the processing of obtaining the index value α using the absolute value |ITD| of the inter-channel time difference can be performed, for example, for a plurality of subranges obtained by dividing a range that can be taken by the absolute value |ITD| of the inter-channel time difference, by storing a set of information for specifying the absolute value |ITD| of the inter-channel time difference belonging to each subrange and each function value corresponding to each subrange determined in advance so that the function value has a weak monotonic decrease relationship with respect to the absolute value |ITD| of the inter-channel time difference in the index value calculation unit 110 in advance, and the index value calculation unit 110 acquiring, for each frame, a function value corresponding to the absolute value |ITD| of the inter-channel time difference of the frame among the stored function values and using the acquired function value as the index value α.

The value having a weak monotonic increase relationship with respect to the absolute value |ITD| of the inter-channel time difference of the two-channel stereo input sound signal is, for example, a function value of a weak monotonic increase function using the absolute value |ITD| of the inter-channel time difference of the two-channel stereo input sound signal as an argument. Therefore, the processing of obtaining the index value α′ using the absolute value |ITD| of the inter-channel time difference can be performed, for example, by storing a weak monotonic increase function in the index value calculation unit 110 in advance, and for each frame, the index value calculation unit 110 acquiring a function value by giving the absolute value |ITD| of the inter-channel time difference of the frame as an argument to the weak monotonic increase function, and using the acquired function value as the index value α′. Alternatively, the processing of obtaining the index value α′ using the absolute value |ITD| of the inter-channel time difference can be performed, for example, for a plurality of subranges obtained by dividing a range that can be taken by the absolute value |ITD| of the inter-channel time difference, by storing a set of information for specifying the absolute value |ITD| of the inter-channel time difference belonging to each subrange and each function value corresponding to each subrange determined in advance so that the function value has a weak monotonic increase relationship with respect to the absolute value |ITD| of the inter-channel time difference in the index value calculation unit 110 in advance, and the index value calculation unit 110 acquiring, for each frame, a function value corresponding to the absolute value |ITD| of the inter-channel time difference of the frame among the stored function values and using the acquired function value as the index value α′. Note that the index value calculation unit 110 may use the absolute value |ITD| itself of the inter-channel time difference as the index value α′.

### [Signal Mixing Unit 120]

Although contents of the index value α and the index value α′ are different, input/output and operation of the signal mixing unit 120 are the same as those in the first modification of the second embodiment. A first channel input sound signal and a second channel input sound signal, which are input sound signals of two channels constituting a two-channel stereo input sound signal input to the sound signal processing device 100, and the index value α or index value α′ output from the index value calculation unit 110 are input to the signal mixing unit 120. The signal mixing unit 120 to which the index value α is input obtains, for each channel of the first channel and the second channel, as the encoding target signal of the channel, a signal in which the input sound signal of the channel and the input sound signal of the other channel are mixed, the signal being closer to the input sound signal of the channel as the index value α is larger, and the signal mixing unit 120 to which the index value α′ is input obtains, for each channel of the first channel and the second channel, as the encoding target signal of the channel, a signal in which the input sound signal of the channel and the input sound signal of the other channel are mixed, the signal being closer to the input sound signal of the channel as the index value α′ is smaller (step S120). The encoding target signals (that is, the two-channel stereo encoding target signal) of the two channels obtained by the signal mixing unit 120 are output to the stereo encoding device 200 as output signals of the sound signal processing device 100.

The signal mixing unit 120 to which the index value α is input may obtain the input sound signal of the channel as it is as the encoding target signal of the channel for each channel in a case where the index value α is larger than a predetermined value, and obtain the signal in which the input sound signal of the channel and the input sound signal of the other channel are mixed for each channel, the signal being closer to the input sound signal of the channel as the index value α is larger as the encoding target signal of the channel in a case other than the above case, that is, in a case where the index value α is equal to or less than the predetermined value (step S120). The signal mixing unit 120 may perform an operation in which “larger than a predetermined value” and “equal to or less than the predetermined value” described above are replaced with “equal to or larger than a predetermined value” and “smaller than the predetermined value”, respectively.

Similarly, the signal mixing unit 120 to which the index value α′ is input may obtain the input sound signal of the channel as it is as the encoding target signal of the channel for each channel in a case where the index value α′ is smaller than a predetermined value, and obtain the signal in which the input sound signal of the channel and the input sound signal of the other channel are mixed for each channel, the signal being closer to the input sound signal of the channel as the index value α′ is smaller as the encoding target signal of the channel in a case other than the above case, that is, in a case where the index value α′ is equal to or larger than the predetermined value (step S120). The signal mixing unit 120 may perform an operation in which “smaller than a predetermined value” and “equal to or larger than the predetermined value” described above are replaced with “equal to or less than a predetermined value” and “larger than the predetermined value”, respectively.

### First Example of Index Value Calculation Unit 110 and Signal Mixing Unit 120

The index value calculation unit 110 obtains the index value α that is 0.5 or more and 1 or less and has a weak monotonic decrease relationship with respect to the absolute value |ITD| of the inter-channel time difference. For example, the index value calculation unit 110 obtains, as the index value α, 0.5 when the absolute value |ITD| of the inter-channel time difference is the maximum value of values that can be taken by the absolute value |ITD| of the inter-channel time difference, 1 when the absolute value |ITD| of the inter-channel time difference is the minimum value of values that can be taken by the absolute value |ITD| of the inter-channel time difference, and a larger value as the absolute value |ITD| of the inter-channel time difference is lower.

For each time t, the signal mixing unit 120 obtains a first channel encoding target signal x′₁(t) represented by Formula (2-7) described above and obtains a second channel encoding target signal x′₂(t) represented by Formula (2-8) described above.

When the index value calculation unit 110 calculates the index value α for each frame, the signal mixing unit 120 may, for each frame, set the index value α calculated for the previous frame by the index value calculation unit 110 as αₚ, set the index value α calculated for the current frame by the index value calculation unit 110 as α_{c}, set a value obtained by Formula (2-9) described above as an index value α(t) for each time from the initial time (that is, the first time) of the current frame to the T₀−1th time, set ac as the index value α(t) for each time from the τ₀th time to the last time (that is, the Tth time) of the current frame, and obtain the first channel encoding target signal x′₁(t) represented by Formula (2-10) described above instead of Formula (2-7) described above for each time t of the current frame, and obtain the second channel encoding target signal x′₂(t) represented by Formula (2-11) described above instead of Formula (2-8) described above.

### Second Example of Index Value Calculation Unit 110 and Signal Mixing Unit 120

The index value calculation unit 110 obtains the index value α′ that is 0 or more and 0.5 or less and has a weak monotonic increase relationship with respect to the absolute value |ITD| of the inter-channel time difference. For example, the index value calculation unit 110 obtains, as the index value α′, 0 when the absolute value |ITD| of the inter-channel time difference is the minimum value of values that can be taken by the absolute value |ITD| of the inter-channel time difference, 0.5 when the absolute value |ITD| of the inter-channel time difference is the maximum value of values that can be taken by the absolute value |ITD| of the inter-channel time difference, and a larger value as the absolute value |ITD| of the inter-channel time difference is larger.

For each time t, the signal mixing unit 120 obtains a first channel encoding target signal x′₁(t) represented by Formula (2-12) described above and obtains a second channel encoding target signal x′₂(t) represented by Formula (2-13) described above.

When the index value calculation unit 110 calculates the index value α′ for each frame, the signal mixing unit 120 may, for each frame, set the index value α′ calculated for the previous frame by the index value calculation unit 110 as α′ₚ, set the index value α′ calculated for the current frame by the index value calculation unit 110 as α′_{c}, set a value obtained by Formula (2-14) described above as an index value α′(t) for each time from the initial time (that is, the first time) of the current frame to the To-lth time, set α′_{c} as the index value α′ (t) for each time from the τ₀th time to the last time (that is, the Tth time) of the current frame, and obtain the first channel encoding target signal x′₁(t) represented by Formula (2-15) described above instead of Formula (2-12) described above for each time t of the current frame, and obtain the second channel encoding target signal x′₂(t) represented by Formula (2-16) described above instead of Formula (2-13) described above.

### Second Modification of Third Embodiment

The third embodiment may be implemented including processing of mixing a two-channel stereo input sound signal to generate a downmixed signal. A mode including processing of generating a downmixed signal will be described as a second modification of the third embodiment. A sound signal processing device 100 of the second modification of the third embodiment is as indicated by the one-dot chain line, the broken line, and the solid line in FIG. 5 and includes an index value calculation unit 110 and a signal mixing unit 120, and the signal mixing unit 120 includes a downmixed signal generation unit 1201 and a mixing unit 1211. As indicated by the broken line and the solid line in FIG. 6, the sound signal processing device 100 performs processing of step S110, and processing of step S120 including steps S1201 and S1211. Hereinafter, the second modification of the third embodiment will be described focusing on differences from the third embodiment.

### [Index Value Calculation Unit 110]

Input/output and operation of the index value calculation unit 110 are the same as those in the third embodiment, and details are as described in the third embodiment. A first channel input sound signal and a second channel input sound signal, which are input sound signals of two channels constituting a two-channel stereo input sound signal input to the sound signal processing device 100, are input to the index value calculation unit 110. The index value calculation unit 110 calculates an absolute value |ITD| of the inter-channel time difference of the two-channel stereo input sound signal (step S110). The absolute value |ITD| of the inter-channel time difference obtained by the index value calculation unit 110 is output to the signal mixing unit 120.

### [Downmixed Signal Generation Unit 1201]

Input/output and operation of the downmixed signal generation unit 1201 are the same as those in the second and third modifications of the second embodiment, and details are as described in the second modification of the second embodiment. A first channel input sound signal and a second channel input sound signal, which are input sound signals of two channels constituting a two-channel stereo input sound signal input to the sound signal processing device 100, are input to the downmixed signal generation unit 1201. The downmixed signal generation unit 1201 mixes the first channel input sound signal and the second channel input sound signal to generate a downmixed signal (step S1201). The downmixed signal obtained by the downmixed signal generation unit 1201 is output to the mixing unit 1211.

### [Mixing Unit 1211]

A first channel input sound signal and a second channel input sound signal, which are input sound signals of two channels constituting a two-channel stereo input sound signal input to the sound signal processing device 100, the downmixed signal output from the downmixed signal generation unit 1201, and the absolute value |ITD| of the inter-channel time difference output from the index value calculation unit 110 are input to the mixing unit 1211. For example, for each channel of the first channel and the second channel, the mixing unit 1211 obtains, as an encoding target signal of the channel, a signal in which a downmixed signal is mixed with an input sound signal of the channel, the signal being closer to the input sound signal of the channel as the absolute value |ITD| of the inter-channel time difference is smaller and closer to the downmixed signal as the absolute value |ITD| of the inter-channel time difference is larger (step S1211). In other words, for each channel of the first channel and the second channel, the mixing unit 1211 obtains, as an encoding target signal of the channel, a signal in which an input sound signal of the channel is mixed with a downmixed signal, the signal being closer to the input sound signal of the channel as the absolute value |ITD| of the inter-channel time difference is smaller and closer to the downmixed signal as the absolute value |ITD| of the inter-channel time difference is larger. The encoding target signals (that is, the two-channel stereo encoding target signal) of the two channels obtained by the mixing unit 1211 are output to the stereo encoding device 200 as output signals of the sound signal processing device 100.

For example, as illustrated in FIG. 5, it is sufficient if the mixing unit 1211 includes a first channel mixing unit 1211-1 and a second channel mixing unit 1211-2. In this case, it is sufficient if the first channel mixing unit 1211-1 obtains, as a first channel encoding target signal, a signal in which the first channel input sound signal and the downmixed signal are mixed, the signal being closer to the first channel input sound signal as the absolute value |ITD| of the inter-channel time difference is smaller and closer to the downmixed signal as the absolute value |ITD| of the inter-channel time difference is larger. In addition, it is sufficient if the second channel mixing unit 1211-2 obtains, as a second channel encoding target signal, a signal in which the second channel input sound signal and the downmixed signal are mixed, the signal being closer to the second channel input sound signal as the absolute value |ITD| of the inter-channel time difference is smaller and closer to the downmixed signal as the absolute value |ITD| of the inter-channel time difference is larger.

Assuming that a downmixed signal at time t is x_{M}(t), for example, assuming that w₁ and w₂ are weight values that are 0 or more and 1 or less and have a negative correlation with the absolute value |ITD| of the inter-channel time difference, that is, weight values that are larger as the absolute value |ITD| of the inter-channel time difference is smaller, it is sufficient if the first channel mixing unit 1211-1 obtains the first channel encoding target signal x′₁(t) represented by Formula (2-17) described above for each time t, and the second channel mixing unit 1211-2 obtains the second channel encoding target signal x′₂(t) represented by Formula (2-18) described above for each time t. The weight value w₁ and the weight value w₂ may be the same value or different values.

Note that it is not essential that the weight values w₁ and w₂ are larger as the absolute value |ITD| of the inter-channel time difference is smaller in the entire range that can be taken by the absolute value |ITD| of the inter-channel time difference, and the weight values w₁ and w₂ may be constant regardless of the absolute value |ITD| of the inter-channel time difference in a partial range of the range that can be taken by the absolute value |ITD| of the inter-channel time difference. That is, it is sufficient if each of the weight value w₁ and the weight value w₂ has a weak monotonic decrease relationship with respect to the absolute value |ITD| of the inter-channel time difference.

Therefore, it is sufficient if the mixing unit 1211 obtains, for each channel, as the encoding target signal of the channel, a signal in which the input sound signal of the channel and the downmixed signal are mixed, the signal being closer to the input sound signal of the channel as the absolute value |ITD| of the inter-channel time difference is smaller (that is, a signal closer to the downmixed signal as the absolute value |ITD| of the inter-channel time difference is larger), in the entire range that can be taken by the absolute value |ITD| of the inter-channel time difference, or obtains, for each channel, as the encoding target signal of the channel, a signal in which the input sound signal of the channel and the downmixed signal are mixed, the signal having the same closeness to the input sound signal of the channel regardless of the absolute value |ITD| of the inter-channel time difference (that is, a signal having the same closeness to the downmixed signal regardless of the absolute value |ITD| of the inter-channel time difference), in a partial range (first type range) of the range that can be taken by the absolute value |ITD| of the inter-channel time difference, and, obtains, for each channel, as the encoding target signal of the channel, a signal in which the input sound signal of the channel and the downmixed signal are mixed, the signal being closer to the input sound signal of the channel as the absolute value |ITD| of the inter-channel time difference is smaller (that is, a signal closer to the downmixed signal as the absolute value |ITD| of the inter-channel time difference is larger) in a range other than the partial range (range other than first type range, second type range) of the range that can be taken by the absolute value |ITD| of the inter-channel time difference (step S1211). Each of the first type range and the second type range is one or more ranges. That is, there may be a plurality of first type ranges or there may be a plurality of second type ranges.

For example, it is sufficient if the mixing unit 1211 obtains, for each channel, as the encoding target signal of the channel, a signal obtained by performing weighted addition on the input sound signal of the channel and the downmixed signal, in which the weight of the input sound signal of the channel in the weighted addition is a value having a weak monotonic decrease relationship with respect to the absolute value |ITD| of the inter-channel time difference, and the weight of the downmixed signal in the weighted addition is a value having a weak monotonic increase relationship with respect to the absolute value |ITD| of the inter-channel time difference.

The value having a weak monotonic decrease relationship with respect to the absolute value |ITD| of the inter-channel time difference is, for example, a function value of a weak monotonic decrease function using the absolute value |ITD| of the inter-channel time difference as an argument. Therefore, for example, it is sufficient if a weak monotonic decrease function for each channel is stored in the mixing unit 1211 in advance, and the mixing unit 1211 acquires a function value by giving the absolute value |ITD| of the inter-channel time difference of the frame as an argument to the weak monotonic decrease function for the channel for each channel of each frame and uses the acquired function value as the weight of the input sound signal of the channel. Alternatively, for example, for a plurality of subranges obtained by dividing a range that can be taken by the absolute value |ITD| of the inter-channel time difference, it is sufficient if a set of information for specifying the absolute value |ITD| of the inter-channel time difference belonging to each subrange and each weight value corresponding to each subrange determined in advance so that the weight value has a weak monotonic decrease relationship with respect to the absolute value |ITD| of the inter-channel time difference is stored in the mixing unit 1211 in advance, and the mixing unit 1211 acquires, for each channel of each frame, a weight value corresponding to the absolute value |ITD| of the inter-channel time difference of the frame among the stored weight values and uses the acquired weight value as the weight of the input sound signal of the channel.

The value having a weak monotonic increase relationship with respect to the absolute value |ITD| of the inter-channel time difference is, for example, a function value of a weak monotonic increase function using the absolute value |ITD| of the inter-channel time difference as an argument. Therefore, for example, it is sufficient if a weak monotonic increase function for each channel is stored in the mixing unit 1211 in advance, and the mixing unit 1211 acquires a function value by giving the absolute value |ITD| of the inter-channel time difference of the frame as an argument to the weak monotonic increase function for the channel for each channel of each frame and uses the acquired function value as the weight of the downmixed signal. Alternatively, for example, for a plurality of subranges obtained by dividing a range that can be taken by the absolute value |ITD| of the inter-channel time difference, it is sufficient if a set of information for specifying the absolute value |ITD| of the inter-channel time difference belonging to each subrange and each weight value corresponding to each bit rate determined in advance so that the weight value has a weak monotonic increase relationship with respect to the absolute value |ITD| of the inter-channel time difference is stored in the mixing unit 1211 in advance, and the mixing unit 1211 acquires, for each channel of each frame, a weight value corresponding to the absolute value |ITD| of the inter-channel time difference of the frame among the stored weight values and uses the acquired weight value as the weight of the downmixed signal.

When the weight value w₁ is 1, the first channel encoding target signal x′₁(t) represented by Formula (2-17) described above is the same as the first channel input sound signal x₁(t), and when the weight value w₂ is 1, the second channel encoding target signal x′₂(t) represented by Formula (2-18) described above is the same as the second channel input sound signal x₂(t). Therefore, in a case where the weight value w₁ and the weight value w₂ when the absolute value |ITD| of the inter-channel time difference is the minimum value of values that can be taken by the absolute value |ITD| of the inter-channel time difference or within a predetermined range including the minimum value are 1, the mixing unit 1211 may use the input sound signal of the channel as the encoding target signal of the channel as it is for each channel when the absolute value |ITD| of the inter-channel time difference is the minimum value of values that can be taken or within the predetermined range including the minimum value.

When the weight value w₁ is 0, the first channel encoding target signal x′₁(t) represented by Formula (2-17) described above is the same as the downmixed signal x_{M}(t), and when the weight value w₂ is 0, the second channel encoding target signal x′₂(t) represented by Formula (2-18) described above is the same as the downmixed signal x_{M}(t). Therefore, in a case where the weight value w₁ and the weight value w₂ when the absolute value |ITD| of the inter-channel time difference is the maximum value of values that can be taken by the absolute value |ITD| of the inter-channel time difference or within a predetermined range including the maximum value are 0, the mixing unit 1211 may use the downmixed signal as the encoding target signal of the channel as it is for each channel when the absolute value |ITD| of the inter-channel time difference is the maximum value of values that can be taken by the absolute value |ITD| of the inter-channel time difference or within the predetermined range including the maximum value.

Therefore, in a case where absolute value |ITD| of the inter-channel time difference is smaller than a predetermined value, the mixing unit 1211 may obtain the input sound signal of the channel as it is as the encoding target signal of the channel for each channel, and in other cases than the above case, that is, in a case where the absolute value |ITD| of the inter-channel time difference is equal to or larger than the predetermined value described above, the mixing unit 1211 may obtain, for each channel, as the encoding target signal of the channel, a signal in which the input sound signal of the channel and the downmixed signal are mixed, the signal being closer to the input sound signal of the channel as the absolute value |ITD| of the inter-channel time difference is smaller (that is, a signal closer to the downmixed signal as the absolute value |ITD| of the inter-channel time difference is larger), in the entire range that can be taken by the absolute value |ITD| of the inter-channel time difference, or obtain, for each channel, as the encoding target signal of the channel, a signal in which the input sound signal of the channel and the downmixed signal are mixed, the signal having the same closeness to the input sound signal of the channel regardless of the absolute value |ITD| of the inter-channel time difference (that is, a signal having the same closeness to the downmixed signal regardless of the absolute value |ITD| of the inter-channel time difference), in a partial range (first type range) of the range that can be taken by the absolute value |ITD| of the inter-channel time difference, and, obtain, for each channel, as the encoding target signal of the channel, a signal in which the input sound signal of the channel and the downmixed signal are mixed, the signal being closer to the input sound signal of the channel as the absolute value |ITD| of the inter-channel time difference is smaller (that is, a signal closer to the downmixed signal as the absolute value |ITD| of the inter-channel time difference is larger) in a range other than the partial range (range other than first type range, second type range) of the range that can be taken by the absolute value |ITD| of the inter-channel time difference (step S1211). The mixing unit 1211 may perform an operation in which “smaller than a predetermined value” and “equal to or larger than the predetermined value” described above are replaced with “equal to or less than a predetermined value” and “larger than the predetermined value”, respectively. Each of the first type range and the second type range is one or more ranges. That is, there may be a plurality of first type ranges or there may be a plurality of second type ranges.

For example, it is sufficient if the mixing unit 1211 obtains the input sound signal of the channel as it is as the encoding target signal of the channel for each channel in a first range, within the range that can be taken by the absolute value |ITD| of the inter-channel time difference, that is a range in which the absolute value |ITD| of the inter-channel time difference is smaller than a predetermined value (that is, in a first case where the absolute value |ITD| of the inter-channel time difference is smaller than the predetermined value), and obtains, as the encoding target signal of the channel, for each channel in a second range that is a range other than the first range within the range that can be taken by the absolute value |ITD| of the inter-channel time difference (that is, in a second case other than the first case, specifically, in a case where the absolute value |ITD| of the inter-channel time difference is equal to or larger than the predetermined value described above), a signal obtained by performing weighted addition on the input sound signal of the channel and the downmixed signal, in which the weight of the input sound signal of the channel in the weighted addition is a value having a weak monotonic decrease relationship with respect to the absolute value |ITD| of the inter-channel time difference in the second range, and the weight of the downmixed signal in the weighted addition is a value having a weak monotonic increase relationship with respect to the absolute value |ITD| of the inter-channel time difference in the second range. The mixing unit 1211 may perform an operation in which “smaller than a predetermined value” and “equal to or larger than the predetermined value” described above are replaced with “equal to or less than a predetermined value” and “larger than the predetermined value”, respectively.

Alternatively, in a case where absolute value |ITD| of the inter-channel time difference is larger than a predetermined value, the mixing unit 1211 may obtain the downmixed signal as it is as the encoding target signal of the channel for each channel, and in other cases than the above case, that is, in a case where the absolute value |ITD| of the inter-channel time difference is equal to or less than the predetermined value described above, the mixing unit 1211 may obtain, for each channel, as the encoding target signal of the channel, a signal in which the input sound signal of the channel and the downmixed signal are mixed, the signal being closer to the input sound signal of the channel as the absolute value |ITD| of the inter-channel time difference is smaller (that is, a signal closer to the downmixed signal as the absolute value |ITD| of the inter-channel time difference is larger), in the entire range that can be taken by the absolute value |ITD| of the inter-channel time difference, or obtain, for each channel, as the encoding target signal of the channel, a signal in which the input sound signal of the channel and the downmixed signal are mixed, the signal having the same closeness to the input sound signal of the channel regardless of the absolute value |ITD| of the inter-channel time difference (that is, a signal having the same closeness to the downmixed signal regardless of the absolute value |ITD| of the inter-channel time difference), in a partial range (first type range) of the range that can be taken by the absolute value |ITD| of the inter-channel time difference, and, obtain, for each channel, as the encoding target signal of the channel, a signal in which the input sound signal of the channel and the downmixed signal are mixed, the signal being closer to the input sound signal of the channel as the absolute value |ITD| of the inter-channel time difference is smaller (that is, a signal closer to the downmixed signal as the absolute value |ITD| of the inter-channel time difference is larger) in a range other than the partial range (range other than first type range, second type range) of the range that can be taken by the absolute value |ITD| of the inter-channel time difference (step S1211). The mixing unit 1211 may perform an operation in which “larger than a predetermined value” and “equal to or less than the predetermined value” described above are replaced with “equal to or larger than a predetermined value” and “smaller than the predetermined value”, respectively. Each of the first type range and the second type range is one or more ranges. That is, there may be a plurality of first type ranges or there may be a plurality of second type ranges.

For example, it is sufficient if the mixing unit 1211 obtains the downmixed signal as it is as the encoding target signal of the channel for each channel in a first range, within the range that can be taken by the absolute value |ITD| of the inter-channel time difference, that is a range in which the absolute value |ITD| of the inter-channel time difference is larger than a predetermined value (that is, in a first case where the absolute value |ITD| of the inter-channel time difference is larger than the predetermined value), and obtains, as the encoding target signal of the channel, for each channel in a second range that is a range other than the first range within the range that can be taken by the absolute value |ITD| of the inter-channel time difference (that is, in a second case other than the first case, specifically, in a case where the absolute value |ITD| of the inter-channel time difference is equal to or less than the predetermined value described above), a signal obtained by performing weighted addition on the input sound signal of the channel and the downmixed signal, in which the weight of the input sound signal of the channel in the weighted addition is a value having a weak monotonic decrease relationship with respect to the absolute value |ITD| of the inter-channel time difference in the second range, and the weight of the downmixed signal in the weighted addition is a value having a weak monotonic increase relationship with respect to the absolute value |ITD| of the inter-channel time difference in the second range. The mixing unit 1211 may perform an operation in which “larger than a predetermined value” and “equal to or less than the predetermined value” described above are replaced with “equal to or larger than a predetermined value” and “smaller than the predetermined value”, respectively.

Alternatively, in a case where the absolute value |ITD| of the inter-channel time difference is smaller than a predetermined first value, the mixing unit 1211 may obtain the input sound signal of the channel as it is as the encoding target signal of the channel for each channel, in a case where the absolute value |ITD| of the inter-channel time difference is equal to or larger than a predetermined second value larger than the predetermined first value, obtain the downmixed signal for each channel as it is as the encoding target signal of the channel, and in a case where neither of the two cases is applicable, that is, in a case where the absolute value |ITD| of the inter-channel time difference is equal to or larger than the predetermined first value and is smaller than the predetermined second value, the mixing unit 1211 may obtain, for each channel, as the encoding target signal of the channel, a signal in which the input sound signal of the channel and the downmixed signal are mixed, the signal being closer to the input sound signal of the channel as the absolute value |ITD| of the inter-channel time difference is smaller (that is, a signal closer to the downmixed signal as the absolute value |ITD| of the inter-channel time difference is larger), in the entire range that can be taken by the absolute value |ITD| of the inter-channel time difference, or obtain, for each channel, as the encoding target signal of the channel, a signal in which the input sound signal of the channel and the downmixed signal are mixed, the signal having the same closeness to the input sound signal of the channel regardless of the absolute value |ITD| of the inter-channel time difference (that is, a signal having the same closeness to the downmixed signal regardless of the absolute value |ITD| of the inter-channel time difference), in a partial range (first type range) of the range that can be taken by the absolute value |ITD| of the inter-channel time difference, and, obtain, for each channel, as the encoding target signal of the channel, a signal in which the input sound signal of the channel and the downmixed signal are mixed, the signal being closer to the input sound signal of the channel as the absolute value |ITD| of the inter-channel time difference is smaller (that is, a signal closer to the downmixed signal as the absolute value |ITD| of the inter-channel time difference is larger) in a range other than the partial range (range other than first type range, second type range) of the range that can be taken by the absolute value |ITD| of the inter-channel time difference (step S1211). The mixing unit 1211 may perform an operation in which “smaller than a predetermined first value” and “equal to or larger than the predetermined first value” described above are replaced with “equal to or less than a predetermined first value” and “larger than the predetermined first value”, respectively, and may perform an operation in which “smaller than a predetermined second value” and “equal to or larger than the predetermined second value” described above are replaced with “equal to or less than a predetermined second value” and “larger than the predetermined second value”, respectively. Each of the first type range and the second type range is one or more ranges. That is, there may be a plurality of first type ranges or there may be a plurality of second type ranges.

For example, it is sufficient if the mixing unit 1211 obtains the input sound signal of the channel as it is as the encoding target signal of the channel for each channel in a first range, within the range that can be taken by the absolute value |ITD| of the inter-channel time difference, that is a range in which the absolute value |ITD| of the inter-channel time difference is smaller than a predetermined first value (that is, in a first case where the absolute value |ITD| of the inter-channel time difference is smaller than the predetermined first value), obtains the downmixed signal as it is as the encoding target signal of the channel for each channel in a second range, within the range that can be taken by the absolute value |ITD| of the inter-channel time difference, that is a range in which the absolute value |ITD| of the inter-channel time difference is equal to or larger than the predetermined second value larger than the predetermined first value described above (that is, in a second case where the absolute value |ITD| of the inter-channel time difference is equal to or larger than the predetermined second value larger than the predetermined first value described above), and obtains, as the encoding target signal of the channel, for each channel in a third range, within the range that can be taken by the absolute value |ITD| of the inter-channel time difference, that is a range other than the first range and the second range (that is, in a third case other than the first case and the second case, specifically, in a case where the absolute value |ITD| of the inter-channel time difference is equal to or larger than the predetermined first value described above and smaller than the predetermined second value described above), a signal obtained by performing weighted addition on the input sound signal of the channel and the downmixed signal, in which the weight of the input sound signal of the channel in the weighted addition is a value having a weak monotonic decrease relationship with respect to the absolute value |ITD| of the inter-channel time difference in the third range, and the weight of the downmixed signal in the weighted addition is a value having a weak monotonic increase relationship with respect to the absolute value |ITD| of the inter-channel time difference in the third range. The mixing unit 1211 may perform an operation in which “smaller than a predetermined first value” and “equal to or larger than the predetermined first value” described above are replaced with “equal to or less than a predetermined first value” and “larger than the predetermined first value”, respectively, and may perform an operation in which “smaller than a predetermined second value” and “equal to or larger than the predetermined second value” described above are replaced with “equal to or less than a predetermined second value” and “larger than the predetermined second value”, respectively.

In a case where the index value calculation unit 110 calculates the absolute value |ITD| of the inter-channel time difference for each frame, assuming that wₚ₁ is the weight value of the first channel determined from the absolute value |ITD| of the inter-channel time difference of the previous frame, that w_{c1} is the weight value of the first channel determined from the absolute value |ITD| of the inter-channel time difference of the current frame, the first channel mixing unit 1211-1 may set a value obtained by Formula (2-19) described above as a weight value w₁(t) for each time from the initial time (that is, the first time) of the current frame to the T₀−1st time, and set w_{c1} as the weight value w₁(t) for each time from the τ₀th time to the last time (that is, the Tth time) of the current frame, and obtain the first channel encoding target signal x′₁(t) represented by Formula (2-20) described above instead of Formula (2-17) described above for each time t of the current frame.

Similarly, assuming that wₚ₂ is the weight value of the second channel determined from the absolute value |ITD| of the inter-channel time difference of the previous frame, that w_{c2} is the weight value of the second channel determined from the absolute value |ITD| of the inter-channel time difference of the current frame, the second channel mixing unit 1211-2 may set a value obtained by Formula (2-21) described above as a weight value w₂(t) for each time from the initial time (that is, the first time) of the current frame to the T₀−1st time, and set w_{c2} as the weight value w₂(t) for each time from the τ₀th time to the last time (that is, the Tth time) of the current frame, and obtain the second channel encoding target signal x′₂(t) represented by Formula (2-22) described above instead of Formula (2-18) described above for each time t of the current frame.

### Third Modification of Third Embodiment

The second modification of the third embodiment may be implemented including processing of calculating an index value according to the absolute value |ITD| of the inter-channel time difference. A mode including the processing of calculating an index value according to the absolute value |ITD| of the inter-channel time difference will be described as a third modification of the third embodiment. A sound signal processing device 100 of the third modification of the third embodiment is as indicated by the one-dot chain line, the broken line, and the solid line in FIG. 5 and includes an index value calculation unit 110 and a signal mixing unit 120, and the signal mixing unit 120 includes a downmixed signal generation unit 1201 and a mixing unit 1211. As indicated by the broken line and the solid line in FIG. 6, the sound signal processing device 100 performs processing of step S110, and processing of step S120 including steps S1201 and S1211. Hereinafter, the third modification of the third embodiment will be described focusing on differences from the second modification of the third embodiment.

### [Index Value Calculation Unit 110]

Input/output and operation of the index value calculation unit 110 are the same as those in the first modification of the third embodiment, and details are as described in the first modification of the third embodiment. A first channel input sound signal and a second channel input sound signal, which are input sound signals of two channels constituting a two-channel stereo input sound signal input to the sound signal processing device 100, are input to the index value calculation unit 110. The index value calculation unit 110 calculates an index value α having a weak monotonic decrease relationship with respect to the absolute value |ITD| of the inter-channel time difference of the two-channel stereo input sound signal or an index value α′ having a weak monotonic increase relationship with respect to the absolute value |ITD| of the inter-channel time difference of the two-channel stereo input sound signal (step S110). The index value α or the index value α′ obtained by the index value calculation unit 110 is output to the signal mixing unit 120.

### [Downmixed Signal Generation Unit 1201]

Input/output and operation of the downmixed signal generation unit 1201 are the same as those in the second and third modifications of the second embodiment and the second modification of the third embodiment, and details are as described in the second modification of the second embodiment. A first channel input sound signal and a second channel input sound signal, which are input sound signals of two channels constituting a two-channel stereo input sound signal input to the sound signal processing device 100, are input to the downmixed signal generation unit 1201. The downmixed signal generation unit 1201 mixes the first channel input sound signal and the second channel input sound signal to generate a downmixed signal (step S1201). The downmixed signal obtained by the downmixed signal generation unit 1201 is output to the mixing unit 1211.

### [Mixing Unit 1211]

Although contents of the index value α and the index value α′ are different, input/output and operation of the mixing unit 1211 are the same as those in the third modification of the second embodiment. A first channel input sound signal and a second channel input sound signal, which are input sound signals of two channels constituting a two-channel stereo input sound signal input to the sound signal processing device 100, the downmixed signal output from the downmixed signal generation unit 1201, and the index value α or the index value α′ output from the index value calculation unit 110 are input to the mixing unit 1211. The mixing unit 1211 to which the index value α is input obtains, for each channel of the first channel and the second channel, as the encoding target signal of the channel, a signal in which the input sound signal of the channel and the downmixed signal are mixed, the signal being closer to the input sound signal of the channel as the index value α is larger (that is, the signal closer to the downmixed signal as the index value α is smaller), and the mixing unit 1211 to which the index value α′ is input obtains, for each channel of the first channel and the second channel, as the encoding target signal of the channel, a signal in which the input sound signal of the channel and the downmixed signal are mixed, the signal being closer to the input sound signal of the channel as the index value α′ is smaller (that is, the signal closer to the downmixed signal as the index value α′ is larger) (step S1201). The encoding target signals (that is, the two-channel stereo encoding target signal) of the two channels obtained by the mixing unit 1211 are output to the stereo encoding device 200 as output signals of the sound signal processing device 100.

The mixing unit 1211 to which the index value α is input may obtain the input sound signal of the channel as it is as the encoding target signal of the channel for each channel in a case where the index value α is larger than a predetermined value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case other than the above case, that is, in a case where the index value α is equal to or less than the predetermined value (step S1211). The mixing unit 1211 may perform an operation in which “larger than a predetermined value” and “equal to or less than the predetermined value” described above are replaced with “equal to or larger than a predetermined value” and “smaller than the predetermined value”, respectively.

Alternatively, the mixing unit 1211 to which the index value α is input may obtain the downmixed signal as it is as the encoding target signal of the channel for each channel in a case where the index value α is smaller than a predetermined value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case other than the above case, that is, in a case where the index value α is equal to or larger than the predetermined value (step S1211). The mixing unit 1211 may perform an operation in which “smaller than a predetermined value” and “equal to or larger than the predetermined value” described above are replaced with “equal to or less than a predetermined value” and “larger than the predetermined value”, respectively.

Alternatively, the mixing unit 1211 to which the index value α is input may obtain the input sound signal of the channel as it is as the encoding target signal of the channel for each channel in a case where the index value α is larger than a predetermined first value, obtain the downmixed signal as it is as the encoding target signal of the channel for each channel in a case where the index value α is equal to or less than a predetermined second value smaller than the predetermined first value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case where neither of the two cases is applicable, that is, in a case where the index value α is equal to or less than the predetermined first value and larger than the predetermined second value (step S1211). The mixing unit 1211 may perform an operation in which “larger than a predetermined first value” and “equal to or less than the predetermined first value” described above are replaced with “equal to or larger than a predetermined first value” and “smaller than the predetermined first value”, respectively, and may perform an operation in which “larger than a predetermined second value” and “equal to or less than the predetermined second value” described above are replaced with “equal to or larger than a predetermined second value” and “smaller than the predetermined second value”, respectively.

Alternatively, the mixing unit 1211 to which the index value α′ is input may obtain the input sound signal of the channel as it is as the encoding target signal of the channel for each channel in a case where the index value α′ is smaller than a predetermined value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case other than the above case, that is, in a case where the index value α′ is equal to or larger than the predetermined value (step S1211). The mixing unit 1211 may perform an operation in which “smaller than a predetermined value” and “equal to or larger than the predetermined value” described above are replaced with “equal to or less than a predetermined value” and “larger than the predetermined value”, respectively.

Alternatively, the mixing unit 1211 to which the index value α′ is input may obtain the downmixed signal as it is as the encoding target signal of the channel for each channel in a case where the index value α′ is larger than a predetermined value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case other than the above case, that is, in a case where the index value α′ is equal to or less than the predetermined value (step S1211). The mixing unit 1211 may perform an operation in which “larger than a predetermined value” and “equal to or less than the predetermined value” described above are replaced with “equal to or larger than a predetermined value” and “smaller than the predetermined value”, respectively.

Alternatively, the mixing unit 1211 to which the index value α′ is input may obtain the input sound signal of the channel as it is as the encoding target signal of the channel for each channel in a case where the index value α′ is smaller than a predetermined first value, obtain the downmixed signal as it is as the encoding target signal of the channel for each channel in a case where the index value α′ is equal to or larger than a predetermined second value larger than the predetermined first value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case where neither of the two cases is applicable, that is, in a case where the index value α′ is equal to or larger than the predetermined first value and smaller than the predetermined second value (step S1211). The mixing unit 1211 may perform an operation in which “smaller than a predetermined first value” and “equal to or larger than the predetermined first value” described above are replaced with “equal to or less than a predetermined first value” and “larger than the predetermined first value”, respectively, and may perform an operation in which “smaller than a predetermined second value” and “equal to or larger than the predetermined second value” described above are replaced with “equal to or less than a predetermined second value” and “larger than the predetermined second value”, respectively.

### First Example of Index Value Calculation Unit 110 and Mixing Unit 1211

The index value calculation unit 110 obtains the index value α that is 0 or more and 1 or less and has a weak monotonic decrease relationship with respect to the absolute value |ITD| of the inter-channel time difference. For example, the index value calculation unit 110 obtains, as the index value α, 0 when the absolute value |ITD| of the inter-channel time difference is the maximum value of values that can be taken by the absolute value |ITD| of the inter-channel time difference, 1 when the absolute value |ITD| of the inter-channel time difference is the minimum value of values that can be taken by the absolute value |ITD| of the inter-channel time difference, and a larger value as the absolute value |ITD| of the inter-channel time difference is lower.

Alternatively, for example, when the absolute value |ITD| of the inter-channel time difference is a value in units of milliseconds (ms), the index value calculation unit 110 obtains the index value α represented by Formula (3-7) described below using the absolute value |ITD| of the inter-channel time difference. Note that min(A, B) is a function that obtains a smaller value of A and B.

$$\begin{matrix}[ Math . 39 ] & \\ α = cos ( min ( 1 , \vert ITD \vert \times 0. 5 ) \times 0.5 π ) \times 0.5 + 0.5 & ( 3 ‐ 7 )\end{matrix}$$

Specifically, for example, in a case where the sampling frequency is 48 kHz and the absolute value |ITD| of the inter-channel time difference is a value in units of the number of samples, it is sufficient if the index value calculation unit 110 obtains the index value α represented by Formula (3-8) described below.

$$\begin{matrix}[ Math . 40 ] & \\ α = cos ( min ( 1 , \vert ITD \vert \times 0. 01 ) \times 0.5 π ) \times 0.5 + 0.5 & ( 3 ‐ 8 )\end{matrix}$$

For each time t, the mixing unit 1211 obtains a first channel encoding target signal x′₁(t) represented by Formula (2-23) described above and obtains a second channel encoding target signal x′₂(t) represented by Formula (2-24) described above.

When the index value calculation unit 110 calculates the index value α for each frame, the mixing unit 1211 may, for each frame, set the index value α calculated for the previous frame by the index value calculation unit 110 as ap, set the index value α calculated for the current frame by the index value calculation unit 110 as α_{c}, set a value obtained by Formula (2-25) described above as an index value α(t) for each time from the initial time (that is, the first time) of the current frame to the T₀−1th time, set α_{c} as the index value α(t) for each time from the τ₀th time to the last time (that is, the Tth time) of the current frame, and obtain the first channel encoding target signal x′₁(t) represented by Formula (2-26) described above instead of Formula (2-23) described above for each time t of the current frame, and obtain the second channel encoding target signal x′₂(t) represented by Formula (2-27) described above instead of Formula (2-24) described above.

### Second Example of Index Value Calculation Unit 110 and Mixing Unit 1211

The index value calculation unit 110 obtains the index value α′ that is 0 or more and 1 or less and has a weak monotonic increase relationship with respect to the absolute value |ITD| of the inter-channel time difference. For example, the index value calculation unit 110 obtains, as the index value α′, 0 when the absolute value |ITD| of the inter-channel time difference is the minimum value of values that can be taken by the absolute value |ITD| of the inter-channel time difference, 1 when the absolute value |ITD| of the inter-channel time difference is the maximum value of values that can be taken by the absolute value |ITD| of the inter-channel time difference, and a larger value as the absolute value |ITD| of the inter-channel time difference is larger.

For each time t, the mixing unit 1211 obtains a first channel encoding target signal x′₁(t) represented by Formula (2-28) described above and obtains a second channel encoding target signal x′₂(t) represented by Formula (2-29) described above.

When the index value calculation unit 110 calculates the index value α′ for each frame, the mixing unit 1211 may, for each frame, set the index value α′ calculated for the previous frame by the index value calculation unit 110 as α′ₚ, set the index value α′ calculated for the current frame by the index value calculation unit 110 as α′_{c}, set a value obtained by Formula (2-30) described above as an index value α′(t) for each time from the initial time (that is, the first time) of the current frame to the T₀−1th time, set α′_{c} as the index value α′ (t) for each time from the τ₀th time to the last time (that is, the Tth time) of the current frame, and obtain the first channel encoding target signal x′₁(t) represented by Formula (2-31) described above instead of Formula (2-28) described above for each time t of the current frame, and obtain the second channel encoding target signal x′₂(t) represented by Formula (2-32) described above instead of Formula (2-29) described above.

### Fourth Embodiment

In the fourth embodiment, a sound signal processing device 100 that performs processing according to a single sound source likeness of the two-channel stereo input sound signal input to the sound signal processing device 100 will be described. The sound signal processing device 100 of the fourth embodiment is as indicated by the one-dot chain line, the broken line, and the solid line in FIG. 3 and includes an index value calculation unit 110 and a signal mixing unit 120. The sound signal processing device 100 performs processing of steps S110 and S120 indicated by the broken line and the solid line in FIG. 4. Hereinafter, the fourth embodiment will be described focusing on differences from the second embodiment.

### [Index Value Calculation Unit 110]

A first channel input sound signal and a second channel input sound signal, which are input sound signals of two channels constituting a two-channel stereo input sound signal input to the sound signal processing device 100, are input to the index value calculation unit 110. The index value calculation unit 110 calculates a value having a weak monotonic increase relationship with respect to the single sound source likeness of the two-channel stereo input sound signal as the index value α, or calculates a value having a weak monotonic decrease relationship with respect to the single sound source likeness of the two-channel stereo input sound signal as the index value α′ (step S110). The index value α or the index value α′ obtained by the index value calculation unit 110 is output to the signal mixing unit 120.

The two-channel stereo input sound signal usually includes a sound emitted by one or more sound sources. For example, in the case of a two-channel stereo input sound signal obtained by performing AD conversion on sounds collected by two microphones arranged in a certain space, in a case where there is only one main sound source present in the certain space, the two-channel stereo input sound signal mainly includes only a sound emitted by one sound source, and in a case where there is a plurality of main sound sources present in the certain space, the two-channel stereo input sound signal mainly includes sounds emitted by the plurality of sound sources. The single sound source likeness of the two-channel stereo input sound signal is a likelihood that only the sound emitted by one sound source is mainly included in the two-channel stereo input sound signal.

For example, the index value calculation unit 110 obtains an index value of the single sound source likeness of the two-channel stereo input sound signal (step S110-C1), and obtains a value having a weak monotonic increase relationship with respect to the index value of the single sound source likeness of the two-channel stereo input sound signal as the index value α, or obtains a value having a weak monotonic decrease relationship with respect to the index value of the single sound source likeness of the two-channel stereo input sound signal as the index value α′ (step S110-C2). Note that the index value calculation unit 110 may directly set the index value of the single sound source likeness of the two-channel stereo input sound signal obtained in the processing of step S110-C1 as the index value α. A specific example in which the index value calculation unit 110 obtains the index value of the single sound source likeness of the two-channel stereo input sound signal will be described below.

The value having a weak monotonic increase relationship with respect to the index value of the single sound source likeness of the two-channel stereo input sound signal is, for example, a function value of a weak monotonic increase function using the index value of the single sound source likeness of the two-channel stereo input sound signal as an argument. Therefore, the processing of obtaining the index value a using the index value of the single sound source likeness of the two-channel stereo input sound signal can be performed, for example, by storing a weak monotonic increase function in the index value calculation unit 110 in advance, and for each frame, the index value calculation unit 110 acquiring a function value by giving the index value of the single sound source likeness of the two-channel stereo input sound signal of the frame as an argument to the weak monotonic increase function, and using the acquired function value as the index value α. Alternatively, the processing of obtaining the index value α using the index value of the single sound source likeness of the two-channel stereo input sound signal can be performed, for example, for a plurality of subranges obtained by dividing a range that can be taken by the index value of the single sound source likeness of the two-channel stereo input sound signal, by storing a set of information for specifying the index value of the single sound source likeness of the two-channel stereo input sound signal belonging to each subrange and each function value corresponding to each subrange determined in advance so that the function value has a weak monotonic increase relationship with respect to the index value of the single sound source likeness of the two-channel stereo input sound signal in the index value calculation unit 110 in advance, and the index value calculation unit 110 acquiring, for each frame, a function value corresponding to the index value of the single sound source likeness of the two-channel stereo input sound signal of the frame among the stored function values and using the acquired function value as the index value α.

The value having a weak monotonic decrease relationship with respect to the index value of the single sound source likeness of the two-channel stereo input sound signal is, for example, a function value of a weak monotonic decrease function using the index value of the single sound source likeness of the two-channel stereo input sound signal as an argument. Therefore, the processing of obtaining the index value α′ using the index value of the single sound source likeness of the two-channel stereo input sound signal can be performed, for example, by storing a weak monotonic decrease function in the index value calculation unit 110 in advance, and for each frame, the index value calculation unit 110 acquiring a function value by giving the index value of the single sound source likeness of the two-channel stereo input sound signal of the frame as an argument to the weak monotonic decrease function, and using the acquired function value as the index value α′. Alternatively, the processing of obtaining the index value α′ using the index value of the single sound source likeness of the two-channel stereo input sound signal can be performed, for example, for a plurality of subranges obtained by dividing a range that can be taken by the index value of the single sound source likeness of the two-channel stereo input sound signal, by storing a set of information for specifying the index value of the single sound source likeness of the two-channel stereo input sound signal belonging to each subrange and each function value corresponding to each subrange determined in advance so that the function value has a weak monotonic decrease relationship with respect to the index value of the single sound source likeness of the two-channel stereo input sound signal in the index value calculation unit 110 in advance, and the index value calculation unit 110 acquiring, for each frame, a function value corresponding to the index value of the single sound source likeness of the two-channel stereo input sound signal of the frame among the stored function values and using the acquired function value as the index value α′.

The fact that the two-channel stereo input sound signal is likely to be a single sound source means that the two-channel stereo input sound signal is not likely to be multiple sound sources. Conversely, the fact that the two-channel stereo input sound signal is not likely to be a single sound source means that the two-channel stereo input sound signal is likely to be multiple sound sources. Therefore, the index value calculation unit 110 may obtain a value having a negative correlation with an index value of the single sound source likeness of the two-channel stereo input sound signal as an index value of multiple sound source likeness (step S110-C1′), and obtain a value having a weak monotonic decrease relationship with respect to the index value of the multiple sound source likeness of the two-channel stereo input sound signal as the index value α, or obtain a value having a weak monotonic increase relationship with respect to the index value of the multiple sound source likeness of the two-channel stereo input sound signal as the index value α′ (step S110-C2′).

### First Example of Method in which Index Value Calculation Unit 110 Obtains Index Value of Single Sound Source Likeness of Two-Channel Stereo Input Sound Signal

The first example is an example of using an absolute value of a correlation coefficient. The index value calculation unit 110 obtains an absolute value γ_{cand} of a correlation coefficient between a sample string of the first channel input sound signal and a sample string of the second channel input sound signal at a position shifted from the sample string by each number of candidate samples τ_{cand} for each number of candidate samples τ_{cand} from a predetermined positive number τₘₐₓ to a predetermined negative number τₘᵢₙ (step S110-C1-A1). Each predetermined number of candidate samples may be an integer value from τₘₐₓ to τₘᵢₙ, may include a fractional value or a decimal value between τₘₐₓ and τₘᵢₙ, or may not include any integer value between Imax and τₘᵢₙ. In addition, τₘₐₓ=−τₘᵢₙ may be satisfied or may not be satisfied.

Next, the index value calculation unit 110 obtains a maximum value γ₁ of an absolute value γ_{cand} of the correlation coefficient and τ₁ which is τ_{cand} when the absolute value γ_{cand} of the correlation coefficient is the maximum value γ₁ (step S110-C1-A2). Hereinafter, γ₁ is referred to as a first peak of the absolute value of the correlation coefficient.

Next, the index value calculation unit 110 obtains a maximum value γ₂ of the absolute value γ_{cand} of the correlation coefficient for τ_{cand} except within a predetermined range in the vicinity of τ₁ (step S110-C1-A3). For example, when the predetermined range in the vicinity of τ₁ is τ₁+δ₁ to τ₁−δ₁, the index value calculation unit 110 obtains a maximum value γ₂ of the absolute value γ_{cand} of the correlation coefficient for each number of candidate samples τ_{cand} excluding τ₁+δ₁ to τ₁−δ₁ from τₘₐₓ to τₘᵢₙ. δ₁ is a predetermined value. Hereinafter, γ₂ is referred to as a second peak of the absolute value of the correlation coefficient.

Next, the index value calculation unit 110 obtains a difference |γ₁−γ₂| between the first peak γ₁ of the absolute value of the correlation coefficient and the second peak γ₂ of the absolute value of the correlation coefficient as an index value of the single sound source likeness of the two-channel stereo input sound signal (step S110-C1-A4).

Note that the index value calculation unit 110 may obtain 1 as the index value of the single sound source likeness of the two-channel stereo input sound signal in a case where the difference |γ₁−γ₂| is larger than a predetermined threshold TH_{γ}, and obtain 0 as the index value of the single sound source likeness of the two-channel stereo input sound signal in a case where the difference |γ₁−γ₂| is equal to or less than the threshold TH_{y} (step S110-C1-A4′). The index value calculation unit 110 may perform an operation in which “larger than the threshold TH_{γ}” and “equal to or less than the threshold value TH_{γ}” described above are replaced with “equal to or larger than the threshold TH_{γ}” and “smaller than the threshold TH_{γ}”, respectively.

Alternatively, the index value calculation unit 110 may first perform step S110-C1-A1 to obtain the maximum value of the absolute value γ_{cand} of the correlation coefficient obtained in step S110-C1-A1 as the index value of the single sound source likeness of the two-channel stereo input sound signal (step S110-C1-A2′).

### Second Example of Method in which Index Value Calculation Unit 110 Obtains Index Value of Single Sound Source Likeness of Two-Channel Stereo Input Sound Signal

The second example is an example of using a correlation value using information of a phase of a signal. The index value calculation unit 110 first performs Fourier transform of Formula (3-1) described above on the first channel input sound signals x₁(1), x₁(2), . . . , x₁(T) to obtain a first channel frequency spectrum X₁(k) at each frequency k from 0 to T−1 (step S110-C1-B1). Similarly, the index value calculation unit 110 performs Fourier transform of Formula (3-2) described above on the second channel input sound signals x₂(1), x₂(2), . . . , x₂(T) to obtain a second channel frequency spectrum X₂(k) at each frequency k from 0 to T−1 (step S110-C1-B2).

Next, the index value calculation unit 110 obtains a phase difference spectrum φ(k) by Formula (3-3) described above using the first channel frequency spectrum X₁(k) and the second channel frequency spectrum X₂(k) for each frequency k (step S110-C1-B3).

Next, the index value calculation unit 110 obtains a phase difference signal ψ(τ_{cand}) by performing inverse Fourier transform of Formula (3-4) described above using the phase difference spectrum φ(k) for each number of candidate samples τ_{cand} from predetermined τₘₐₓ to τₘᵢₙ (step S110-C1-B4). Details of τₘₐₓ and τₘᵢₙ are similar to those of the first example.

Next, the index value calculation unit 110 obtains an absolute value of the phase difference signal ψ(τ_{cand}) with respect to each number of candidate samples τ_{cand} as a correlation value γ_{cand} (step S110-C1-B5). Next, the index value calculation unit 110 obtains a maximum value γ₁ of a correlation value γ_{cand} and τ₁ which is τ_{cand} when the correlation value γ_{cand} is the maximum value γ₁ (step S110-C1-B6). Hereinafter, γ₁ is referred to as a first peak of the absolute value of the correlation value.

Next, the index value calculation unit 110 obtains a maximum value γ₂ of the absolute value γ_{cand} of the correlation value for τ_{cand} except within a predetermined range in the vicinity of τ₁ (step S110-C1-B7). For example, when the predetermined range in the vicinity of Ti is τ₁+δ₁ to τ₁−δ₁, the index value calculation unit 110 obtains a maximum value γ₂ of the absolute value γ_{cand} of the correlation value for each number of candidate samples τ_{cand} excluding τ₁+5 to τ₁−δ from τₘₐₓ to τₘᵢₙ. δ₁ is a predetermined value. Hereinafter, γ₂ is referred to as a second peak of the absolute value of the correlation value.

Next, the index value calculation unit 110 obtains a difference |γ₁−γ₂| between the first peak γ₁ of the absolute value of the correlation value and the second peak γ₂ of the absolute value of the correlation value as an index value of the single sound source likeness of the two-channel stereo input sound signal (step S110-C1-B8).

Note that the index value calculation unit 110 may obtain 1 as the index value of the single sound source likeness of the two-channel stereo input sound signal in a case where the difference |γ₁−γ₂| is larger than a predetermined threshold TH_{γ}, and obtain 0 as the index value of the single sound source likeness of the two-channel stereo input sound signal in a case where the difference |γ₁−γ₂| is equal to or less than the threshold TH_{γ} (step S110-C1-B8′). The index value calculation unit 110 may perform an operation in which “larger than the threshold TH_{γ}” and “equal to or less than the threshold value TH_{γ}” described above are replaced with “equal to or larger than the threshold TH_{γ}” and “smaller than the threshold TH_{γ}”, respectively.

In the second example, instead of using the absolute value of the phase difference signal ψ(τ_{cand}) as it is as the correlation value γ_{cand}, the index value calculation unit 110 may use a normalized value such as a relative difference between the absolute value of the phase difference signal ψ(τ_{cand}) for each τ_{cand} and the average of the absolute values of the phase difference signals obtained for each of a plurality of numbers of candidate samples before and after τ_{cand}. That is, the index value calculation unit 110 may obtain an average value by Formula (3-5) described above using a predetermined positive number τ_{range} for each τ_{cand} and obtain a normalized correlation value obtained by Formula (3-6) described above as γ_{cand} using the obtained average value ψ_{c}(τ_{cand}) and the phase difference signal ψ(τ_{cand}) (step S110-C1-B5′).

Alternatively, the index value calculation unit 110 may obtain the maximum value of γ_{cand} obtained in step S110-C1-B5 or S110-C1-B5′ as the index value of the single sound source likeness of the two-channel stereo input sound signal (step S110-C1-B6′).

### Third Example of Method in which Index Value Calculation Unit 110 Obtains Index Value of Single Sound Source Likeness of Two-Channel Stereo Input Sound Signal

The third example is an example of using an energy ratio of a phase difference correlation signal. The index value calculation unit 110 first performs steps S110-C1-B1 to 5110-C1-B6 described in the second example. At that time, the index value calculation unit 110 may perform step S110-C1-B5′ described in the second example instead of step S110-C1-B5.

Next, the index value calculation unit 110 obtains a ratio of the sum of the energy of the phase difference signal ψ(τ_{cand}) within a predetermined range in the vicinity of τ₁ to the sum of the energy of the phase difference signal ψ(|_{cand}) excluding the range as an index value of the single sound source likeness of the two-channel stereo input sound signal (steps S110-C1-C7). For example, assuming that the predetermined range in the vicinity of Ti is from τ₁+δ₂ to τ₁−δ₂ and the ranges excluding the range are from τₘₐₓ to τ₁+δ₃ and from τ₁−δ₃ to τₘᵢₙ, it is sufficient if the index value calculation unit 110 obtains a value obtained by Formula (4-1) described below as an index value of the single sound source likeness of the two-channel stereo input sound signal.

$$\begin{matrix}[ Math . 41 ] & \\ \frac{{\sum }_{{τ}^{′} = {τ}_{1} - {δ}_{2}}^{{τ}_{1} + {δ}_{2}} {( ψ ( {τ}^{′} ) )}^{2}}{{\sum }_{{τ}^{′} = {τ}_{1} + {δ}_{3}}^{{τ}_{max}} {( ψ ( {τ}^{′} ) )}^{2} + {\sum }_{{τ}^{′} = {τ}_{min}}^{{τ}_{1} - {δ}_{3}} {( ψ ( {τ}^{′} ) )}^{2}} & ( 4 ‐ 1 )\end{matrix}$$

### [Signal Mixing Unit 120]

Although contents of the index value α and the index value α′ are different, input/output and operation of the signal mixing unit 120 are the same as those in the first modification of the second embodiment and the first modification of the third embodiment. A first channel input sound signal and a second channel input sound signal, which are input sound signals of two channels constituting a two-channel stereo input sound signal input to the sound signal processing device 100, and the index value α or index value α′ output from the index value calculation unit 110 are input to the signal mixing unit 120. The signal mixing unit 120 to which the index value α is input obtains, for each channel of the first channel and the second channel, as the encoding target signal of the channel, a signal in which the input sound signal of the channel and the input sound signal of the other channel are mixed, the signal being closer to the input sound signal of the channel as the index value α is larger, and the signal mixing unit 120 to which the index value α′ is input obtains, for each channel of the first channel and the second channel, as the encoding target signal of the channel, a signal in which the input sound signal of the channel and the input sound signal of the other channel are mixed, the signal being closer to the input sound signal of the channel as the index value α′ is smaller (step S120). The encoding target signals (that is, the two-channel stereo encoding target signal) of the two channels obtained by the signal mixing unit 120 are output to the stereo encoding device 200 as output signals of the sound signal processing device 100.

For example, the signal mixing unit 120 to which the index value α is input obtains, for each channel, as the encoding target signal of the channel, a signal obtained by performing weighted addition on the input sound signal of the channel and the input sound signal of the other channel, in which the weight of the input sound signal of the channel in the weighted addition is a value having a monotonic increase relationship with respect to the index value α or the index value α, and the weight of the input sound signal of the other channel in the weighted addition is a value having a monotonic decrease relationship with respect to the index value α.

The value having a monotonic increase relationship with respect to the index value α is, for example, a function value of a monotonic increase function using the index value α as an argument. Therefore, for example, it is sufficient if a monotonic increase function for each channel is stored in the signal mixing unit 120 in advance, and the signal mixing unit 120 acquires a function value by giving the index value α as an argument to the monotonic increase function for the channel for each channel of each frame and uses the acquired function value as the weight of the input sound signal of the channel. The monotonic increase function for the first channel and the monotonic increase function for the second channel may be the same or different. Alternatively, for example, for a plurality of subranges obtained by dividing a range that can be taken by the index value α, it is sufficient if a set of information for specifying the index value α belonging to each subrange and each weight value corresponding to each subrange determined in advance so that the weight value has a monotonic increase relationship with respect to the index value α is stored in the signal mixing unit 120 in advance for each channel, and the signal mixing unit 120 acquires, for each channel of each frame, a weight value corresponding to the index value α of the frame among the stored weight values and uses the acquired weight value as the weight of the input sound signal of the channel. Each set stored in advance may be the same or different for the first channel and the second channel.

The value having a monotonic decrease relationship with respect to the index value α is, for example, a function value of a monotonic decrease function using the index value α as an argument. Therefore, for example, it is sufficient if a monotonic decrease function for each channel is stored in the signal mixing unit 120 in advance, and the signal mixing unit 120 acquires a function value by giving the index value α as an argument to the monotonic decrease function for the channel for each channel of each frame and uses the acquired function value as the weight of the input sound signal of the other channel. The monotonic decrease function for the first channel and the monotonic decrease function for the second channel may be the same or different. Alternatively, for example, for a plurality of subranges obtained by dividing a range that can be taken by the index value α, it is sufficient if a set of information for specifying the index value α belonging to each subrange and each weight value corresponding to each subrange determined in advance so that the weight value has a monotonic decrease relationship with respect to the index value α is stored in the signal mixing unit 120 in advance for each channel, and the signal mixing unit 120 acquires, for each channel of each frame, a weight value corresponding to the index value α of the frame among the stored weight values and uses the acquired weight value as the weight of the input sound signal of the other channel. Each set stored in advance may be the same or different for the first channel and the second channel.

For example, the signal mixing unit 120 to which the index value α′ is input obtains, for each channel, as the encoding target signal of the channel, a signal obtained by performing weighted addition on the input sound signal of the channel and the input sound signal of the other channel, in which the weight of the input sound signal of the channel in the weighted addition is a value having a monotonic decrease relationship with respect to the index value α′, and the weight of the input sound signal of the other channel in the weighted addition is a value having a monotonic increase relationship with respect to the index value α′ or the index value α′.

The value having a monotonic decrease relationship with respect to the index value α′ is, for example, a function value of a monotonic decrease function using the index value α′ as an argument. Therefore, for example, it is sufficient if a monotonic decrease function for each channel is stored in the signal mixing unit 120 in advance, and the signal mixing unit 120 acquires a function value by giving the index value α′ as an argument to the monotonic decrease function for the channel for each channel of each frame and uses the acquired function value as the weight of the input sound signal of the channel. The monotonic decrease function for the first channel and the monotonic decrease function for the second channel may be the same or different. Alternatively, for example, for a plurality of subranges obtained by dividing a range that can be taken by the index value α′, it is sufficient if a set of information for specifying the index value α′ belonging to each subrange and each weight value corresponding to each subrange determined in advance so that the weight value has a monotonic decrease relationship with respect to the index value α′ is stored in the signal mixing unit 120 in advance for each channel, and the signal mixing unit 120 acquires, for each channel of each frame, a weight value corresponding to the index value α′ of the frame among the stored weight values and uses the acquired weight value as the weight of the input sound signal of the channel. Each set stored in advance may be the same or different for the first channel and the second channel.

The value having a monotonic increase relationship with respect to the index value α′ is, for example, a function value of a monotonic increase function using the index value α′ as an argument. Therefore, for example, it is sufficient if a monotonic increase function for each channel is stored in the signal mixing unit 120 in advance, and the signal mixing unit 120 acquires a function value by giving the index value α′ as an argument to the monotonic increase function for the channel for each channel of each frame and uses the acquired function value as the weight of the input sound signal of the other channel. The monotonic increase function for the first channel and the monotonic increase function for the second channel may be the same or different. Alternatively, for example, for a plurality of subranges obtained by dividing a range that can be taken by the index value α′, it is sufficient if a set of information for specifying the index value α′ belonging to each subrange and each weight value corresponding to each subrange determined in advance so that the weight value has a monotonic increase relationship with respect to the index value α′ is stored in the signal mixing unit 120 in advance for each channel, and the signal mixing unit 120 acquires, for each channel of each frame, a weight value corresponding to the index value α′ of the frame among the stored weight values and uses the acquired weight value as the weight of the input sound signal of the other channel. Each set stored in advance may be the same or different for the first channel and the second channel.

In general, a stereo encoding method is designed in consideration of reproducibility of a sound itself emitted by a sound source and reproducibility of localization of the sound source. In a case where only the sound emitted by one sound source is mainly included in the two-channel stereo encoding target signal, the information amount indicating the localization of the sound source may be small, so that the reproducibility of the localization of the sound source is high and the reproducibility of the sound itself emitted by the sound source is high. However, in a case where sounds emitted by a plurality of sound sources are mainly included in the two-channel stereo encoding target signal, a large amount of information is required to represent localization of the plurality of sound sources, and thus reproducibility of the sounds themselves emitted by the sound sources may be lowered.

The reason why a large amount of information is required to represent the localization of the plurality of sound sources is that the plurality of sound sources is at various positions in the space, and when the existence range of the plurality of sound sources in the space is narrow, extremely speaking, when the plurality of sound sources exists at one point in the space, it is considered that the information amount for representing the localization of the plurality of sound sources is small. Therefore, in the sound signal processing device 100 of the fourth embodiment, the encoding target signal of each channel is made closer to the input sound signal of each channel as the two-channel stereo input sound signal is likely to be a single sound source (that is, the two-channel stereo input sound signal is not likely to be multiple sound sources), and the encoding target signal of each channel is made closer to the same one signal as the two-channel stereo input sound signal is not likely to be a single sound source (that is, the two-channel stereo input sound signal is likely to be multiple sound sources), so that it is possible to suppress deterioration in auditory quality of the decoded sound signal when the inter-channel time difference of the two-channel stereo input sound signal is larger.

The signal mixing unit 120 to which the index value α is input may obtain the input sound signal of the channel as it is as the encoding target signal of the channel for each channel in a case where the index value α is larger than a predetermined value, and obtain the signal in which the input sound signal of the channel and the input sound signal of the other channel are mixed for each channel, the signal being closer to the input sound signal of the channel as the index value α is larger as the encoding target signal of the channel in a case other than the above case, that is, in a case where the index value α is equal to or less than the predetermined value (step S120). The signal mixing unit 120 may perform an operation in which “larger than a predetermined value” and “equal to or less than the predetermined value” described above are replaced with “equal to or larger than a predetermined value” and “smaller than the predetermined value”, respectively.

For example, the signal mixing unit 120 to which the index value α is input may obtain the input sound signal of the channel as it is as the encoding target signal of the channel for each channel in a first range, within the range that can be taken by the index value α, that is a range in which the index value α is larger than a predetermined value (that is, in a first case where the index value α is larger than the predetermined value), and obtain, as the encoding target signal of the channel, for each channel in a second range that is a range other than the first range within the range that can be taken by the index value α (that is, in a second case other than the first case, specifically, in a case where the index value α is equal to or less than the predetermined value described above), a signal obtained by performing weighted addition on the input sound signal of the channel and the input sound signal of the other channel, in which the weight of the input sound signal of the channel in the weighted addition is a value having a monotonic increase relationship with respect to the index value α in the second range or the index value α, and the weight of the input sound signal of the other channel in the weighted addition is a value having a monotonic decrease relationship with respect to the index value α in the second range. The signal mixing unit 120 may perform an operation in which “larger than a predetermined value” and “equal to or less than the predetermined value” described above are replaced with “equal to or larger than a predetermined value” and “smaller than the predetermined value”, respectively.

Similarly, the signal mixing unit 120 to which the index value α′ is input may obtain the input sound signal of the channel as it is as the encoding target signal of the channel for each channel in a case where the index value α′ is smaller than a predetermined value, and obtain the signal in which the input sound signal of the channel and the input sound signal of the other channel are mixed for each channel, the signal being closer to the input sound signal of the channel as the index value α′ is smaller as the encoding target signal of the channel in a case other than the above case, that is, in a case where the index value α′ is equal to or larger than the predetermined value (step S120). The signal mixing unit 120 may perform an operation in which “smaller than a predetermined value” and “equal to or larger than the predetermined value” described above are replaced with “equal to or less than a predetermined value” and “larger than the predetermined value”, respectively.

For example, the signal mixing unit 120 to which the index value α′ is input may obtain the input sound signal of the channel as it is as the encoding target signal of the channel for each channel in a first range, within the range that can be taken by the index value α′, that is a range in which the index value α′ is smaller than a predetermined value (that is, in a first case where the index value α′ is smaller than the predetermined value), and obtain, as the encoding target signal of the channel, for each channel in a second range that is a range other than the first range within the range that can be taken by the index value α′ (that is, in a second case other than the first case, specifically, in a case where the index value α′ is equal to or larger than the predetermined value described above), a signal obtained by performing weighted addition on the input sound signal of the channel and the input sound signal of the other channel, in which the weight of the input sound signal of the channel in the weighted addition is a value having a monotonic decrease relationship with respect to the index value α′ in the second range, and the weight of the input sound signal of the other channel in the weighted addition is a value having a monotonic increase relationship with respect to the index value α′ in the second range or the index value α′. The signal mixing unit 120 may perform an operation in which “smaller than a predetermined value” and “equal to or larger than the predetermined value” described above are replaced with “equal to or less than a predetermined value” and “larger than the predetermined value”, respectively.

### First Example of Index Value Calculation Unit 110 and Signal Mixing Unit 120

The index value calculation unit 110 obtains the index value α that is 0.5 or more and 1 or less and has a weak monotonic increase relationship with respect to the single sound source likeness. For example, the index value calculation unit 110 obtains, as the index value α, 0.5 when the index value of the single sound source likeness is the minimum value of values that can be taken by the index value, 1 when the index value of the single sound source likeness is the maximum value of values that can be taken by the index value, and a larger value as the index value of the single sound source likeness is larger.

For each time t, the signal mixing unit 120 obtains a first channel encoding target signal x′₁(t) represented by Formula (2-7) described above and obtains a second channel encoding target signal x′₂(t) represented by Formula (2-8) described above.

When the index value calculation unit 110 calculates the index value α for each frame, the signal mixing unit 120 may, for each frame, set the index value α calculated for the previous frame by the index value calculation unit 110 as αₚ, set the index value α calculated for the current frame by the index value calculation unit 110 as α_{c}, set a value obtained by Formula (2-9) described above as an index value α(t) for each time from the initial time (that is, the first time) of the current frame to the T₀−1th time, set α_{c} as the index value α(t) for each time from the τ₀th time to the last time (that is, the Tth time) of the current frame, and obtain the first channel encoding target signal x′₁(t) represented by Formula (2-10) described above instead of Formula (2-7) described above for each time t of the current frame, and obtain the second channel encoding target signal x′₂(t) represented by Formula (2-11) described above instead of Formula (2-8) described above.

### Second Example of Index Value Calculation Unit 110 and Signal Mixing Unit 120

The index value calculation unit 110 obtains the index value α′ that is 0 or more and 0.5 or less and has a weak monotonic decrease relationship with respect to the single sound source likeness. For example, the index value calculation unit 110 obtains, as the index value α′, 0 when the index value of the single sound source likeness is the maximum value of values that can be taken by the index value, 0.5 when the index value of the single sound source likeness is the minimum value of values that can be taken by the index value, and a larger value as the index value of the single sound source likeness is smaller.

For each time t, the signal mixing unit 120 obtains a first channel encoding target signal x′₁(t) represented by Formula (2-12) described above and obtains a second channel encoding target signal x′₂(t) represented by Formula (2-13) described above.

When the index value calculation unit 110 calculates the index value α′ for each frame, the signal mixing unit 120 may, for each frame, set the index value α′ calculated for the previous frame by the index value calculation unit 110 as α′ₚ, set the index value α′ calculated for the current frame by the index value calculation unit 110 as α′_{c}, set a value obtained by Formula (2-14) described above as an index value α′(t) for each time from the initial time (that is, the first time) of the current frame to the To-lth time, set α′_{c} as the index value α′ (t) for each time from the τ₀th time to the last time (that is, the Tth time) of the current frame, and obtain the first channel encoding target signal x′₁(t) represented by Formula (2-15) described above instead of Formula (2-12) described above for each time t of the current frame, and obtain the second channel encoding target signal x′₂(t) represented by Formula (2-16) described above instead of Formula (2-13) described above.

### First Modification of Fourth Embodiment

The fourth embodiment may be implemented including processing of mixing a two-channel stereo input sound signal to generate a downmixed signal. A mode including processing of generating a downmixed signal will be described as a first modification of the fourth embodiment. A sound signal processing device 100 of the first modification of the fourth embodiment is as indicated by the one-dot chain line, the broken line, and the solid line in FIG. 5 and includes an index value calculation unit 110 and a signal mixing unit 120, and the signal mixing unit 120 includes a downmixed signal generation unit 1201 and a mixing unit 1211. As indicated by the broken line and the solid line in FIG. 6, the sound signal processing device 100 performs processing of step S110, and processing of step S120 including steps S1201 and S1211. Hereinafter, the first modification of the fourth embodiment will be described focusing on differences from the fourth embodiment.

### [Index Value Calculation Unit 110]

Input/output and operation of the index value calculation unit 110 are the same as those in the fourth embodiment, and details are as described in the fourth embodiment. A first channel input sound signal and a second channel input sound signal, which are input sound signals of two channels constituting a two-channel stereo input sound signal input to the sound signal processing device 100, are input to the index value calculation unit 110. The index value calculation unit 110 calculates an index value α having a weak monotonic increase relationship with respect to the single sound source likeness of the two-channel stereo input sound signal, or calculates an index value α′ having a weak monotonic decrease relationship with respect to the single sound source likeness of the two-channel stereo input sound signal (step S110). The index value α or the index value α′ obtained by the index value calculation unit 110 is output to the signal mixing unit 120.

### [Downmixed Signal Generation Unit 1201]

Input/output and operation of the downmixed signal generation unit 1201 are the same as those in the second and third modifications of the second embodiment and the second and third modifications of the third embodiment, and details are as described in the second modification of the second embodiment. A first channel input sound signal and a second channel input sound signal, which are input sound signals of two channels constituting a two-channel stereo input sound signal input to the sound signal processing device 100, are input to the downmixed signal generation unit 1201. The downmixed signal generation unit 1201 mixes the first channel input sound signal and the second channel input sound signal to generate a downmixed signal (step S1201). The downmixed signal obtained by the downmixed signal generation unit 1201 is output to the mixing unit 1211.

### [Mixing Unit 1211]

Although contents of the index value α and the index value α′ are different, input/output and operation of the mixing unit 1211 are the same as those in the third modification of the second embodiment and the third modification of the third embodiment. A first channel input sound signal and a second channel input sound signal, which are input sound signals of two channels constituting a two-channel stereo input sound signal input to the sound signal processing device 100, the downmixed signal output from the downmixed signal generation unit 1201, and the index value α or the index value α′ output from the index value calculation unit 110 are input to the mixing unit 1211. The mixing unit 1211 to which the index value α is input obtains, for each channel of the first channel and the second channel, as the encoding target signal of the channel, a signal in which the input sound signal of the channel and the downmixed signal are mixed, the signal being closer to the input sound signal of the channel as the index value α is larger (that is, the signal closer to the downmixed signal as the index value α is smaller), and the mixing unit 1211 to which the index value α′ is input obtains, for each channel of the first channel and the second channel, as the encoding target signal of the channel, a signal in which the input sound signal of the channel and the downmixed signal are mixed, the signal being closer to the input sound signal of the channel as the index value α′ is smaller (that is, the signal closer to the downmixed signal as the index value α′ is larger) (step S1201). The encoding target signals (that is, the two-channel stereo encoding target signal) of the two channels obtained by the mixing unit 1211 are output to the stereo encoding device 200 as output signals of the sound signal processing device 100.

For example, the mixing unit 1211 to which the index value α is input obtains, for each channel, as the encoding target signal of the channel, a signal obtained by performing weighted addition on the input sound signal of the channel and the downmixed signal, in which the weight of the input sound signal of the channel in the weighted addition is a value having a monotonic increase relationship with respect to the index value α or the index value α, and the weight of the downmixed signal in the weighted addition is a value having a monotonic decrease relationship with respect to the index value α.

The value having a monotonic increase relationship with respect to the index value α is, for example, a function value of a monotonic increase function using the index value α as an argument. Therefore, for example, it is sufficient if a monotonic increase function for each channel is stored in the mixing unit 1211 in advance, and the mixing unit 1211 acquires a function value by giving the index value α as an argument to the monotonic increase function for the channel for each channel of each frame and uses the acquired function value as the weight of the input sound signal of the channel. The monotonic increase function for the first channel and the monotonic increase function for the second channel may be the same or different. Alternatively, for example, for a plurality of subranges obtained by dividing a range that can be taken by the index value α, it is sufficient if a set of information for specifying the index value α belonging to each subrange and each weight value corresponding to each subrange determined in advance so that the weight value has a monotonic increase relationship with respect to the index value α is stored in the mixing unit 1211 in advance for each channel, and the mixing unit 1211 acquires, for each channel of each frame, a weight value corresponding to the index value α of the frame among the stored weight values and uses the acquired weight value as the weight of the input sound signal of the channel. Each set stored in advance may be the same or different for the first channel and the second channel.

The value having a monotonic decrease relationship with respect to the index value α is, for example, a function value of a monotonic decrease function using the index value α as an argument. Therefore, for example, it is sufficient if a monotonic decrease function for each channel is stored in the mixing unit 1211 in advance, and the mixing unit 1211 acquires a function value by giving the index value α as an argument to the monotonic decrease function for the channel for each channel of each frame and uses the acquired function value as the weight of the downmixed signal. The monotonic decrease function for the first channel and the monotonic decrease function for the second channel may be the same or different. Alternatively, for example, for a plurality of subranges obtained by dividing a range that can be taken by the index value α, it is sufficient if a set of information for specifying the index value α belonging to each subrange and each weight value corresponding to each subrange determined in advance so that the weight value has a monotonic decrease relationship with respect to the index value α is stored in the mixing unit 1211 in advance for each channel, and the mixing unit 1211 acquires, for each channel of each frame, a weight value corresponding to the index value α of the frame among the stored weight values and uses the acquired weight value as the weight of the downmixed signal. Each set stored in advance may be the same or different for the first channel and the second channel.

For example, the mixing unit 1211 to which the index value α′ is input obtains, for each channel, as the encoding target signal of the channel, a signal obtained by performing weighted addition on the input sound signal of the channel and the downmixed signal, in which the weight of the input sound signal of the channel in the weighted addition is a value having a monotonic decrease relationship with respect to the index value α′, and the weight of the downmixed signal in the weighted addition is a value having a monotonic increase relationship with respect to the index value α′ or the index value α′.

The value having a monotonic decrease relationship with respect to the index value α′ is, for example, a function value of a monotonic decrease function using the index value α′ as an argument. Therefore, for example, it is sufficient if a monotonic decrease function for each channel is stored in the mixing unit 1211 in advance, and the mixing unit 1211 acquires a function value by giving the index value α′ as an argument to the monotonic decrease function for the channel for each channel of each frame and uses the acquired function value as the weight of the input sound signal of the channel. The monotonic decrease function for the first channel and the monotonic decrease function for the second channel may be the same or different. Alternatively, for example, for a plurality of subranges obtained by dividing a range that can be taken by the index value α′, it is sufficient if a set of information for specifying the index value α′ belonging to each subrange and each weight value corresponding to each subrange determined in advance so that the weight value has a monotonic decrease relationship with respect to the index value α′ is stored in the mixing unit 1211 in advance for each channel, and the mixing unit 1211 acquires, for each channel of each frame, a weight value corresponding to the index value α′ of the frame among the stored weight values and uses the acquired weight value as the weight of the input sound signal of the channel. Each set stored in advance may be the same or different for the first channel and the second channel.

The value having a monotonic increase relationship with respect to the index value α′ is, for example, a function value of a monotonic increase function using the index value α′ as an argument. Therefore, for example, it is sufficient if a monotonic increase function for each channel is stored in the mixing unit 1211 in advance, and the mixing unit 1211 acquires a function value by giving the index value α′ as an argument to the monotonic increase function for the channel for each channel of each frame and uses the acquired function value as the weight of the downmixed signal. The monotonic increase function for the first channel and the monotonic increase function for the second channel may be the same or different. Alternatively, for example, for a plurality of subranges obtained by dividing a range that can be taken by the index value α′, it is sufficient if a set of information for specifying the index value α′ belonging to each subrange and each weight value corresponding to each subrange determined in advance so that the weight value has a monotonic increase relationship with respect to the index value α′ is stored in the mixing unit 1211 in advance for each channel, and the mixing unit 1211 acquires, for each channel of each frame, a weight value corresponding to the index value α′ of the frame among the stored weight values and uses the acquired weight value as the weight of the downmixed signal. Each set stored in advance may be the same or different for the first channel and the second channel.

The mixing unit 1211 to which the index value α is input may obtain the input sound signal of the channel as it is as the encoding target signal of the channel for each channel in a case where the index value α is larger than a predetermined value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case other than the above case, that is, in a case where the index value α is equal to or less than the predetermined value (step S1211). The mixing unit 1211 may perform an operation in which “larger than a predetermined value” and “equal to or less than the predetermined value” described above are replaced with “equal to or larger than a predetermined value” and “smaller than the predetermined value”, respectively.

For example, the mixing unit 1211 to which the index value α is input may obtain the input sound signal of the channel as it is as the encoding target signal of the channel for each channel in a first range, within the range that can be taken by the index value α, that is a range in which the index value α is larger than a predetermined value (that is, in a first case where the index value α is larger than the predetermined value), and obtain, as the encoding target signal of the channel, for each channel in a second range that is a range other than the first range within the range that can be taken by the index value α (that is, in a second case other than the first case, specifically, in a case where the index value α is equal to or less than the predetermined value described above), a signal obtained by performing weighted addition on the input sound signal of the channel and the downmixed signal, in which the weight of the input sound signal of the channel in the weighted addition is a value having a monotonic increase relationship with respect to the index value α in the second range or the index value α, and the weight of the downmixed signal in the weighted addition is a value having a monotonic decrease relationship with respect to the index value α in the second range. The mixing unit 1211 may perform an operation in which “larger than a predetermined value” and “equal to or less than the predetermined value” described above are replaced with “equal to or larger than a predetermined value” and “smaller than the predetermined value”, respectively.

Alternatively, the mixing unit 1211 to which the index value α is input may obtain the downmixed signal as it is as the encoding target signal of the channel for each channel in a case where the index value α is smaller than a predetermined value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case other than the above case, that is, in a case where the index value α is equal to or larger than the predetermined value (step S1211). The mixing unit 1211 may perform an operation in which “smaller than a predetermined value” and “equal to or larger than the predetermined value” described above are replaced with “equal to or less than a predetermined value” and “larger than the predetermined value”, respectively.

For example, the mixing unit 1211 to which the index value α is input may obtain the downmixed signal as it is as the encoding target signal of the channel for each channel in a first range, within the range that can be taken by the index value α, that is a range in which the index value α is smaller than a predetermined value (that is, in a first case where the index value α is smaller than the predetermined value), and obtain, as the encoding target signal of the channel, for each channel in a second range that is a range other than the first range within the range that can be taken by the index value α (that is, in a second case other than the first case, specifically, in a case where the index value α is equal to or larger than the predetermined value described above), a signal obtained by performing weighted addition on the input sound signal of the channel and the downmixed signal, in which the weight of the input sound signal of the channel in the weighted addition is a value having a monotonic increase relationship with respect to the index value α in the second range or the index value α, and the weight of the downmixed signal in the weighted addition is a value having a monotonic decrease relationship with respect to the index value α in the second range. The mixing unit 1211 may perform an operation in which “smaller than a predetermined value” and “equal to or larger than the predetermined value” described above are replaced with “equal to or less than a predetermined value” and “larger than the predetermined value”, respectively.

Alternatively, the mixing unit 1211 to which the index value α is input may obtain the input sound signal of the channel as it is as the encoding target signal of the channel for each channel in a case where the index value α is larger than a predetermined first value, obtain the downmixed signal as it is as the encoding target signal of the channel for each channel in a case where the index value α is equal to or less than a predetermined second value smaller than the predetermined first value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case where neither of the two cases is applicable, that is, in a case where the index value α is equal to or less than the predetermined first value and larger than the predetermined second value (step S1211). The mixing unit 1211 may perform an operation in which “larger than a predetermined first value” and “equal to or less than the predetermined first value” described above are replaced with “equal to or larger than a predetermined first value” and “smaller than the predetermined first value”, respectively, and may perform an operation in which “larger than a predetermined second value” and “equal to or less than the predetermined second value” described above are replaced with “equal to or larger than a predetermined second value” and “smaller than the predetermined second value”, respectively.

For example, the mixing unit 1211 to which the index value α is input may obtain the input sound signal of the channel as it is as the encoding target signal of the channel for each channel in a first range, within the range that can be taken by the index value α, that is a range in which the index value α is larger than a predetermined first value (that is, in a first case where the index value α is larger than the predetermined first value), obtain the downmixed signal as it is as the encoding target signal of the channel for each channel in a second range, within the range that can be taken by the index value α, that is a range in which the index value α is equal to or less than the predetermined second value smaller than the first value described above (that is, in a second case where the index value α is equal to or less than the predetermined second value smaller than the first value described above), and obtain, as the encoding target signal of the channel, for each channel in a third range, within the range that can be taken by the index value α, that is a range other than the first range and the second range (that is, in a third case other than the first case and the second case, specifically, in a case where the index value α is equal to or less than the predetermined first value described above and larger than the predetermined second value described above), a signal obtained by performing weighted addition on the input sound signal of the channel and the downmixed signal, in which the weight of the input sound signal of the channel in the weighted addition is a value having a monotonic increase relationship with respect to the index value α in the third range or the index value α, and the weight of the downmixed signal in the weighted addition is a value having a monotonic decrease relationship with respect to the index value α in the third range. The mixing unit 1211 may perform an operation in which “larger than a predetermined first value” and “equal to or less than the predetermined first value” described above are replaced with “equal to or larger than a predetermined first value” and “smaller than the predetermined first value”, respectively, and may perform an operation in which “larger than a predetermined second value” and “equal to or less than the predetermined second value” described above are replaced with “equal to or larger than a predetermined second value” and “smaller than the predetermined second value”, respectively.

Alternatively, the mixing unit 1211 to which the index value α′ is input may obtain the input sound signal of the channel as it is as the encoding target signal of the channel for each channel in a case where the index value α′ is smaller than a predetermined value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case other than the above case, that is, in a case where the index value α′ is equal to or larger than the predetermined value (step S1211). The mixing unit 1211 may perform an operation in which “smaller than a predetermined value” and “equal to or larger than the predetermined value” described above are replaced with “equal to or less than a predetermined value” and “larger than the predetermined value”, respectively.

For example, the mixing unit 1211 to which the index value α′ is input may obtain the input sound signal of the channel as it is as the encoding target signal of the channel for each channel in a first range, within the range that can be taken by the index value α′, that is a range in which the index value α′ is smaller than a predetermined value (that is, in a first case where the index value α′ is smaller than the predetermined value), and obtain, as the encoding target signal of the channel, for each channel in a second range that is a range other than the first range within the range that can be taken by the index value α′ (that is, in a second case other than the first case, specifically, in a case where the index value α′ is equal to or larger than the predetermined value described above), a signal obtained by performing weighted addition on the input sound signal of the channel and the downmixed signal, in which the weight of the input sound signal of the channel in the weighted addition is a value having a monotonic decrease relationship with respect to the index value α′ in the second range, and the weight of the downmixed signal in the weighted addition is a value having a monotonic increase relationship with respect to the index value α′ in the second range or the index value α′. The mixing unit 1211 may perform an operation in which “smaller than a predetermined value” and “equal to or larger than the predetermined value” described above are replaced with “equal to or less than a predetermined value” and “larger than the predetermined value”, respectively.

Alternatively, the mixing unit 1211 to which the index value α′ is input may obtain the downmixed signal as it is as the encoding target signal of the channel for each channel in a case where the index value α′ is larger than a predetermined value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case other than the above case, that is, in a case where the index value α′ is equal to or less than the predetermined value (step S1211). The mixing unit 1211 may perform an operation in which “larger than a predetermined value” and “equal to or less than the predetermined value” described above are replaced with “equal to or larger than a predetermined value” and “smaller than the predetermined value”, respectively.

For example, the mixing unit 1211 to which the index value α′ is input may obtain the downmixed signal as it is as the encoding target signal of the channel for each channel in a first range, within the range that can be taken by the index value α′, that is a range in which the index value α is larger than a predetermined value (that is, in a first case where the index value α′ is larger than the predetermined value), and obtain, as the encoding target signal of the channel, for each channel in a second range that is a range other than the first range within the range that can be taken by the index value α′ (that is, in a second case other than the first case, specifically, in a case where the index value α′ is equal to or less than the predetermined value described above), a signal obtained by performing weighted addition on the input sound signal of the channel and the downmixed signal, in which the weight of the input sound signal of the channel in the weighted addition is a value having a monotonic decrease relationship with respect to the index value α′ in the second range, and the weight of the downmixed signal in the weighted addition is a value having a monotonic increase relationship with respect to the index value α′ in the second range or the index value α′. The mixing unit 1211 may perform an operation in which “larger than a predetermined value” and “equal to or less than the predetermined value” described above are replaced with “equal to or larger than a predetermined value” and “smaller than the predetermined value”, respectively.

Alternatively, the mixing unit 1211 to which the index value α′ is input may obtain the input sound signal of the channel as it is as the encoding target signal of the channel for each channel in a case where the index value α′ is smaller than a predetermined first value, obtain the downmixed signal as it is as the encoding target signal of the channel for each channel in a case where the index value α′ is equal to or larger than a predetermined second value larger than the predetermined first value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case where neither of the two cases is applicable, that is, in a case where the index value α′ is equal to or larger than the predetermined first value and smaller than the predetermined second value (step S1211). The mixing unit 1211 may perform an operation in which “smaller than a predetermined first value” and “equal to or larger than the predetermined first value” described above are replaced with “equal to or less than a predetermined first value” and “larger than the predetermined first value”, respectively, and may perform an operation in which “smaller than a predetermined second value” and “equal to or larger than the predetermined second value” described above are replaced with “equal to or less than a predetermined second value” and “larger than the predetermined second value”, respectively.

For example, the mixing unit 1211 to which the index value α′ is input may obtain the input sound signal of the channel as it is as the encoding target signal of the channel for each channel in a first range, within the range that can be taken by the index value α′, that is a range in which the index value α′ is smaller than a predetermined first value (that is, in a first case where the index value α′ is smaller than the predetermined first value), obtain the downmixed signal as it is as the encoding target signal of the channel for each channel in a second range, within the range that can be taken by the index value α′, that is a range in which the index value α′ is equal to or larger than the predetermined second value larger than the first value described above (that is, in a second case where the index value α′ is equal to or larger than the predetermined second value larger than the first value described above), and obtain, as the encoding target signal of the channel, for each channel in a third range, within the range that can be taken by the index value α′, that is a range other than the first range and the second range (that is, in a third case other than the first case and the second case, specifically, in a case where the index value α′ is equal to or larger than the predetermined first value described above and smaller than the predetermined second value described above), a signal obtained by performing weighted addition on the input sound signal of the channel and the downmixed signal, in which the weight of the input sound signal of the channel in the weighted addition is a value having a monotonic decrease relationship with respect to the index value α′ in the third range, and the weight of the downmixed signal in the weighted addition is a value having a monotonic increase relationship with respect to the index value α′ in the third range or the index value α′. The mixing unit 1211 may perform an operation in which “smaller than a predetermined first value” and “equal to or larger than the predetermined first value” described above are replaced with “equal to or less than a predetermined first value” and “larger than the predetermined first value”, respectively, and may perform an operation in which “smaller than a predetermined second value” and “equal to or larger than the predetermined second value” described above are replaced with “equal to or less than a predetermined second value” and “larger than the predetermined second value”, respectively.

### First Example of Index Value Calculation Unit 110 and Mixing Unit 1211

The index value calculation unit 110 obtains the index value α that is 0 or more and 1 or less and has a weak monotonic increase relationship with respect to the single sound source likeness. For example, the index value calculation unit 110 obtains, as the index value α, 0 when the index value of the single sound source likeness is the minimum value of values that can be taken by the index value, 1 when the index value of the single sound source likeness is the maximum value of values that can be taken by the index value, and a larger value as the index value of the single sound source likeness is larger.

More specifically, for example, the index value calculation unit 110 obtains the index value of the single sound source likeness of the two-channel stereo input sound signal by any of the above-described methods: [First Example of Method in which Index Value Calculation Unit 110 Obtains Index Value of Single Sound Source Likeness of Two-Channel Stereo Input Sound Signal] to [Third Example of Method in which Index Value Calculation Unit 110 Obtains Index Value of Single Sound Source Likeness of Two-Channel Stereo Input Sound Signal], and obtains a value obtained by normalizing the index value of the single sound source likeness of the two-channel stereo input sound signal so that the value falls within the range of 0 or more and 1 or less as the index value α. Note that, since the index values of the single sound source likeness of the two-channel stereo input sound signal obtained in step S110-C1-A2′ of [First Example of Method in which Index Value Calculation Unit 110 Obtains Index Value of Single Sound Source Likeness of Two-Channel Stereo Input Sound Signal] and step S110-C1-B6′ of [Second Example of Method in which Index Value Calculation Unit 110 Obtains Index Value of Single Sound Source Likeness of Two-Channel Stereo Input Sound Signal]falls within values in a range of 0 or more and 1 or less, the index value calculation unit 110 may directly obtain any of the index values of the single sound source likeness of the two-channel stereo input sound signal as the index value α.

Alternatively, the index value calculation unit 110 may obtain the index value of the single sound source likeness of the two-channel stereo input sound signal by any of the above-described methods: [First Example of Method in which Index Value Calculation Unit 110 Obtains Index Value of Single Sound Source Likeness of Two-Channel Stereo Input Sound Signal] to [Third Example of Method in which Index Value Calculation Unit 110 Obtains Index Value of Single Sound Source Likeness of Two-Channel Stereo Input Sound Signal], and obtain the index value α represented by Formula (4-2) described below by setting a value obtained by normalizing the index value of the single sound source likeness of the two-channel stereo input sound signal so that the value falls within values in a range of 0 or more and 1 or less as y, or setting the index value of the single sound source likeness of the two-channel stereo input sound signal obtained in any one of step S110-C1-A2′ of [First Example of Method in which Index Value Calculation Unit 110 Obtains Index Value of Single Sound Source Likeness of Two-Channel Stereo Input Sound Signal]and step S110-C1-B6′ of [Second Example of Method in which Index Value Calculation Unit 110 Obtains Index Value of Single Sound Source Likeness of Two-Channel Stereo Input Sound Signal] as y.

$$\begin{matrix}[ Math . 42 ] & \\ α = 0.5 \times ( 1 + cos ( 2 π \times ( 0.5 + y \times 0.5 ) ) ) & ( 4 ‐ 2 )\end{matrix}$$

For each time t, the mixing unit 1211 obtains a first channel encoding target signal x′₁(t) represented by Formula (2-23) described above and obtains a second channel encoding target signal x′₂(t) represented by Formula (2-24) described above.

When the index value calculation unit 110 calculates the index value α for each frame, the mixing unit 1211 may, for each frame, set the index value α calculated for the previous frame by the index value calculation unit 110 as ap, set the index value α calculated for the current frame by the index value calculation unit 110 as α_{c}, set a value obtained by Formula (2-25) described above as an index value α(t) for each time from the initial time (that is, the first time) of the current frame to the T₀−1th time, set α_{c} as the index value α(t) for each time from the τ₀th time to the last time (that is, the Tth time) of the current frame, and obtain the first channel encoding target signal x′₁(t) represented by Formula (2-26) described above instead of Formula (2-23) described above for each time t of the current frame, and obtain the second channel encoding target signal x′₂(t) represented by Formula (2-27) described above instead of Formula (2-24) described above.

### Second Example of Index Value Calculation Unit 110 and Mixing Unit 1211

The index value calculation unit 110 obtains the index value α′ that is 0 or more and 1 or less and has a weak monotonic decrease relationship with respect to the single sound source likeness. For example, the index value calculation unit 110 obtains, as the index value α′, 0 when the index value of the single sound source likeness is the maximum value of values that can be taken by the index value, 1 when the index value of the single sound source likeness is the minimum value of values that can be taken by the index value, and a larger value as the index value of the single sound source likeness is smaller.

For each time t, the mixing unit 1211 obtains a first channel encoding target signal x′₁(t) represented by Formula (2-28) described above and obtains a second channel encoding target signal x′₂(t) represented by Formula (2-29) described above.

When the index value calculation unit 110 calculates the index value α′ for each frame, the mixing unit 1211 may, for each frame, set the index value α′ calculated for the previous frame by the index value calculation unit 110 as α′ₚ, set the index value α′ calculated for the current frame by the index value calculation unit 110 as α′_{c}, set a value obtained by Formula (2-30) described above as an index value α′(t) for each time from the initial time (that is, the first time) of the current frame to the T₀−1th time, set α′_{c} as the index value α′ (t) for each time from the τ₀th time to the last time (that is, the Tth time) of the current frame, and obtain the first channel encoding target signal x′₁(t) represented by Formula (2-31) described above instead of Formula (2-28) described above for each time t of the current frame, and obtain the second channel encoding target signal x′₂(t) represented by Formula (2-32) described above instead of Formula (2-29) described above.

### Fifth Embodiment

In the fifth embodiment, a sound signal processing device 100 will be described that performs processing according to two or more of the bit rate of the stereo encoding of the stereo encoding device 200, the absolute value of the inter-channel time difference of the two-channel stereo input sound signal input to the sound signal processing device 100, and the single sound source likeness of the two-channel stereo input sound signal input to the sound signal processing device 100. The sound signal processing device 100 of the fifth embodiment is as indicated by the one-dot chain line, the broken line, and the solid line in FIG. 3 and includes an index value calculation unit 110 and a signal mixing unit 120. The sound signal processing device 100 performs processing of steps S110 and S120 indicated by the broken line and the solid line in FIG. 4. Hereinafter, the fifth embodiment will be described focusing on differences from the second embodiment.

### [Index Value Calculation Unit 110]

A first channel input sound signal and a second channel input sound signal, which are input sound signals of two channels constituting a two-channel stereo input sound signal input to the sound signal processing device 100, are input to the index value calculation unit 110. The index value calculation unit 110 calculates a value that satisfies two or more conditions among first, second, and third conditions described below as the index value α, or calculates a value that satisfies two or more conditions among fourth, fifth, and sixth conditions described below as the index value α′ (step S110). The index value α or the index value α′ obtained by the index value calculation unit 110 is output to the signal mixing unit 120.

The first condition is that when conditions other than the bit rate of the stereo encoding of the stereo encoding device 200 are the same, there is a weak monotonic increase relationship with respect to the bit rate of the stereo encoding of the stereo encoding device 200.

The second condition is that when conditions other than the absolute value |ITD| of the inter-channel time difference of the two-channel stereo input sound signal are the same, there is a weak monotonic decrease relationship with respect to the absolute value |ITD| of the inter-channel time difference of the two-channel stereo input sound signal.

The third condition is that when conditions other than the single sound source likeness of the two-channel stereo input sound signal are the same, there is a weak monotonic increase relationship with respect to the single sound source likeness of the two-channel stereo input sound signal. It can also be said that the third condition is that when conditions other than the multiple sound source likeness of the two-channel stereo input sound signal are the same, there is a weak monotonic decrease relationship with respect to the multiple sound source likeness of the two-channel stereo input sound signal.

That is, the index value α calculated by the index value calculation unit 110 is one of four types described below.

The first type of index value α is a value that satisfies the first condition and the second condition. In a case where the index value calculation unit 110 calculates the first type of index value α, for example, it is sufficient if a function that weakly monotonically increases with respect to a first argument when a second argument has the same value and weakly monotonically decreases with respect to the second argument when the first argument has the same value is stored in the index value calculation unit 110, and the index value calculation unit 110 gives the bit rate of the stereo encoding of the frame as the first argument and gives the absolute value |ITD| of the inter-channel time difference of the frame as the second argument to the function for each frame to acquire the function value, and sets the acquired function value as the index value α of the frame. Assuming that the bit rate of the stereo encoding of the stereo encoding device 200 is BR, a certain predetermined weak monotonic increase function is f₁( ), and a certain predetermined weak monotonic decrease function is f₂( ), a function value f₁(BR)+f₂(|ITD|) is an example of the first type of index value α.

The second type of index value α is a value that satisfies the first condition and the third condition. In a case where the index value calculation unit 110 calculates the second type of index value α, for example, it is sufficient if a function that weakly monotonically increases with respect to a first argument when a second argument has the same value and weakly monotonically increases with respect to the second argument when the first argument has the same value is stored in the index value calculation unit 110, and the index value calculation unit 110 gives the bit rate of the stereo encoding of the frame as the first argument and gives the index value of the single sound source likeness of the frame as the second argument to the function for each frame to acquire the function value, and sets the acquired function value as the index value α of the frame. Assuming that the index value of the single sound source likeness is SS and a certain predetermined weak monotonic increase function is f₃( ), a function value f₁(BR)+f₃(SS) is an example of the second type of index value α.

The third type of index value α is a value that satisfies the second condition and the third condition. In a case where the index value calculation unit 110 calculates the third type of index value α, for example, it is sufficient if a function that weakly monotonically decreases with respect to a first argument when a second argument has the same value and weakly monotonically increases with respect to the second argument when the first argument has the same value is stored in the index value calculation unit 110, and the index value calculation unit 110 gives the absolute value |ITD| of the inter-channel time difference of the frame as the first argument and gives the index value of the single sound source likeness of the frame as the second argument to the function for each frame to acquire the function value, and sets the acquired function value as the index value α of the frame. A function value f₂(|ITD|)+f₃(SS) is an example of the third type of index value α.

The fourth type of index value α is a value that satisfies the first condition, the second condition, and the third condition. In a case where the index value calculation unit 110 calculates the fourth type of index value α, for example, it is sufficient if a function that weakly monotonically increases with respect to a first argument when a second argument has the same value and a third argument has the same value, weakly monotonically decreases with respect to the second argument when the first argument has the same value and the third argument has the same value, and weakly monotonically increases with respect to the third argument when the first argument has the same value and the second argument has the same value is stored in the index value calculation unit 110, and the index value calculation unit 110 gives the bit rate of the stereo encoding of the frame as the first argument, gives the absolute value |ITD| of the inter-channel time difference of the frame as the second argument, and gives the index value of the single sound source likeness of the frame as the third argument to the function for each frame to acquire the function value, and sets the acquired function value as the index value α of the frame. A function value f₁(BR)+f₂(|ITD|)+f₃(SS) is an example of the fourth type of index value α.

The fourth condition is that when conditions other than the bit rate of the stereo encoding of the stereo encoding device 200 are the same, there is a weak monotonic decrease relationship with respect to the bit rate of the stereo encoding of the stereo encoding device 200.

The fifth condition is that when conditions other than the absolute value |ITD| of the inter-channel time difference of the two-channel stereo input sound signal are the same, there is a weak monotonic increase relationship with respect to the absolute value |ITD| of the inter-channel time difference of the two-channel stereo input sound signal.

The sixth condition is that when conditions other than the single sound source likeness of the two-channel stereo input sound signal are the same, there is a weak monotonic decrease relationship with respect to the single sound source likeness of the two-channel stereo input sound signal. It can also be said that the sixth condition is that when conditions other than the multiple sound source likeness of the two-channel stereo input sound signal are the same, there is a weak monotonic increase relationship with respect to the multiple sound source likeness of the two-channel stereo input sound signal.

That is, the index value α′ calculated by the index value calculation unit 110 is one of four types described below.

The first type of index value α′ is an index value that satisfies the fourth condition and the fifth condition. In a case where the index value calculation unit 110 calculates the first type of index value α′, for example, it is sufficient if a function that weakly monotonically decreases with respect to a first argument when a second argument has the same value and weakly monotonically increases with respect to the second argument when the first argument has the same value is stored in the index value calculation unit 110, and the index value calculation unit 110 gives the bit rate of the stereo encoding of the frame as the first argument and gives the absolute value |ITD| of the inter-channel time difference of the frame as the second argument to the function for each frame to acquire the function value, and sets the acquired function value as the index value α′ of the frame. Assuming that a certain predetermined weak monotonic decrease function is f₄( ), and a certain predetermined weak monotonic increase function is f₅( ), a function value f₄(BR)+f₅(|ITD|) is an example of the first type of index value α′.

The second type of index value α′ is an index value that satisfies the fourth condition and the sixth condition. In a case where the index value calculation unit 110 calculates the second type of index value α′, for example, it is sufficient if a function that weakly monotonically decreases with respect to a first argument when a second argument has the same value and weakly monotonically decreases with respect to the second argument when the first argument has the same value is stored in the index value calculation unit 110, and the index value calculation unit 110 gives the bit rate of the stereo encoding of the frame as the first argument and gives the index value of the single sound source likeness of the frame as the second argument to the function for each frame to acquire the function value, and sets the acquired function value as the index value α′ of the frame. Assuming that a certain predetermined weak monotonic decrease function is f₆( ), a function value f₄(BR)+f₆(SS) is an example of the second type of index value α′.

The third type of index value α′ is an index value that satisfies the fifth condition and the sixth condition. In a case where the index value calculation unit 110 calculates the third type of index value α′, for example, it is sufficient if a function that weakly monotonically increases with respect to a first argument when a second argument has the same value and weakly monotonically decreases with respect to the second argument when the first argument has the same value is stored in the index value calculation unit 110, and the index value calculation unit 110 gives the absolute value |ITD| of the inter-channel time difference of the frame as the first argument and gives the index value of the single sound source likeness of the frame as the second argument to the function for each frame to acquire the function value, and sets the acquired function value as the index value α′ of the frame. A function value f₅(|ITD|)+f₆(SS) is an example of the third type of index value α′.

The fourth type of index value α′ is an index value that satisfies the fourth condition, the fifth condition, and the sixth condition. In a case where the index value calculation unit 110 calculates the fourth type of index value α′, for example, it is sufficient if a function that weakly monotonically decreases with respect to a first argument when a second argument has the same value and a third argument has the same value, weakly monotonically increases with respect to the second argument when the first argument has the same value and the third argument has the same value, and weakly monotonically decreases with respect to the third argument when the first argument has the same value and the second argument has the same value is stored in the index value calculation unit 110, and the index value calculation unit 110 gives the bit rate of the stereo encoding of the frame as the first argument, gives the absolute value |ITD| of the inter-channel time difference of the frame as the second argument, and gives the index value of the single sound source likeness of the frame as the third argument to the function for each frame to acquire the function value, and sets the acquired function value as the index value α′ of the frame. A function value f₄(BR)+f₅(|ITD|)+f₆(SS) is an example of the fourth type of index value α′.

When the index value calculation unit 110 calculates the index value α or the index value α′ based on the absolute value |ITD| of the inter-channel time difference of the two-channel stereo input sound signal, it is sufficient if the index value calculation unit 110 calculates the index value α or the index value α′ after calculating the absolute value |ITD| of the inter-channel time difference of the two-channel stereo input sound signal by the same method as the index value calculation unit 110 of the third embodiment, for example.

When the index value calculation unit 110 calculates the index value α or the index value α′ based on the single sound source likeness or the multiple sound source likeness of the two-channel stereo input sound signal, it is sufficient if the index value calculation unit 110 calculates the index value α or the index value α′ after calculating the index value of the single sound source likeness or the index value of the multiple sound source likeness of the two-channel stereo input sound signal by the same method as the index value calculation unit 110 of the fourth embodiment, for example.

### [Signal Mixing Unit 120]

Although contents of the index value α and the index value α′ are different, input/output and operation of the signal mixing unit 120 are the same as those in the first modification of the second embodiment, the first modification of the third embodiment, and the fourth embodiment. A first channel input sound signal and a second channel input sound signal, which are input sound signals of two channels constituting a two-channel stereo input sound signal input to the sound signal processing device 100, and the index value α or index value α′ output from the index value calculation unit 110 are input to the signal mixing unit 120. The signal mixing unit 120 to which the index value α is input obtains, for each channel of the first channel and the second channel, as the encoding target signal of the channel, a signal in which the input sound signal of the channel and the input sound signal of the other channel are mixed, the signal being closer to the input sound signal of the channel as the index value α is larger, and the signal mixing unit 120 to which the index value α′ is input obtains, for each channel of the first channel and the second channel, as the encoding target signal of the channel, a signal obtained by performing weighted addition on the input sound signal of the channel and the input sound signal of the other channel, the signal being closer to the input sound signal of the channel as the index value α′ is smaller (step S120). The encoding target signals (that is, the two-channel stereo encoding target signal) of the two channels obtained by the signal mixing unit 120 are output to the stereo encoding device 200 as output signals of the sound signal processing device 100.

For example, the signal mixing unit 120 to which the index value α is input obtains, for each channel, as the encoding target signal of the channel, a signal obtained by performing weighted addition on the input sound signal of the channel and the input sound signal of the other channel, in which the weight of the input sound signal of the channel in the weighted addition is a value having a monotonic increase relationship with respect to the index value α or the index value α, and the weight of the input sound signal of the other channel in the weighted addition is a value having a monotonic decrease relationship with respect to the index value α.

The value having a monotonic increase relationship with respect to the index value α is, for example, a function value of a monotonic increase function using the index value α as an argument. Therefore, for example, it is sufficient if a monotonic increase function for each channel is stored in the signal mixing unit 120 in advance, and the signal mixing unit 120 acquires a function value by giving the index value α as an argument to the monotonic increase function for the channel for each channel of each frame and uses the acquired function value as the weight of the input sound signal of the channel. The monotonic increase function for the first channel and the monotonic increase function for the second channel may be the same or different. Alternatively, for example, for a plurality of subranges obtained by dividing a range that can be taken by the index value α, it is sufficient if a set of information for specifying the index value α belonging to each subrange and each weight value corresponding to each subrange determined in advance so that the weight value has a monotonic increase relationship with respect to the index value α is stored in the signal mixing unit 120 in advance for each channel, and the signal mixing unit 120 acquires, for each channel of each frame, a weight value corresponding to the index value α of the frame among the stored weight values and uses the acquired weight value as the weight of the input sound signal of the channel. Each set stored in advance may be the same or different for the first channel and the second channel.

The value having a monotonic decrease relationship with respect to the index value α is, for example, a function value of a monotonic decrease function using the index value α as an argument. Therefore, for example, it is sufficient if a monotonic decrease function for each channel is stored in the signal mixing unit 120 in advance, and the signal mixing unit 120 acquires a function value by giving the index value α as an argument to the monotonic decrease function for the channel for each channel of each frame and uses the acquired function value as the weight of the input sound signal of the other channel. The monotonic decrease function for the first channel and the monotonic decrease function for the second channel may be the same or different. Alternatively, for example, for a plurality of subranges obtained by dividing a range that can be taken by the index value α, it is sufficient if a set of information for specifying the index value α belonging to each subrange and each weight value corresponding to each subrange determined in advance so that the weight value has a monotonic decrease relationship with respect to the index value α is stored in the signal mixing unit 120 in advance for each channel, and the signal mixing unit 120 acquires, for each channel of each frame, a weight value corresponding to the index value α of the frame among the stored weight values and uses the acquired weight value as the weight of the input sound signal of the other channel. Each set stored in advance may be the same or different for the first channel and the second channel.

For example, the signal mixing unit 120 to which the index value α′ is input obtains, for each channel, as the encoding target signal of the channel, a signal obtained by performing weighted addition on the input sound signal of the channel and the input sound signal of the other channel, in which the weight of the input sound signal of the channel in the weighted addition is a value having a monotonic decrease relationship with respect to the index value α′, and the weight of the input sound signal of the other channel in the weighted addition is a value having a monotonic increase relationship with respect to the index value α′ or the index value α′.

The value having a monotonic decrease relationship with respect to the index value α′ is, for example, a function value of a monotonic decrease function using the index value α′ as an argument. Therefore, for example, it is sufficient if a monotonic decrease function for each channel is stored in the signal mixing unit 120 in advance, and the signal mixing unit 120 acquires a function value by giving the index value α′ as an argument to the monotonic decrease function for the channel for each channel of each frame and uses the acquired function value as the weight of the input sound signal of the channel. The monotonic decrease function for the first channel and the monotonic decrease function for the second channel may be the same or different. Alternatively, for example, for a plurality of subranges obtained by dividing a range that can be taken by the index value α′, it is sufficient if a set of information for specifying the index value α′ belonging to each subrange and each weight value corresponding to each subrange determined in advance so that the weight value has a monotonic decrease relationship with respect to the index value α′ is stored in the signal mixing unit 120 in advance for each channel, and the signal mixing unit 120 acquires, for each channel of each frame, a weight value corresponding to the index value α′ of the frame among the stored weight values and uses the acquired weight value as the weight of the input sound signal of the channel. Each set stored in advance may be the same or different for the first channel and the second channel.

The value having a monotonic increase relationship with respect to the index value α′ is, for example, a function value of a monotonic increase function using the index value α′ as an argument. Therefore, for example, it is sufficient if a monotonic increase function for each channel is stored in the signal mixing unit 120 in advance, and the signal mixing unit 120 acquires a function value by giving the index value α′ as an argument to the monotonic increase function for the channel for each channel of each frame and uses the acquired function value as the weight of the input sound signal of the other channel. The monotonic increase function for the first channel and the monotonic increase function for the second channel may be the same or different. Alternatively, for example, for a plurality of subranges obtained by dividing a range that can be taken by the index value α′, it is sufficient if a set of information for specifying the index value α′ belonging to each subrange and each weight value corresponding to each subrange determined in advance so that the weight value has a monotonic increase relationship with respect to the index value α′ is stored in the signal mixing unit 120 in advance for each channel, and the signal mixing unit 120 acquires, for each channel of each frame, a weight value corresponding to the index value α′ of the frame among the stored weight values and uses the acquired weight value as the weight of the input sound signal of the other channel. Each set stored in advance may be the same or different for the first channel and the second channel.

The signal mixing unit 120 to which the index value α is input may obtain the input sound signal of the channel as it is as the encoding target signal of the channel for each channel in a case where the index value α is larger than a predetermined value, and obtain the signal in which the input sound signal of the channel and the input sound signal of the other channel are mixed for each channel, the signal being closer to the input sound signal of the channel as the index value α is larger as the encoding target signal of the channel in a case other than the above case, that is, in a case where the index value α is equal to or less than the predetermined value (step S120). The signal mixing unit 120 may perform an operation in which “larger than a predetermined value” and “equal to or less than the predetermined value” described above are replaced with “equal to or larger than a predetermined value” and “smaller than the predetermined value”, respectively.

For example, the signal mixing unit 120 to which the index value α is input may obtain the input sound signal of the channel as it is as the encoding target signal of the channel for each channel in a first range, within the range that can be taken by the index value α, that is a range in which the index value α is larger than a predetermined value (that is, in a first case where the index value α is larger than the predetermined value), and obtain, as the encoding target signal of the channel, for each channel in a second range that is a range other than the first range within the range that can be taken by the index value α (that is, in a second case other than the first case, specifically, in a case where the index value α is equal to or less than the predetermined value described above), a signal obtained by performing weighted addition on the input sound signal of the channel and the input sound signal of the other channel, in which the weight of the input sound signal of the channel in the weighted addition is a value having a monotonic increase relationship with respect to the index value α in the second range or the index value α, and the weight of the input sound signal of the other channel in the weighted addition is a value having a monotonic decrease relationship with respect to the index value α in the second range. The signal mixing unit 120 may perform an operation in which “larger than a predetermined value” and “equal to or less than the predetermined value” described above are replaced with “equal to or larger than a predetermined value” and “smaller than the predetermined value”, respectively.

Similarly, the signal mixing unit 120 to which the index value α′ is input may obtain the input sound signal of the channel as it is as the encoding target signal of the channel for each channel in a case where the index value α′ is smaller than a predetermined value, and obtain the signal in which the input sound signal of the channel and the input sound signal of the other channel are mixed for each channel, the signal being closer to the input sound signal of the channel as the index value α′ is smaller as the encoding target signal of the channel in a case other than the above case, that is, in a case where the index value α′ is equal to or larger than the predetermined value (step S120). The signal mixing unit 120 may perform an operation in which “smaller than a predetermined value” and “equal to or larger than the predetermined value” described above are replaced with “equal to or less than a predetermined value” and “larger than the predetermined value”, respectively.

For example, the signal mixing unit 120 to which the index value α′ is input may obtain the input sound signal of the channel as it is as the encoding target signal of the channel for each channel in a first range, within the range that can be taken by the index value α′, that is a range in which the index value α′ is smaller than a predetermined value (that is, in a first case where the index value α′ is smaller than the predetermined value), and obtain, as the encoding target signal of the channel, for each channel in a second range that is a range other than the first range within the range that can be taken by the index value α′ (that is, in a second case other than the first case, specifically, in a case where the index value α′ is equal to or larger than the predetermined value described above), a signal obtained by performing weighted addition on the input sound signal of the channel and the input sound signal of the other channel, in which the weight of the input sound signal of the channel in the weighted addition is a value having a monotonic decrease relationship with respect to the index value α′ in the second range, and the weight of the input sound signal of the other channel in the weighted addition is a value having a monotonic increase relationship with respect to the index value α′ in the second range or the index value α′. The signal mixing unit 120 may perform an operation in which “smaller than a predetermined value” and “equal to or larger than the predetermined value” described above are replaced with “equal to or less than a predetermined value” and “larger than the predetermined value”, respectively.

### First Example of Index Value Calculation Unit 110 and Signal Mixing Unit 120

The index value calculation unit 110 obtains an index value α that is 0.5 or more and 1 or less and satisfies two or more of the first condition, the second condition, and the third condition. Specifically, the index value calculation unit 110 obtains any of an index value α that is 0.5 or more and 1 or less and satisfies the first condition and the second condition, an index value α that is 0.5 or more and 1 or less and satisfies the first condition and the third condition, an index value α that is 0.5 or more and 1 or less and satisfies the second condition and the third condition, and an index value α that is 0.5 or more and 1 or less and satisfies the first condition, the second condition, and the third condition.

For each time t, the signal mixing unit 120 obtains a first channel encoding target signal x′₁(t) represented by Formula (2-7) described above and obtains a second channel encoding target signal x′₂(t) represented by Formula (2-8) described above.

When the index value calculation unit 110 calculates the index value α for each frame, the signal mixing unit 120 may, for each frame, set the index value α calculated for the previous frame by the index value calculation unit 110 as αₚ, set the index value α calculated for the current frame by the index value calculation unit 110 as α_{c}, set a value obtained by Formula (2-9) described above as an index value α(t) for each time from the initial time (that is, the first time) of the current frame to the T₀−1th time, set α_{c} as the index value α(t) for each time from the τ₀th time to the last time (that is, the Tth time) of the current frame, and obtain the first channel encoding target signal x′₁(t) represented by Formula (2-10) described above instead of Formula (2-7) described above for each time t of the current frame, and obtain the second channel encoding target signal x′₂(t) represented by Formula (2-11) described above instead of Formula (2-8) described above.

### Second Example of Index Value Calculation Unit 110 and Signal Mixing Unit 120

The index value calculation unit 110 obtains an index value α′ that is 0 or more and 0.5 or less and satisfies two or more of the fourth condition, the fifth condition, and the sixth condition. Specifically, the index value calculation unit 110 obtains any of an index value α′ that is 0 or more and 0.5 or less and satisfies the fourth condition and the fifth condition, an index value α′ that is 0 or more and 0.5 or less and satisfies the fourth condition and the sixth condition, an index value α′ that is 0 or more and 0.5 or less and satisfies the fifth condition and the sixth condition, and an index value α′ that is 0 or more and 0.5 or less and satisfies the fourth condition, the fifth condition, and the sixth condition.

For each time t, the signal mixing unit 120 obtains a first channel encoding target signal x′₁(t) represented by Formula (2-12) described above and obtains a second channel encoding target signal x′₂(t) represented by Formula (2-13) described above.

When the index value calculation unit 110 calculates the index value α′ for each frame, the signal mixing unit 120 may, for each frame, set the index value α′ calculated for the previous frame by the index value calculation unit 110 as α′ₚ, set the index value α′ calculated for the current frame by the index value calculation unit 110 as α′_{c}, set a value obtained by Formula (2-14) described above as an index value α′(t) for each time from the initial time (that is, the first time) of the current frame to the To-lth time, set α′_{c} as the index value α′ (t) for each time from the τ₀th time to the last time (that is, the Tth time) of the current frame, and obtain the first channel encoding target signal x′₁(t) represented by Formula (2-15) described above instead of Formula (2-12) described above for each time t of the current frame, and obtain the second channel encoding target signal x′₂(t) represented by Formula (2-16) described above instead of Formula (2-13) described above.

### First Modification of Fifth Embodiment

The fifth embodiment may be implemented including processing of mixing a two-channel stereo input sound signal to generate a downmixed signal. A mode including processing of generating a downmixed signal will be described as a first modification of the fifth embodiment. A sound signal processing device 100 of the first modification of the fifth embodiment is as indicated by the one-dot chain line, the broken line, and the solid line in FIG. 5 and includes an index value calculation unit 110 and a signal mixing unit 120, and the signal mixing unit 120 includes a downmixed signal generation unit 1201 and a mixing unit 1211. As indicated by the broken line and the solid line in FIG. 6, the sound signal processing device 100 performs processing of step S110, and processing of step S120 including steps S1201 and S1211. Hereinafter, the first modification of the fifth embodiment will be described focusing on differences from the fifth embodiment.

### [Index Value Calculation Unit 110]

Input/output and operation of the index value calculation unit 110 are the same as those in the fifth embodiment, and details are as described in the fifth embodiment. A first channel input sound signal and a second channel input sound signal, which are input sound signals of two channels constituting a two-channel stereo input sound signal input to the sound signal processing device 100, are input to the index value calculation unit 110. The index value calculation unit 110 calculates a value that satisfies two or more conditions among the first, second, and third conditions described above as the index value α, or calculates a value that satisfies two or more conditions among the fourth, fifth, and sixth conditions described above as the index value α′ (step S110). The index value α or the index value α′ obtained by the index value calculation unit 110 is output to the signal mixing unit 120.

### [Downmixed Signal Generation Unit 1201]

Input/output and operation of the downmixed signal generation unit 1201 are the same as those in the second and third modifications of the second embodiment, and the second and third modifications of the third embodiment, and the first modification of the fourth embodiment, and details are as described in the second modification of the second embodiment. A first channel input sound signal and a second channel input sound signal, which are input sound signals of two channels constituting a two-channel stereo input sound signal input to the sound signal processing device 100, are input to the downmixed signal generation unit 1201. The downmixed signal generation unit 1201 mixes the first channel input sound signal and the second channel input sound signal to generate a downmixed signal (step S1201). The downmixed signal obtained by the downmixed signal generation unit 1201 is output to the mixing unit 1211.

### [Mixing Unit 1211]

Although contents of the index value α and the index value α′ are different, input/output and operation of the mixing unit 1211 are the same as those in the third modification of the second embodiment, the third modification of the third embodiment, and the first modification of the fourth embodiment. A first channel input sound signal and a second channel input sound signal, which are input sound signals of two channels constituting a two-channel stereo input sound signal input to the sound signal processing device 100, the downmixed signal output from the downmixed signal generation unit 1201, and the index value α or the index value α′ output from the index value calculation unit 110 are input to the mixing unit 1211. The mixing unit 1211 to which the index value α is input obtains, for each channel of the first channel and the second channel, as the encoding target signal of the channel, a signal in which the input sound signal of the channel and the downmixed signal are mixed, the signal being closer to the input sound signal of the channel as the index value α is larger (that is, the signal closer to the downmixed signal as the index value α is smaller), and the mixing unit 1211 to which the index value α′ is input obtains, for each channel of the first channel and the second channel, as the encoding target signal of the channel, a signal in which the input sound signal of the channel and the downmixed signal are mixed, the signal being closer to the input sound signal of the channel as the index value α′ is smaller (that is, the signal closer to the downmixed signal as the index value α′ is larger) (step S1201). The encoding target signals (that is, the two-channel stereo encoding target signal) of the two channels obtained by the mixing unit 1211 are output to the stereo encoding device 200 as output signals of the sound signal processing device 100.

For example, the mixing unit 1211 to which the index value α is input obtains, for each channel, as the encoding target signal of the channel, a signal obtained by performing weighted addition on the input sound signal of the channel and the downmixed signal, in which the weight of the input sound signal of the channel in the weighted addition is a value having a monotonic increase relationship with respect to the index value α or the index value α, and the weight of the downmixed signal in the weighted addition is a value having a monotonic decrease relationship with respect to the index value α.

The value having a monotonic increase relationship with respect to the index value α is, for example, a function value of a monotonic increase function using the index value α as an argument. Therefore, for example, it is sufficient if a monotonic increase function for each channel is stored in the mixing unit 1211 in advance, and the mixing unit 1211 acquires a function value by giving the index value α as an argument to the monotonic increase function for the channel for each channel of each frame and uses the acquired function value as the weight of the input sound signal of the channel. The monotonic increase function for the first channel and the monotonic increase function for the second channel may be the same or different. Alternatively, for example, for a plurality of subranges obtained by dividing a range that can be taken by the index value α, it is sufficient if a set of information for specifying the index value α belonging to each subrange and each weight value corresponding to each subrange determined in advance so that the weight value has a monotonic increase relationship with respect to the index value α is stored in the mixing unit 1211 in advance for each channel, and the mixing unit 1211 acquires, for each channel of each frame, a weight value corresponding to the index value α of the frame among the stored weight values and uses the acquired weight value as the weight of the input sound signal of the channel. Each set stored in advance may be the same or different for the first channel and the second channel.

The value having a monotonic decrease relationship with respect to the index value α is, for example, a function value of a monotonic decrease function using the index value α as an argument. Therefore, for example, it is sufficient if a monotonic decrease function for each channel is stored in the mixing unit 1211 in advance, and the mixing unit 1211 acquires a function value by giving the index value α as an argument to the monotonic decrease function for the channel for each channel of each frame and uses the acquired function value as the weight of the downmixed signal. The monotonic decrease function for the first channel and the monotonic decrease function for the second channel may be the same or different. Alternatively, for example, for a plurality of subranges obtained by dividing a range that can be taken by the index value α, it is sufficient if a set of information for specifying the index value α belonging to each subrange and each weight value corresponding to each subrange determined in advance so that the weight value has a monotonic decrease relationship with respect to the index value α is stored in the mixing unit 1211 in advance for each channel, and the mixing unit 1211 acquires, for each channel of each frame, a weight value corresponding to the index value α of the frame among the stored weight values and uses the acquired weight value as the weight of the downmixed signal. Each set stored in advance may be the same or different for the first channel and the second channel.

For example, the mixing unit 1211 to which the index value α′ is input obtains, for each channel, as the encoding target signal of the channel, a signal obtained by performing weighted addition on the input sound signal of the channel and the downmixed signal, in which the weight of the input sound signal of the channel in the weighted addition is a value having a monotonic decrease relationship with respect to the index value α′, and the weight of the downmixed signal in the weighted addition is a value having a monotonic increase relationship with respect to the index value α′ or the index value α′.

The value having a monotonic decrease relationship with respect to the index value α′ is, for example, a function value of a monotonic decrease function using the index value α′ as an argument. Therefore, for example, it is sufficient if a monotonic decrease function for each channel is stored in the mixing unit 1211 in advance, and the mixing unit 1211 acquires a function value by giving the index value α′ as an argument to the monotonic decrease function for the channel for each channel of each frame and uses the acquired function value as the weight of the input sound signal of the channel. The monotonic decrease function for the first channel and the monotonic decrease function for the second channel may be the same or different. Alternatively, for example, for a plurality of subranges obtained by dividing a range that can be taken by the index value α′, it is sufficient if a set of information for specifying the index value α′ belonging to each subrange and each weight value corresponding to each subrange determined in advance so that the weight value has a monotonic decrease relationship with respect to the index value α′ is stored in the mixing unit 1211 in advance for each channel, and the mixing unit 1211 acquires, for each channel of each frame, a weight value corresponding to the index value α′ of the frame among the stored weight values and uses the acquired weight value as the weight of the input sound signal of the channel. Each set stored in advance may be the same or different for the first channel and the second channel.

The value having a monotonic increase relationship with respect to the index value α′ is, for example, a function value of a monotonic increase function using the index value α′ as an argument. Therefore, for example, it is sufficient if a monotonic increase function for each channel is stored in the mixing unit 1211 in advance, and the mixing unit 1211 acquires a function value by giving the index value α′ as an argument to the monotonic increase function for the channel for each channel of each frame and uses the acquired function value as the weight of the downmixed signal. The monotonic increase function for the first channel and the monotonic increase function for the second channel may be the same or different. Alternatively, for example, for a plurality of subranges obtained by dividing a range that can be taken by the index value α′, it is sufficient if a set of information for specifying the index value α′ belonging to each subrange and each weight value corresponding to each subrange determined in advance so that the weight value has a monotonic increase relationship with respect to the index value α′ is stored in the mixing unit 1211 in advance for each channel, and the mixing unit 1211 acquires, for each channel of each frame, a weight value corresponding to the index value α′ of the frame among the stored weight values and uses the acquired weight value as the weight of the downmixed signal. Each set stored in advance may be the same or different for the first channel and the second channel.

The mixing unit 1211 to which the index value α is input may obtain the input sound signal of the channel as it is as the encoding target signal of the channel for each channel in a case where the index value α is larger than a predetermined value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case other than the above case, that is, in a case where the index value α is equal to or less than the predetermined value (step S1211). The mixing unit 1211 may perform an operation in which “larger than a predetermined value” and “equal to or less than the predetermined value” described above are replaced with “equal to or larger than a predetermined value” and “smaller than the predetermined value”, respectively.

For example, the mixing unit 1211 to which the index value α is input may obtain the input sound signal of the channel as it is as the encoding target signal of the channel for each channel in a first range, within the range that can be taken by the index value α, that is a range in which the index value α is larger than a predetermined value (that is, in a first case where the index value α is larger than the predetermined value), and obtain, as the encoding target signal of the channel, for each channel in a second range that is a range other than the first range within the range that can be taken by the index value α (that is, in a second case other than the first case, specifically, in a case where the index value α is equal to or less than the predetermined value described above), a signal obtained by performing weighted addition on the input sound signal of the channel and the downmixed signal, in which the weight of the input sound signal of the channel in the weighted addition is a value having a monotonic increase relationship with respect to the index value α in the second range or the index value α, and the weight of the downmixed signal in the weighted addition is a value having a monotonic decrease relationship with respect to the index value α in the second range. The mixing unit 1211 may perform an operation in which “larger than a predetermined value” and “equal to or less than the predetermined value” described above are replaced with “equal to or larger than a predetermined value” and “smaller than the predetermined value”, respectively.

Alternatively, the mixing unit 1211 to which the index value α is input may obtain the downmixed signal as it is as the encoding target signal of the channel for each channel in a case where the index value α is smaller than a predetermined value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case other than the above case, that is, in a case where the index value α is equal to or larger than the predetermined value (step S1211). The mixing unit 1211 may perform an operation in which “smaller than a predetermined value” and “equal to or larger than the predetermined value” described above are replaced with “equal to or less than a predetermined value” and “larger than the predetermined value”, respectively.

For example, the mixing unit 1211 to which the index value α is input may obtain the downmixed signal as it is as the encoding target signal of the channel for each channel in a first range, within the range that can be taken by the index value α, that is a range in which the index value α is smaller than a predetermined value (that is, in a first case where the index value α is smaller than the predetermined value), and obtain, as the encoding target signal of the channel, for each channel in a second range that is a range other than the first range within the range that can be taken by the index value α (that is, in a second case other than the first case, specifically, in a case where the index value α is equal to or larger than the predetermined value described above), a signal obtained by performing weighted addition on the input sound signal of the channel and the downmixed signal, in which the weight of the input sound signal of the channel in the weighted addition is a value having a monotonic increase relationship with respect to the index value α in the second range or the index value α, and the weight of the downmixed signal in the weighted addition is a value having a monotonic decrease relationship with respect to the index value α in the second range. The mixing unit 1211 may perform an operation in which “smaller than a predetermined value” and “equal to or larger than the predetermined value” described above are replaced with “equal to or less than a predetermined value” and “larger than the predetermined value”, respectively.

Alternatively, the mixing unit 1211 to which the index value α is input may obtain the input sound signal of the channel as it is as the encoding target signal of the channel for each channel in a case where the index value α is larger than a predetermined first value, obtain the downmixed signal as it is as the encoding target signal of the channel for each channel in a case where the index value α is equal to or less than a predetermined second value smaller than the predetermined first value, and obtain the signal in which the input sound signal of the channel and the downmixed signal are mixed for each channel, the signal being closer to the input sound signal of the channel as the index value α is larger (that is, the signal closer to the downmixed signal as the index value α is smaller) as the encoding target signal of the channel in a case where neither of the two cases is applicable, that is, in a case where the index value α is equal to or less than the predetermined first value and larger than the predetermined second value (step S1211). The mixing unit 1211 may perform an operation in which “larger than a predetermined first value” and “equal to or less than the predetermined first value” described above are replaced with “equal to or larger than a predetermined first value” and “smaller than the predetermined first value”, respectively, and may perform an operation in which “larger than a predetermined second value” and “equal to or less than the predetermined second value” described above are replaced with “equal to or larger than a predetermined second value” and “smaller than the predetermined second value”, respectively.

For example, the mixing unit 1211 to which the index value α is input may obtain the input sound signal of the channel as it is as the encoding target signal of the channel for each channel in a first range, within the range that can be taken by the index value α, that is a range in which the index value α is larger than a predetermined first value (that is, in a first case where the index value α is larger than the predetermined first value), obtain the downmixed signal as it is as the encoding target signal of the channel for each channel in a second range, within the range that can be taken by the index value α, that is a range in which the index value α is equal to or less than the predetermined second value smaller than the first value described above (that is, in a second case where the index value α is equal to or less than the predetermined second value smaller than the first value described above), and obtain, as the encoding target signal of the channel, for each channel in a third range, within the range that can be taken by the index value α, that is a range other than the first range and the second range (that is, in a third case other than the first case and the second case, specifically, in a case where the index value α is equal to or less than the predetermined first value described above and larger than the predetermined second value described above), a signal obtained by performing weighted addition on the input sound signal of the channel and the downmixed signal, in which the weight of the input sound signal of the channel in the weighted addition is a value having a monotonic increase relationship with respect to the index value α in the third range or the index value α, and the weight of the downmixed signal in the weighted addition is a value having a monotonic decrease relationship with respect to the index value α in the third range. The mixing unit 1211 may perform an operation in which “larger than a predetermined first value” and “equal to or less than the predetermined first value” described above are replaced with “equal to or larger than a predetermined first value” and “smaller than the predetermined first value”, respectively, and may perform an operation in which “larger than a predetermined second value” and “equal to or less than the predetermined second value” described above are replaced with “equal to or larger than a predetermined second value” and “smaller than the predetermined second value”, respectively.

Similarly, the mixing unit 1211 to which the index value α′ is input may obtain the input sound signal of the channel as it is as the encoding target signal of the channel for each channel in a case where the index value α′ is smaller than a predetermined value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case other than the above case, that is, in a case where the index value α′ is equal to or larger than the predetermined value (step S1211). The mixing unit 1211 may perform an operation in which “smaller than a predetermined value” and “equal to or larger than the predetermined value” described above are replaced with “equal to or less than a predetermined value” and “larger than the predetermined value”, respectively.

For example, the mixing unit 1211 to which the index value α′ is input may obtain the input sound signal of the channel as it is as the encoding target signal of the channel for each channel in a first range, within the range that can be taken by the index value α′, that is a range in which the index value α′ is smaller than a predetermined value (that is, in a first case where the index value α′ is smaller than the predetermined value), and obtain, as the encoding target signal of the channel, for each channel in a second range that is a range other than the first range within the range that can be taken by the index value α′ (that is, in a second case other than the first case, specifically, in a case where the index value α′ is equal to or larger than the predetermined value described above), a signal obtained by performing weighted addition on the input sound signal of the channel and the downmixed signal, in which the weight of the input sound signal of the channel in the weighted addition is a value having a monotonic decrease relationship with respect to the index value α′ in the second range, and the weight of the downmixed signal in the weighted addition is a value having a monotonic increase relationship with respect to the index value α′ in the second range or the index value α′. The mixing unit 1211 may perform an operation in which “smaller than a predetermined value” and “equal to or larger than the predetermined value” described above are replaced with “equal to or less than a predetermined value” and “larger than the predetermined value”, respectively.

Alternatively, the mixing unit 1211 to which the index value α′ is input may obtain the downmixed signal as it is as the encoding target signal of the channel for each channel in a case where the index value α′ is larger than a predetermined value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case other than the above case, that is, in a case where the index value α′ is equal to or less than the predetermined value (step S1211). The mixing unit 1211 may perform an operation in which “larger than a predetermined value” and “equal to or less than the predetermined value” described above are replaced with “equal to or larger than a predetermined value” and “smaller than the predetermined value”, respectively.

For example, the mixing unit 1211 to which the index value α′ is input may obtain the downmixed signal as it is as the encoding target signal of the channel for each channel in a first range, within the range that can be taken by the index value α′, that is a range in which the index value α is larger than a predetermined value (that is, in a first case where the index value α′ is larger than the predetermined value), and obtain, as the encoding target signal of the channel, for each channel in a second range that is a range other than the first range within the range that can be taken by the index value α′ (that is, in a second case other than the first case, specifically, in a case where the index value α′ is equal to or less than the predetermined value described above), a signal obtained by performing weighted addition on the input sound signal of the channel and the downmixed signal, in which the weight of the input sound signal of the channel in the weighted addition is a value having a monotonic decrease relationship with respect to the index value α′ in the second range, and the weight of the downmixed signal in the weighted addition is a value having a monotonic increase relationship with respect to the index value α′ in the second range or the index value α′. The mixing unit 1211 may perform an operation in which “larger than a predetermined value” and “equal to or less than the predetermined value” described above are replaced with “equal to or larger than a predetermined value” and “smaller than the predetermined value”, respectively.

Alternatively, the mixing unit 1211 to which the index value α′ is input may obtain the input sound signal of the channel as it is as the encoding target signal of the channel for each channel in a case where the index value α′ is smaller than a predetermined first value, obtain the downmixed signal as it is as the encoding target signal of the channel for each channel in a case where the index value α′ is equal to or larger than a predetermined second value larger than the predetermined first value, and obtain the signal in which the input sound signal of the channel and the downmixed signal are mixed for each channel, the signal being closer to the input sound signal of the channel as the index value α′ is smaller (that is, the signal closer to the downmixed signal as the index value α′ is larger) as the encoding target signal of the channel in a case where neither of the two cases is applicable, that is, in a case where the index value α′ is equal to or larger than the predetermined first value and smaller than the predetermined second value (step S1211). The mixing unit 1211 may perform an operation in which “smaller than a predetermined first value” and “equal to or larger than the predetermined first value” described above are replaced with “equal to or less than a predetermined first value” and “larger than the predetermined first value”, respectively, and may perform an operation in which “smaller than a predetermined second value” and “equal to or larger than the predetermined second value” described above are replaced with “equal to or less than a predetermined second value” and “larger than the predetermined second value”, respectively.

For example, the mixing unit 1211 to which the index value α′ is input may obtain the input sound signal of the channel as it is as the encoding target signal of the channel for each channel in a first range, within the range that can be taken by the index value α′, that is a range in which the index value α′ is smaller than a predetermined first value (that is, in a first case where the index value α′ is smaller than the predetermined first value), obtain the downmixed signal as it is as the encoding target signal of the channel for each channel in a second range, within the range that can be taken by the index value α′, that is a range in which the index value α′ is equal to or larger than the predetermined second value larger than the first value described above (that is, in a second case where the index value α′ is equal to or larger than the predetermined second value larger than the first value described above), and obtain, as the encoding target signal of the channel, for each channel in a third range, within the range that can be taken by the index value α′, that is a range other than the first range and the second range (that is, in a third case other than the first case and the second case, specifically, in a case where the index value α′ is equal to or larger than the predetermined first value described above and smaller than the predetermined second value described above), a signal obtained by performing weighted addition on the input sound signal of the channel and the downmixed signal, in which the weight of the input sound signal of the channel in the weighted addition is a value having a monotonic decrease relationship with respect to the index value α′ in the third range, and the weight of the downmixed signal in the weighted addition is a value having a monotonic increase relationship with respect to the index value α′ in the third range or the index value α′. The mixing unit 1211 may perform an operation in which “smaller than a predetermined first value” and “equal to or larger than the predetermined first value” described above are replaced with “equal to or less than a predetermined first value” and “larger than the predetermined first value”, respectively, and may perform an operation in which “smaller than a predetermined second value” and “equal to or larger than the predetermined second value” described above are replaced with “equal to or less than a predetermined second value” and “larger than the predetermined second value”, respectively.

### First Example of Index Value Calculation Unit 110 and Mixing Unit 1211

The index value calculation unit 110 obtains an index value α that is 0 or more and 1 or less and satisfies two or more of the first condition, the second condition, and the third condition. Specifically, the index value calculation unit 110 obtains any of an index value α that is 0 or more and 1 or less and satisfies the first condition and the second condition, an index value α that is 0 or more and 1 or less and satisfies the first condition and the third condition, an index value α that is 0 or more and 1 or less and satisfies the second condition and the third condition, and an index value α that is 0 or more and 1 or less and satisfies the first condition, the second condition, and the third condition.

For example, the index value calculation unit 110 sets bias=0.8 and range=0.2 when the bit rate of the stereo encoding of the stereo encoding device 200 is 24.4 kbps, sets bias=0.6 and range=0.4 when the bit rate of the stereo encoding of the stereo encoding device 200 is 16.4 kbps, and sets bias=0.4 and range=0.4 when the bit rate of the stereo encoding of the stereo encoding device 200 is 13.2 kbps, and sets a value obtained by normalizing the index value of the single sound source likeliness of the two-channel stereo input sound signal obtained by any method of [First Example of Method in which Index Value Calculation Unit 110 Obtains Index Value of Single Sound Source Likeness of Two-Channel Stereo Input Sound Signal] to [Third Example of Method in which Index Value Calculation Unit 110 Obtains Index Value of Single Sound Source Likeness of Two-Channel Stereo Input Sound Signal] so that the value falls within values in a range of 0 or more and 1 or less or the index value of the single sound source likeliness of the two-channel stereo input sound signal obtained by any one of step S110-C1-A2′ of [First Example of Method in which Index Value Calculation Unit 110 Obtains Index Value of Single Sound Source Likeness of Two-Channel Stereo Input Sound Signal] and step S110-C1-B6′ of [Second Example of Method in which Index Value Calculation Unit 110 Obtains Index Value of Single Sound Source Likeness of Two-Channel Stereo Input Sound Signal] as y, sets a value represented by Formula (5-1) described below using y as u, sets a value represented by Formula (5-2) described below using bias, range, and u as v, sets a value represented by Formula (5-3) described below using the absolute value |ITD| of the inter-channel time difference in units of millisecond (ms) or a value represented by Formula (5-4) described below using the absolute value |ITD| of the inter-channel time difference in units of the number of samples when the sampling frequency is 48 kHz as mag, and obtains a value α represented by Formula (5-5) described below as an index value α that satisfies the first condition, the second condition, and the third condition.

$$\begin{matrix}[ Math . 43 ] & \\ u = 0.5 \times ( 1 + cos ( 2 π \times ( 0.5 + y \times 0.5 ) ) ) & ( 5 ‐ 1 )\end{matrix}$$

$$\begin{matrix}[ Math . 44 ] & \\ v = min ( 1 , bias + range \times u ) & ( 5 ‐ 2 )\end{matrix}$$

$$\begin{matrix}[ Math . 45 ] & \\ mag = cos ( min ( 1 , \vert ITD \vert \times 0. 5 ) \times 0.5 π ) \times 0.5 + 0.5 & ( 5 ‐ 3 )\end{matrix}$$

$$\begin{matrix}[ Math . 46 ] & \\ mag = cos ( min ( 1 , \vert ITD \vert \times 0. 01 ) \times 0.5 π ) \times 0.5 + 0.5 & ( 5 ‐ 4 )\end{matrix}$$

$$\begin{matrix}[ Math . 47 ] & \\ α = ma g \times min ( 1 , v ) & ( 5 ‐ 5 )\end{matrix}$$

Note that, instead of obtaining the absolute value of τ_{cand} when γ_{cand} is the maximum value as the absolute value |ITD| of the inter-channel time difference, the index value calculation unit 110 may obtain τ_{cand} when γ_{cand} is the maximum value as the inter-channel time difference ITD, and obtain the above-described index value α using the inter-channel time difference ITD.

For example, the index value calculation unit 110 may obtain w represented by Formula (5-6) described below in a case where the inter-channel time difference ITD is larger than 0 or equal to or larger than 0, obtain w represented by Formula (5-7) described below in a case other than the above case, that is, in a case where the inter-channel time difference ITD is equal to or less than 0 and smaller than 0, and set a value represented by Formula (5-8) described below as u, set a value represented by Formula (5-2) described above using bias, range, and u as v, set a value represented by Formula (5-3) described above using the absolute value |ITD| of the inter-channel time difference in units of milliseconds (ms) or a value represented by Formula (5-4) described above using the absolute value |ITD| of the inter-channel time difference in units of the number of samples when the sampling frequency is 48 kHz as mag, and obtain a value α represented by Formula (5-5) described above as the index value α satisfying the first condition, the second condition, and the third condition.

$$\begin{matrix}[ Math . 48 ] & \\ w = 0. 5 + y \times 0.5 & ( 5 ‐ 6 )\end{matrix}$$

$$\begin{matrix}[ Math . 49 ] & \\ w = 0.5 - y \times 0.5 & ( 5 ‐ 7 )\end{matrix}$$

$$\begin{matrix}[ Math . 50 ] & \\ u = 0. 5 \times ( 1 + cos ( 2 π \times w ) ) & ( 5 ‐ 8 )\end{matrix}$$

The index value calculation unit 110 may obtain the value v represented by Formula (5-2) described above as the index value α satisfying the first condition and the third condition.

For each time t, the mixing unit 1211 obtains a first channel encoding target signal x′₁(t) represented by Formula (2-23) described above and obtains a second channel encoding target signal x′₂(t) represented by Formula (2-24) described above.

When the index value calculation unit 110 calculates the index value α for each frame, the mixing unit 1211 may, for each frame, set the index value α calculated for the previous frame by the index value calculation unit 110 as ap, set the index value α calculated for the current frame by the index value calculation unit 110 as α_{c}, set a value obtained by Formula (2-25) described above as an index value α(t) for each time from the initial time (that is, the first time) of the current frame to the T₀−1th time, set α_{c} as the index value α(t) for each time from the τ₀th time to the last time (that is, the Tth time) of the current frame, and obtain the first channel encoding target signal x′₁(t) represented by Formula (2-26) described above instead of Formula (2-23) described above for each time t of the current frame, and obtain the second channel encoding target signal x′₂(t) represented by Formula (2-27) described above instead of Formula (2-24) described above.

### Second Example of Index Value Calculation Unit 110 and Mixing Unit 1211

The index value calculation unit 110 obtains an index value α′ that is 0 or more and 1 or less and satisfies two or more of the fourth condition, the fifth condition, and the sixth condition. Specifically, the index value calculation unit 110 obtains any of an index value α′ that is 0 or more and 1 or less and satisfies the fourth condition and the fifth condition, an index value α′ that is 0 or more and 1 or less and satisfies the fourth condition and the sixth condition, an index value α′ that is 0 or more and 1 or less and satisfies the fifth condition and the sixth condition, and an index value α′ that is 0 or more and 1 or less and satisfies the fourth condition, the fifth condition, and the sixth condition.

For each time t, the mixing unit 1211 obtains a first channel encoding target signal x′₁(t) represented by Formula (2-28) described above and obtains a second channel encoding target signal x′₂(t) represented by Formula (2-29) described above.

When the index value calculation unit 110 calculates the index value α′ for each frame, the mixing unit 1211 may, for each frame, set the index value α′ calculated for the previous frame by the index value calculation unit 110 as α′ₚ, set the index value α′ calculated for the current frame by the index value calculation unit 110 as α′_{c}, set a value obtained by Formula (2-30) described above as an index value α′(t) for each time from the initial time (that is, the first time) of the current frame to the T₀−1th time, set α′_{c} as the index value α′ (t) for each time from the τ₀th time to the last time (that is, the Tth time) of the current frame, and obtain the first channel encoding target signal x′₁(t) represented by Formula (2-31) described above instead of Formula (2-28) described above for each time t of the current frame, and obtain the second channel encoding target signal x′₂(t) represented by Formula (2-32) described above instead of Formula (2-29) described above.

### Sixth Embodiment

In the sixth embodiment, a mode will be described in which the downmixed signal generation unit 1201 of the second modification and the third modification of the second embodiment, the second modification and the third modification of the third embodiment, the first modification of the fourth embodiment, and the first modification of the fifth embodiment performs processing different from the above-described processing.

Hereinafter, a downmixed signal generation unit 1201 of the sixth embodiment different from that of each of the above-described modifications will be described.

### [Downmixed Signal Generation Unit 1201]

A first channel input sound signal and a second channel input sound signal, which are input sound signals of two channels constituting a two-channel stereo input sound signal input to the sound signal processing device 100, are input to the downmixed signal generation unit 1201. The downmixed signal generation unit 1201 generates, as a downmixed signal, a signal obtained by performing weighted addition on the first channel input sound signal and the second channel input sound signal so that more of the input sound signal of the preceding channel of the first channel input sound signal and the second channel input sound signal is included as the correlation between the first channel input sound signal and the second channel input sound signal is larger (step S1201). For example, the downmixed signal generation unit 1201 obtains the downmixed signal by performing each processing described below.

First, the downmixed signal generation unit 1201 obtains γ_{cand} for each number of candidate samples τ_{cand} from predetermined τₘₐₓ to τₘᵢₙ (for example, τₘₐₓ is a positive number, and τₘᵢₙ is a negative number) by performing the same processing as in step S110-A1 of the first example of the method in which the index value calculation unit 110 of the third embodiment calculates the absolute value |ITD| of the inter-channel time difference or in step S110-B1 to step S110-B5 or step S110-B5′ of the second example of the method in which the index value calculation unit 110 of the third embodiment calculates the absolute value |ITD| of the inter-channel time difference. γ_{cand} is a value representing the magnitude of the correlation between a sample string of the first channel input sound signal and a sample string of the second channel input sound signal at a position shifted behind the sample string by each number of candidate samples τ_{cand}.

Note that, in a case where γ_{cand} has already been obtained by the index value calculation unit 110, it is not necessary for the downmixed signal generation unit 1201 to perform processing of obtaining γ_{cand}, and, as indicated by the two-dot chain line in FIG. 5, it is sufficient if γ_{cand} obtained by the index value calculation unit 110 is input to the downmixed signal generation unit 1201, and the downmixed signal generation unit 1201 uses the input γ_{cand}.

Next, the downmixed signal generation unit 1201 obtains the maximum value y of γ_{cand}. Next, the downmixed signal generation unit 1201 obtains, as preceding channel information, information indicating that the first channel is preceding in a case where τ_{cand} when γ_{cand} is the maximum value y is a positive value, and obtains, as preceding channel information, information indicating that the second channel is preceding in a case where τ_{cand} when γ_{cand} is the maximum value y is a negative value. In a case where τ_{cand} when γ_{cand} is the maximum value y is 0, the downmixed signal generation unit 1201 favorably obtains the information indicating that neither of the channels is preceding as the preceding channel information, but may obtain the information indicating that the first channel is preceding as the preceding channel information, and may obtain the information indicating that second channel is preceding as the preceding channel information.

The preceding channel information is information corresponding to at which of the first channel microphone disposed in a space and the second channel microphone disposed in the space a sound emitted by a main sound source in the space arrives earlier. That is, the preceding channel information is information indicating in which of the first channel input sound signal and the second channel input sound signal the same sound signal is included first. Assuming that it is said that the first channel is preceding in a case where the same sound signal is included earlier in the first channel input sound signal, and it is said that the second channel is preceding in a case where the same sound signal is included earlier in the second channel input sound signal, the preceding channel information is information indicating which of the first channel and the second channel is preceding.

Next, the downmixed signal generation unit 1201 generates, as a downmixed signal, a signal obtained by performing weighted addition on the first channel input sound signal and the second channel input sound signal so that more of the input sound signal of the preceding channel of the first channel input sound signal and the second channel input sound signal is included as the correlation between the first channel input sound signal and the second channel input sound signal is larger.

For example, in a case where the absolute value of the correlation coefficient or the normalized value is obtained as γ_{cand} as in the above-described example, an inter-channel correlation value γ is a value of 0 or more and 1 or less, and thus, it is sufficient if the downmixed signal generation unit 1201 obtains x_{M}(t)=((1+y)/2)×x₁(t)+((1−y)/2)×x₂(t) as the downmixed signal x_{M}(t) for each time t in a case where the preceding channel information is information indicating that the first channel is preceding, that is, in a case where the first channel is preceding, and obtains x_{M}(t)=((1−y)/2)×x₁(t)+((1+y)/2)×x₂(t) as the downmix signal x_{M}(t) for each time t in a case where the preceding channel information is information indicating that the second channel is preceding, that is, in a case where the second channel is preceding. In a case where the preceding channel information indicates that neither of the channels precedes, that is, in a case where neither of the channels precedes, it is sufficient if the downmixed signal generation unit 1201 obtains x_{M}(t)=(X₁(t)+x₂(t))/2 as the downmixed signal x_{M}(t) for each time t.

### <Supplementary Notes>

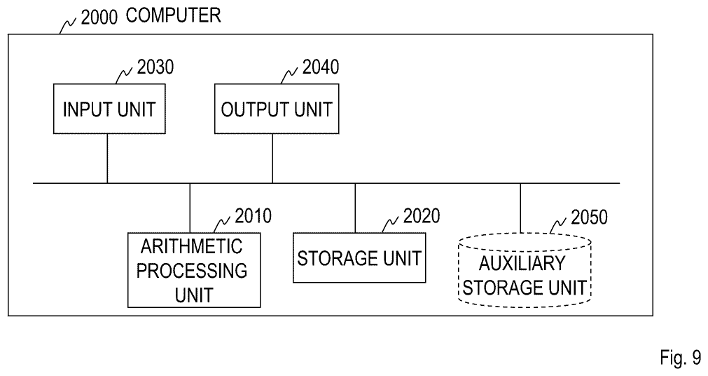

Processing of each unit of the system and each device described above may be implemented by a computer, and in this case, processing contents of a function that each device is supposed to have are written by a program. Then, by causing a storage unit 2020 of a computer 2000 illustrated in FIG. 9 to read this program and causing an arithmetic processing unit 2010, an input unit 2030, an output unit 2040, and the like to operate, various processing functions in the system described above and each device described above are implemented on the computer.

The system and device of the present invention include, for example, as a single hardware entity, an input unit to which a signal can be input from the outside of the hardware entity, an output unit that can output a signal to the outside of the hardware entity, a communication unit that can be connected to a communication device (e.g., a communication cable) capable of communicating with the outside of the hardware entity, a CPU (Central Processing Unit which may include a cache memory or a register), RAM or ROM which is a memory, an external storage device as a hard disk, and a bus that connects the input unit, the output unit, the communication unit, the CPU, the RAM, the ROM, and the external storage device so that data can be exchanged therebetween. In addition, if necessary, a device (drive) or the like that can read and write a recording medium such as a CD-ROM may be provided in the hardware entity. Examples of a physical entity including such a hardware resource include a general-purpose computer.

The external storage device of the hardware entity stores programs required for implementing the above-described functions, data required for processing of the programs, and the like (the programs may be stored, for example, in a ROM as a read-only storage device instead of the external storage device). In addition, such data or the like obtained by the processing by the program is appropriately stored in the RAM, the external storage device, or the like.

In the hardware entity, each program stored in an external storage device (or ROM or the like) and data necessary for processing of each program are read into a memory as necessary, and interpreted, executed and processed by the CPU as appropriate. As a result, the CPU implements a predetermined function (each component represented as the above . . . unit, . . . means, and the like). That is, each of the components of the embodiment of the present invention may include processing circuitry.

As described earlier, in a case where the processing functions of the hardware entity (the system and device of the present invention) described in the foregoing embodiments are implemented by a computer, processing contents of the functions that the hardware entity is supposed to have are described by a program. Then, as the computer executes the program, the processing function of the hardware entity described above is implemented on the computer.

The program in which the processing content is written can be recorded on a computer-readable recording medium. The computer-readable recording medium is, for example, a non-transitory recording medium and is specifically a magnetic recording device, an optical disc, or the like.

In addition, distribution of the program is performed by, for example, selling, transferring, or renting a portable recording medium such as a DVD or a CD-ROM in which the program is recorded. Further, the program may be stored in a storage device of a server computer, and distributed by being transferred from the server computer to another computer via a network.

For example, a computer that executes such a program first temporarily stores the program recorded in a portable recording medium or the program transferred from a server computer in an auxiliary storage unit 2050 that is a non-transitory storage device of the computer itself. Then, at the time of performing processing, the computer reads the program stored in the auxiliary storage unit 2050 serving as the non-transitory storage device of the computer into the storage unit 2020 and performs processing according to the read program. In addition, in another embodiment of this program, the computer may directly read the program from a portable recording medium into the storage unit 2020, and perform processing according to the program. Furthermore, the computer may sequentially perform processing according to the received program each time the program is transferred from the server computer to the computer. In addition, the above processing may be performed by a so-called ASP (Application Service Provider) service that achieves a processing function only by issuing an instruction to execute the program and acquiring the result, without transfer of the program from the server computer to the computer. Note that the program in this mode includes information that is to be used in processing by an electronic calculator and is equivalent to the program (data and the like that are not direct commands to the computer but have properties that define the processing to be performed by the computer).

In addition, although the present system and device are configured by the predetermined program being executed on the computer in this mode, at least a part of the processing content may be implemented by hardware.

The present invention is not limited to the above-described embodiments and can be appropriately modified without departing from the gist of the present invention.

1.-6. (canceled)

7. A sound signal processing method that obtains a two-channel stereo encoding target signal including encoding target signals of two channels to be subjected to stereo encoding by a stereo encoding method from a two-channel stereo input sound signal including input sound signals of two channels, the sound signal processing method comprising:
obtaining, for each channel, a signal obtained by performing weighted addition on the input sound signal of the channel and the input sound signal of the other channel as the encoding target signal of the channel, wherein
a weight of the input sound signal of the channel in the weighted addition is a value having a weak monotonic decrease relationship with respect to an absolute value of an inter-channel time difference of the two-channel stereo input sound signal, and
a weight of the input sound signal of the other channel in the weighted addition is a value having a weak monotonic increase relationship with respect to the absolute value of the inter-channel time difference.

8. (canceled)

9. A sound signal processing method that obtains a two-channel stereo encoding target signal including encoding target signals of two channels to be subjected to stereo encoding by a stereo encoding method from a two-channel stereo input sound signal including input sound signals of two channels, the sound signal processing method comprising:
mixing the input sound signals of the two channels to generate a downmixed signal; and
obtaining, for each channel, a signal obtained by performing weighted addition on the input sound signal of the channel and the downmixed signal as the encoding target signal of the channel, wherein
a weight of the input sound signal of the channel in the weighted addition is a value having a weak monotonic decrease relationship with respect to an absolute value of an inter-channel time difference of the two-channel stereo input sound signal, and
a weight of the downmixed signal in the weighted addition is a value having a weak monotonic increase relationship with respect to the absolute value of the inter-channel time difference.

10. (canceled)

11. A sound signal processing method that obtains a two-channel stereo encoding target signal including encoding target signals of two channels to be subjected to stereo encoding by a stereo encoding method from a two-channel stereo input sound signal including input sound signals of two channels, the sound signal processing method comprising:
mixing the input sound signals of the two channels to generate a downmixed signal; and
obtaining the downmixed signal as the encoding target signal of the channel for each channel in a first range, within a range that can be taken by an absolute value of an inter-channel time difference of the two-channel stereo input sound signal, that is a range in which the absolute value of the inter-channel time difference is larger than or equal to or larger than a predetermined value, and
obtaining, as the encoding target signal, a signal obtained by performing weighted addition on the input sound signal of the channel and the downmixed signal for each channel in a second range, within the range that can be taken by the absolute value of the inter-channel time difference, that is a range other than the first range, wherein
a weight of the input sound signal of the channel in the weighted addition is a value having a weak monotonic decrease relationship with respect to the absolute value of the inter-channel time difference in the second range, and
a weight of the downmixed signal in the weighted addition is a value having a weak monotonic increase relationship with respect to the absolute value of the inter-channel time difference in the second range.

12. (canceled)

13. A non-transitory computer-readable storage medium which stores a program for causing a computer to perform the sound signal processing method according to claim 7.

14. A non-transitory computer-readable storage medium which stores a program for causing a computer to perform the sound signal processing method according to claim 9.

15. A non-transitory computer-readable storage medium which stores a program for causing a computer to perform the sound signal processing method according to claim 11.
